(19) United States
(12) Patent Application Publication
(10) Pub. No.: US 2024/0189982 A1
(43) Pub. Date: Jun. 13, 2024

(54) ROBOTIC SYSTEM WITH OBJECT HANDLING MECHANISM FOR LOADING AND UNLOADING OF CARGO CARRIERS

(71) Applicant: MUJIN, Inc., Tokyo (JP)

(72) Inventors: Rosen Nikolaev Diankov, Tokyo (JP); Puttichai Lertkultanon, Tokyo (JP); Shintaro Matsuoka, Tokyo (JP); Yoshiki Kanemoto, Tokyo (JP); Jose Jeronimo Moreira Rodrigues, Tokyo (JP); Lei Lei, Guangzhao (CN); Yixuan Zhang, Guangzhao (CN); Xutao Ye, Guangzhao (CN); Yufan Du, Guangzhao (CN); Mingjian Liang, Guangzhao (CN); Lingping Gao, Guangzhao (CN); Xinhao Wen, Guangzhao (CN); Xu Chen, Guangzhao (CN)

(21) Appl. No.: 18/532,868

(22) Filed: Dec. 7, 2023

Related U.S. Application Data
(60) Provisional application No. 63/431,749, filed on Dec. 12, 2022.

(51) Int. Cl. B25J 9/00; B25J 5/00; B65G 67/08; B65G 67/24

(52) U.S. Cl. CPC B25J 9/0093; B25J 5/007; B65G 67/08; B65G 67/24

(57) ABSTRACT

A robotic system may include a chassis as well as a first leg and a second leg operatively coupled to the chassis. The first leg and the second leg may be configured to move in a vertical direction to move the chassis in a vertical translational degree of freedom. The robotic system may include a proximal conveyor, a first segment including a first segment conveyor extending along a length of the first segment, and a gripper including a distal conveyor extending along a length of the gripper. A first joint between the proximal conveyor and the first segment may be configured to provide a first rotational degree of freedom between the first segment and the proximal conveyor. A second joint between the gripper and the first segment may be configured to provide a second rotational degree of freedom between the first segment and the gripper.

### CROSS-REFERENCE TO RELATED APPLICATION

The present application claims the benefit of U.S. Provisional Patent Application No. 63/431,749, filed Dec. 12, 2022, the entirety of which is incorporated herein by reference.

### TECHNICAL FIELD

The present disclosure is generally related to robotic systems and, more specifically, to systems, processes, and techniques for object handling mechanisms. Embodiments herein may relate to robotic systems for loading and/or unloading cargo carriers (e.g., shipping containers, trailers, box trucks, etc.).

### BACKGROUND

With their ever-increasing performance and lowering cost, many robots (e.g., machines configured to automatically/autonomously execute physical actions) are now extensively used in various different fields. Robots, for example, can be used to execute various tasks (e.g., manipulate or transfer an object through space) in manufacturing and/or assembly, packing and/or packaging, transport and/or shipping, etc. In executing the tasks, the robots can replicate human actions, thereby replacing or reducing human involvements that are otherwise required to perform dangerous or repetitive tasks.

However, despite the technological advancements, robots often lack the sophistication necessary to duplicate human interactions required for executing larger and/or more complex tasks, such as for transferring objects to/from cargo carriers. Accordingly, there remains a need for improved techniques and systems for managing operations and/or interactions between robots.

### BRIEF DESCRIPTION OF THE DRAWINGS

Detailed descriptions of implementations of the present technology will be described and explained through the use of the accompanying drawings.

FIG. 1 illustrates an example environment in which a robotic system with a coordinated transfer mechanism may operate.

FIG. 2 is a block diagram illustrating the robotic system in accordance with one or more embodiments.

FIG. 3 is a perspective view of a robotic system in accordance with embodiments of the present technology.

FIG. 4 is an enlarged side view of the robotic system of FIG. 3 illustrating actuation of supporting legs in accordance with embodiments of the present technology.

FIG. 5 is a side view of the robotic system of FIG. 3 illustrating vertical actuation of a segment in accordance with embodiments of the present technology.

FIG. 6 is a top view of the robotic system of FIG. 3 illustrating horizontal actuation the segment in accordance with embodiments of the present technology.

FIGS. 7A and 7B are side views of the robotic system of FIG. 3 illustrating vertical actuation of the segment relative to a cargo carrier in accordance with embodiments of the present technology.

FIG. 8 is a side schematic of a robotic system in accordance with one or more embodiments.

FIG. 9 is a top schematic of the robotic system of FIG. 8 in a first state.

FIG. 10 is a top schematic of the robotic system of FIG. 8 in a second state.

FIG. 11 is a schematic illustrating a robotic system positioned inside of a cargo carrier in accordance with one or more embodiments.

FIG. 12A illustrates a robotic system in a first state of a process of unloading a cargo carrier in accordance with one or more embodiments.

FIG. 12B illustrates the robotic system of FIG. 12A in a second state of a process of unloading a cargo carrier in accordance with one or more embodiments.

FIG. 12C illustrates a perspective view the robotic system of FIG. 12A in the second state of the process of unloading a cargo carrier in accordance with one or more embodiments.

FIG. 12D illustrates the robotic system of FIG. 12A in a third state of a process of unloading a cargo carrier in accordance with one or more embodiments.

FIG. 12E illustrates the robotic system of FIG. 12A in a fourth state of a process of unloading a cargo carrier in accordance with one or more embodiments.

FIG. 13 is a flow diagram illustrating a process of operating a robotic system in accordance with one or more embodiments.

FIG. 14 is a flow diagram illustrating a process of operating a robotic system in accordance with one or more embodiments.

FIG. 15 is a side schematic of a gripper for a robotic system in accordance with one or more embodiments.

FIG. 16 is a top schematic of the gripper of FIG. 15.

FIG. 17A is a schematic illustrating a first state of a process of operating a robotic system in accordance with one or more embodiments.

FIG. 17B is a schematic illustrating a second state of a process of operating a robotic system in accordance with one or more embodiments.

FIG. 17C is a schematic illustrating a third state of a process of operating a robotic system in accordance with one or more embodiments.

FIG. 17D is a schematic illustrating a fourth state of a process of operating a robotic system in accordance with one or more embodiments.

FIG. 17E is a schematic illustrating a fifth state of a process of operating a robotic system in accordance with one or more embodiments.

FIG. 17F is a schematic illustrating a sixth state of a process of operating a robotic system in accordance with one or more embodiments.

FIG. 18 is a flow diagram illustrating a process of operating a robotic system in accordance with one or more embodiments.

FIG. 19 is a perspective view of a robotic system in accordance with embodiments of the present technology.

FIG. 20 is an enlarged side view of the robotic system of FIG. 19 in accordance with embodiments of the present technology.

FIG. 21 is a perspective view of the robotic system of FIG. 19 on a warehouse floor in accordance with embodiments of the present technology.

FIGS. 22 and 23 are enlarged side views of the robotic system of FIG. 19 illustrating actuation of supporting legs in accordance with embodiments of the present technology.

FIG. 24 is an enlarged perspective view of front wheels of the robotic system of FIG. 19 in accordance with embodiments of the present technology.

FIG. 25 is an enlarged perspective view of a rear supporting leg of the robotic system of FIG. 19 in accordance with embodiments of the present technology.

FIG. 26 is a perspective view of a chassis joint for a robotic system in accordance with one or more embodiments.

FIG. 27 is a flow diagram illustrating a process of operating a robotic system in accordance with one or more embodiments.

FIG. 28 is a front view of a robotic system and chassis joint in a first state in accordance with one or more embodiments.

FIG. 29 is a front view of the robotic system and chassis joint of FIG. 28 in a second state.

FIG. 30 is a flow diagram illustrating a process of operating a robotic system in accordance with one or more embodiments.

FIG. 31 is a partially schematic isometric view of a robotic system configured in accordance with some embodiments of the present technology.

FIGS. 32A and 32B are partially schematic upper and lower side views of an end effector configured in accordance with some embodiments of the present technology.

FIGS. 33A-33F are partially schematic side views of an end effector of the type illustrated in FIG. 32A at various stages of a process for picking up a target object in accordance with some embodiments of the present technology.

FIG. 34 is a partially schematic upper-side view of an end effector configured in accordance with some embodiments of the present technology.

FIG. 35 is a partially schematic side view of a gripping component for an end effector configured in accordance with some embodiments of the present technology.

FIGS. 36A-36E are partially schematic side views of an end effector of the type illustrated in FIG. 34 at various stages of a process for picking up a target object in accordance with some embodiments of the present technology.

FIG. 37 is a flow diagram of a process for picking up a target object in accordance with some embodiments of the present technology.

FIGS. 38A and 38B are partially schematic upper-side views illustrating additional features at a distal region of an end effector configured in accordance with some embodiments of the present technology.

FIGS. 39A and 39B are partially schematic top and upper-side views, respectively, of an end effector configured in accordance with some embodiments of the present technology.

FIG. 40 is a partially schematic upper-side view of a distal joint for a robotic system configured in accordance with some embodiments of the present technology.

FIG. 41 is a partially schematic bottom view of a distal joint for a robotic system configured in accordance with some embodiments of the present technology.

FIGS. 42A and 42B are partially schematic side views of a distal joint for a robotic system configured in accordance with some embodiments of the present technology.

FIGS. 43A-43C are partially schematic top views of a distal joint for a robotic system configured in accordance with some embodiments of the present technology.

FIG. 43D is a partially schematic bottom view of a distal joint for a robotic system configured in accordance with some embodiments of the present technology.

FIGS. 44A-44C are partially schematic side views of a distal joint of the type illustrated in FIGS. 43A-43C configured in accordance with some embodiments of the present technology.

FIG. 45 is a partially schematic upper-side view of connection management features within a distal joint of the type illustrated in FIG. 40 in accordance with some embodiments of the present technology.

FIG. 46 is a partially schematic cross-sectional view of connection management features of the type illustrated in FIG. 45 in accordance with some embodiments of the present technology.

FIG. 47 is a partially schematic isometric view of a drive component for a gripping component configured in accordance with some embodiments of the present technology.

FIG. 48 is a partially schematic isometric view of a branching component of a drive component configured in accordance with some embodiments of the present technology.

FIG. 49 is a partially schematic isometric view illustrating additional details on a drive component for a gripping component in accordance with some embodiments of the present technology.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology includes methods, apparatuses, and systems for robotic handling of objects. Specifically, according to some embodiments herein, the disclosed technology includes methods, apparatuses, and systems for robotic loading and unloading of cargo carriers, including, but not limited to, shipping containers, trailers, cargo beds, and box trucks. Conventional processes for loading and unloading cargo carriers are highly labor intensive. Typically, cargo carriers are loaded or unloaded via manual labor by hand or with human-operated tools (e.g., pallet jacks). This process is therefore time-consuming and expensive, and such processes require repetitive, physically strenuous work. Previous attempts to automate portions of a load or unload process have certain detriments that prevent widespread adoption.

First, many existing robotic systems are unable to compensate for variability in packing pattern and object size within a cargo carrier. For example, many cargo carriers are packed with irregularly sized boxes that cannot be removed automatically (i.e., without human input/effort) in a regular or repeating pattern. Introduced here are robotic systems that are configured to automatically/autonomously unload/load cargo carriers packed with irregularly sized and oriented objects, such as mixed stock keeping unit (SKU) boxes. As discussed further herein, a robotic system may employ a vision system to reliably recognize irregularly sized objects and control an end of arm tool (EOAT) including a gripper based on that recognition.

Second, many existing robotic systems are unable to reach extremities of a rectangular shaped cargo carriers. In many cases, cargo carriers (sometimes also referred to herein as “shipping units”) such as shipping containers, semi-trailers, and box-trucks are packed as full as possible for cargo efficiency. However, existing robotic systems are unable to load or unload objects from the outmost perimeter of the cargo carriers due to limitation on range of motion and friction from the cargo carrier. Introduced here are robotic systems that are configured to unload/load rectangular cargo carriers that are fully packed. That is, robotic systems may be configured to load or unload objects placed proximate or in contact with an outermost periphery of the cargo carrier. As discussed further herein, a robotic system may include a plurality of rotating joints providing rotational degrees of freedom and a chassis assembly providing a translational degree of freedom, allowing an EOAT to reach objects at any position along a vertical plane within a cargo carrier (e.g., within a coronal and/or frontal plane of the cargo carrier) bounded by a rectangular periphery.

Third, many existing robotic systems require replacement of existing infrastructure in a load/unload area of a warehouse or other distribution center (e.g., truck bay, etc.). In many cases, existing warehouses have conveyor systems for moving objects through the warehouse. Typically, objects are removed from such a conveyor and placed into a cargo carrier manually to load the cargo carrier. Conversely, objects may be manually placed on the conveyor after being manually removed from a cargo carrier to unload the cargo carrier. Accordingly, there is existing infrastructure in warehouses or other distribution centers but with a gap between a cargo carrier and that infrastructure that is currently filled by manual labor. Existing robotic systems may require replacement or removal of such pre-existing infrastructure, increasing costs and time to implement the robotic system. As discussed further herein, a robotic system may include a chassis configured to integrate with existing infrastructure in a warehouse or other distribution center. In this manner, robotic systems according to embodiments herein may be retrofit to existing infrastructure in a warehouse or distribution center, in some embodiments.

Fourth, environments in a warehouse or in distribution centers may vary. For example, the texture, inclination, and regularity of a floor of a warehouse may not be level, may have one or more irregularities (e.g., holes, bumps etc.), expansion joints, or other features that may interrupt consistent operation of a robotic system. Some existing robotic systems operate on an assumption that an operating environment will be regular (e.g., level and without substantial bumps or holes), or will be repaired or constructed to be regular. However, these systems ignore the reality of a variety of environments that evolve and change over time with usage. As discussed further herein, robotic systems according to embodiments herein may include a suspension arrangement configured to allow the robotic system to compensate for an irregular environment, for example, a non-level floor. In some embodiments, the robotic system may be configured to allow for rotation of a supporting chassis and/or supporting legs to compensate for irregular floors. Such an arrangement may allow the robotic system to be used in more environments, without the need of significant expensive and time-consuming construction or repairs.

Fifth, many existing robotic systems have limited range of motion to allow an object to be moved along a conveyor once grasped. However, as noted above, limitations in range of motion limits the size and type of cargo carriers such systems may be used with. According to exemplary embodiments herein, a robotic system may include a plurality of rotational joints allowing for rotation of one or more segments about an upward and/or vertical axis (e.g., an axis generally perpendicular to a transverse plane of a chassis of the robotic system). In some embodiments, a range of motion may be between about 30 degrees and 50 degrees (e.g., ±15 degrees and ±25 degrees. At these ranges of motion, conventional conveying arrangements may be impractical for moving objects. For example, a conventional linear conveyor will have gaps form as one of the segments moves through the range of motion. As a result, objects may get stuck, or may otherwise not successfully move along a transition between the two segments. According to embodiments herein, a robotic system including a rotational joint between two segments may include a conveyor portion configured to move between an engaged and disengaged position. For example, in some embodiments, a roller of a conveyor may move between the engaged and disengaged position. Depending on the rotational position of the two segments, the conveyor portion may move into the engaged position to fill gaps formed by relative rotation of the two segments. In this manner, a robotic system may have a greater range of motion while retaining the ability to handle objects of varying sizes that would otherwise be inhibited by the formation of a gap between the two segments.

Sixth, it may be advantageous to raise, lower, and rotate the chassis assembly during operation to adapt to different operating environments and demands. For example, in some embodiments, one or more supporting legs can be rotated relative to the chassis to raise or lower the chassis to further extend the range of the robotic system or to maneuver within constrained spaces. In another example, in some embodiments, one or more supporting legs can be rotated independently of one another to rotate the chassis about a pitch or roll axis to shift weight distribution and mechanical stress on the robotic system.

Seventh, it may be advantageous for an end effector (sometimes also referred to herein as an “end of arm tool,” a “gripper,” and/or the like) to be able to engage and move target objects without requiring additional clearance around a frame of the end effector. For example, in some embodiments, the end effector includes one or more gripping assemblies that are movable to engage a target object, lift the target object onto an upper surface of one or more conveyors, then position themselves beneath the upper surface to allow the conveyors to move the target object proximally. In such embodiments, the end effector does not require additional clearance on either side, allowing the end effector to engage and move objects that are relatively close to walls and/or other obstructions.

In some embodiments, a robotic system includes a chassis, a first leg, and a second leg. The first leg and the second leg may support the chassis above a floor. The first leg may include a first wheel and the second leg may include a second wheel. The first wheel and the second wheel may be configured to rotate to allow the chassis to move in a first translational degree of freedom (e.g., in a distal and proximal direction or a horizontal direction). In some embodiments, the first wheel and the second wheel may be coupled to a first wheel motor and a second wheel motor, respectively, which drive the first wheel and the second wheel to move the chassis in the first translational degree of freedom. The first leg and the second leg may be further configured to move in an upward direction relative to the chassis to move the chassis in a second translational degree of freedom (e.g., a direction with a vertical component with respect to the transverse plane of the chassis) perpendicular to the first translational degree of freedom. In this manner, the chassis, legs, and wheels may allow the chassis to move in two translational degrees of freedom. The robotic system may further include a segment operatively coupled to the chassis and a gripper. The segment (sometimes also referred to herein as a conveyor arm, a movable arm, and/or the like) may be operatively coupled to the chassis by a first joint that provides at least a first rotational degree of freedom for the segment. For example, the segment can pivot about a proximal end of the segment such that a distal end of the segment moves in an arc when the segment moves in the first rotational degree of freedom. The gripper may be operatively coupled to the distal end of the segment by a second joint. The second joint may be configured to provide a second rotational degree of freedom for the gripper. In some embodiments, a first axis of the first rotational degree of freedom and a second axis of the second rotational degree of freedom are generally parallel (e.g., each positioned in a plane parallel to the transverse plane of the chassis, each positioned in a plane parallel to a longitudinal plane of the chassis, each positioned in a plane generally perpendicular to the transverse plane of the chassis, and/or the like). For example, if the first rotational degree of freedom is a pitch degree of freedom (e.g., rotation about a transverse horizontal axis that is generally parallel to the transverse plane of the chassis), the second rotational degree may also be a pitch degree of freedom. As another example, if the first degree of freedom is a yaw degree of freedom (e.g., rotation about a vertical axis that is generally perpendicular to the transverse axis of the chassis), the second rotational degree of freedom may also be a yaw degree of freedom. As with the first joint, the second joint may allow the gripper to move in an arc based on the position of the distal end of the segment. The robotic system may include one or more actuators (e.g., linear actuators, hydraulic actuators, motors, etc.) configured to move the segment and the gripper in their respective degrees of freedom to allow a gripper to reach and grasp an object in a cargo carrier in combination with moving the chassis in the first and second translational degrees of freedom, as will be discussed further herein.

In some embodiments, a robotic system includes a chassis, a segment, and a gripper. A first joint may operatively couple the segment to the chassis, for example, at a proximal end of the segment. A second joint may operatively couple the gripper to the chassis, for example, at a distal end of the segment. In some embodiments, the first joint is configured to provide two rotational degrees of freedom to the segment relative to the chassis, and the second joint is configured to provide two rotational degrees of freedom to the gripper relative to the segment. In some embodiments, the first joint may provide a first rotational degree of freedom (e.g., pitch) and the second joint may provide a corresponding second rotational degree of freedom (e.g., pitch). The first joint may also provide a third degree of freedom (e.g., yaw) and the fourth joint may provide a corresponding fourth rotational degree of freedom (e.g., yaw). In some embodiments, rotating the segment about the first joint may change the position of the gripper coupled to the distal end of the segment, for example within a semispherical range. The rotation of the gripper about the second joint may allow an orientation of a gripper with respect to the cargo carrier or a vertical plane of objects (e.g., a plane generally parallel to a coronal and/or frontal plane of the cargo carrier) to be maintained while the position of the gripper is changed by rotation of the segment. For example, without the second joint, an orientation of the gripper may change with rotation of the segment. However, by rotating the gripper about the second joint the orientation of the gripper may be maintained while the segment is rotated. An arrangement of a segment and gripper with two joints providing a semispherical range of motion for the gripper may be supplemented by a chassis including a translational degree of freedom allowing the semispherical range to be moved in the translational degree of freedom. Accordingly, to access an object disposed in a rectangular vertical plane (e.g., the coronal and/or frontal plane of the cargo carrier), a gripper may move within the semispherical range in combination with movement of the chassis in the translational degree of freedom to allow the gripper to reach any portion of the rectangular vertical plane.

In some embodiments, a robotic system includes a series of conveyors configured to move objects from a distal location (e.g., a distal end of a gripper) to a proximal location, for example, to move the objects out of a cargo carrier and into a warehouse or other location where the objects can be accessed. In contrast to conventional approaches, robotic systems of embodiments herein may extend to a distal end of a robotic system. Accordingly, a gripper of a robotic system may be configured to lift and/or drag an object onto a distal conveyor, whereupon the series of conveyors may move the object in a proximal direction. In some embodiments, a robotic system may include a distal conveyor, a segment conveyor, and a proximal conveyor. The distal conveyor may be disposed on a gripper of the robotic system. The segment conveyor may be disposed on a segment and may be configured to receive an object from the distal conveyor. The proximal conveyor may be configured to receive the object from the segment conveyor. The segment conveyor may be configured to move relative to the proximal conveyor, and the distal conveyor may be configured to move relative to the segment conveyor. For example, a segment may be operatively coupled to the proximal conveyor by a first joint, and the gripper may be operatively coupled to the segment by a second joint. Each of the first joint and the second joint may provide one or more rotational degrees of freedom, allowing the position of the gripper to be adjusted while maintaining a continuous conveyor from a distal end of the robotic system to proximal end of the robotic system. In some embodiments, the first joint may include a first joint conveyor configured to move an object from the segment conveyor to the proximal conveyor. In some embodiments, the second joint may include a second joint conveyor configured to move an object from the distal conveyor to the segment conveyor. In some embodiments, the first joint conveyor and the second joint conveyor may include a plurality of rollers, whereas the distal conveyor, segment conveyor, and the proximal conveyor may include belts. Various conveyor arrangements are discussed further with reference to embodiments herein. In some embodiments, a robotic system may be configured to move an object in a proximal direction to a warehouse conveyor, which in some cases may be pre-existing in the warehouse.

In some embodiments, a robotic system may include a chassis, a first leg, and a second leg. As noted above, in some embodiments, the first leg and the second leg may be configured to move in an upward direction relative to the chassis to move the chassis in a translational degree of freedom (e.g., an upward and/or vertical degree of freedom). In some embodiments, the legs may have an upper end and a lower end. The lower end may be coupled to a wheel. The upper end may be coupled to the chassis at a leg joint, allowing the leg to rotate relative to the chassis about the upper end. In some embodiments, moving in an upward direction may include such a rotation relative to the chassis. The robotic system may include at least one leg actuator coupled to the first leg and the second leg to move the first and second legs in the upward direction. In some embodiments, the first leg may be configured to move in the upward direction independently of the second leg. According to some such embodiments, the independent movement of the first leg and the second leg may rotate the chassis in a rotational degree of freedom. For example, if the first leg is a right leg and the second leg is a left leg, the independent movement of the first leg and/or second leg may rotate the chassis in a chassis roll rotational degree of freedom (e.g., rotation about a longitudinal axis that is generally parallel with a longitudinal plane of the chassis). As another example, if the first leg is a distal leg and the second led is a proximal leg, the independent movement of the first leg and/or second leg may rotate the chassis in a chassis pitch rotational degree of freedom (e.g., rotation about a transverse axis that is generally parallel with a transverse plane of the chassis). In some embodiments, a robotic system may further include a third leg having a third wheel and a fourth leg having a fourth wheel. Like the first and second legs, the third and fourth legs may also be coupled to the chassis and configured to move in an upward direction to move the chassis in the translational degree of freedom. In some embodiments, the third and fourth leg may also be independently movable, for example, by separate leg actuators. In some such embodiments, movement of the first, second, third, and fourth legs independently may allow the chassis to be rotated in a chassis roll rotational degree of freedom and a chassis pitch rotation degree of freedom. In some embodiments, the third leg and the fourth leg may be proximal legs, and the first and second leg may be distal legs. In some such embodiments, the third wheel and fourth wheel may be formed of a different material than the first and second wheel, which may improve performance of the robotic system when moving in a proximal or distal direction when the wheels rotate, as will be discussed further herein.

According to some embodiments herein, a robotic system may be employed with a warehouse conveyor, which in some instances may be pre-existing. In such cases, robotic systems of embodiment herein may be retrofit onto existing telescoping warehouse conveyors (or otherwise extending and retracting conveyors). Additionally, in non-retrofit cases, telescoping warehouse conveyors may also be employed with robotic systems described herein. In either case, a chassis of a robotic system may be driven in a first translational degree of freedom that is parallel to directions of extension and retraction of a conveyor semi-independently from the conveyor. In some arrangements, the extension and retraction of a conveyor may not generate sufficient force to move the robotic system in the first translational degree of freedom, in some embodiments. Accordingly, a robotic system may include one or more wheels coupled to motors that are used to drive the wheels to move the robotic system in the first degree of freedom. Operating the wheels and the extension or retraction of the conveyor to ensure both the robotic system and conveyor move together is difficult, especially in cases where the control of the extension of the conveyor is separate from the control of the robotic system, which may commonly be the case in retrofit installations. In some embodiments, a robotic system may include a chassis joint configured to couple an extending and retracting conveyor to a chassis of the robotic system. In some embodiments, the chassis joint includes a conveyor mount attached to the conveyor, and a chassis mount attached to the chassis. The conveyor mount and the chassis mount are configured to slide relative to one another in the first translational degree of freedom. The chassis mount may further include a position sensor configured to output a signal indicative of a relative position of the warehouse mount and the chassis mount. The signal may be received by a local controller that may drive wheels of the robotic system based on the signal. In this manner, the chassis joint may (1) provide some tolerance for relatively movement between the conveyor and the chassis; and (2) allow the robotic system to automatically follow the extension or retraction of the conveyor. In some embodiments, the chassis joint may further include a spring (e.g., compression spring, tension spring, torsion spring, air spring, etc.) or another biasing member configured to bias the chassis mount and the conveyor mount toward a neutral relative position with one another. The spring may also avoid shock forces to either the chassis mount or the conveyor mount in the case the conveyor or chassis move independently from one another.

In some embodiments, a chassis joint of a robotic system may provide additional degrees of freedom to a robotic system chassis relative to a conveyor disposed in a surrounding environment. For example, in some cases it may be desirable to allow a chassis to rotate to accommodate variations in a floor profile, variations in height of a cargo carrier relative to a floor, or otherwise allow a distal end of the robotic system to reach certain locations within a cargo carrier. In some embodiments, a chassis may be configured to move in an upward translational degree of freedom, for example, but moving legs of the robotic system in an upward direction. In some such embodiments, a conveyor to which the chassis is attached may not move in an upward direction. Accordingly, a chassis joint may include a chassis mount and a warehouse mount that are configured to slide relative to one another in an upward direction. In some embodiments, a chassis mount may include an upward (or fully vertical) shaft and an upward couple configured to slide on the upward shaft to allow the warehouse mount to correspondingly slide relative to the upward shaft. The upward shaft may be attached to the chassis. In some embodiments, a chassis mount may include two upward shafts and two upward couplers. In some embodiments, a chassis may have a chassis roll degree of freedom and/or a chassis pitch degree of freedom. In embodiments where the chassis has a chassis pitch degree of freedom, a chassis mount may include a coupler configured to rotate about a transverse horizontal axis (e.g., generally parallel to the transverse plane of the chassis). The coupler may therefore accommodate change in pitch angle of the chassis relative to the conveyor mount and conveyor. In embodiments wherein the chassis has a chassis roll degree of freedom, the chassis mount may include a first coupler and a second coupler interconnected by an axle. The axle may be coupled to the warehouse mount via a swivel joint, allowing the axle to rotate about a longitudinal axis of the robotic system (e.g., in a roll direction). Accordingly, when the chassis rotates in the roll direction, one of the first and second couplers will move upwards, and the other of the first and second couplers will move down, thereby accommodating the roll rotation while the conveyor mount does not rotate. In some embodiments, each of these approached may be used alone or in any combination to provide the desired degrees of freedom to a chassis of a robotic system.

In some embodiments, a robotic system may be configured to load or unload a cargo carrier automatically or semi-automatically. In some embodiments, a robotic system may employ computer vision and other sensors to control actions of various components of the robotic system. In some embodiments, a robotic system may include a gripper including at least one suction cup and at least one conveyor. The at least one suction cup may be configured to grasp an object when a vacuum is applied to the at least one suction cup, and the conveyor may be configured to move the object in a proximal direction after being grasped by the at least one suction cup. The robotic system may also include a vision sensor configured to obtain image information including a plurality of objects arrayed in a vertical plane within a cargo carrier (e.g., within a coronal and/or frontal plane of the cargo carrier). For example, the vision sensor may be a camera configured to obtain a visual spectrum image of the plurality of object in the cargo container. In some embodiments, the plurality of objects may be boxes stacked in the vertical plane. According to embodiments herein, a robotic system may further include one or more distance sensors configured to measure a distance from the one or more distance sensors to the plurality of objects arrayed in the vertical plane. In some embodiments, the one or more distance sensors may include one or more laser rangefinders. The one or more distance sensors may be configured to obtain plurality of distance measurements in an upward (and/or fully vertical) direction and a second plurality of distance measurements in a horizontal direction to allow a robotic system to identify and grasp objects for removal from the cargo container, as discussed further below.

Many conventional approaches for computer vision are computationally intensive and subject to error in dynamic, variable environments. For example, in the case of boxes, boxes may have different colors, labels, orientations, sizes, etc., which may make it difficult to reliably identify the boundaries of the boxes within a cargo container with computer vision alone. Accordingly, in some embodiments a robotic system may include a local controller configured to receive both image information and information from one or more distance sensors to more consistently identify objects within a cargo carrier for removal by the robotic system in a less computationally intensive manner. The local controller may include one or more processors and memory. The local controller may receive image information from at least one vision sensor that images a plurality of objects arranged in a vertical plane within the cargo carrier. The local controller may identify, based on the image, a minimum viable region corresponding to a first object of the plurality of objects. The minimum viable region may be a region of image corresponding to a high confidence of being a single object. In some cases, a minimum viable region may be assigned based on known smallest dimensions of objects within the cargo carrier. In other embodiments, the minimum viable region may be assigned by one or more computer vision algorithms with a margin of error. The minimum viable region may be smaller than the size of an object in the plurality of objects. After assigning the minimum viable region, the controller may command the gripper to grasp the first object within the minimum viable region, for example, by applying a vacuum to at least one suction cup. The controller may further command the gripper to lift the first object after it is grasped to create a gap between the grasped object and an underlying object. The controller may then receive from the one or more distance sensors distance measurements in a vertical direction. Based on these distance measurements, the controller may identify a bottom boundary of the lifted object. For example, the identification may be based on a stepwise change in the distance measurements. The minimum viable region may be expanded based on the identified bottom boundary. In a similar manner, the controller may also obtain a plurality of distance measurements in a horizontal direction. Based on these horizontal distance measurements, a side boundary of the object may be identified, and the minimum viable region horizontal dimension updated and extended. Once the minimum viable region matches the region of the object, the object may be removed from the plurality of objects. The controller may then subtract the minimum viable region from the previously obtained image and proceed to assign a new minimum viable region based on the remaining image. In this manner, operation of the robotic system may be based on capturing a single image of all objects to be removed, and operation may continue by subtracting regions from the original image without capturing a new image. Such an arrangement may be particularly effective in instances where objects are arranged in multiple vertical layers, as the objects behind previously removed objects may not be falsely identified as being next for removal.

In some embodiments, the robotic system includes a movable base, a movable arm having a proximal end coupled to the movable base at a first joint and a distal end opposite the proximal end, a second joint coupled to the distal end of the movable arm, and an end effector coupled to the second joint. The movable arm can include one or more conveyor elements that are operable to move a target object from the distal end to the proximal end. The first joint can be configured to allow the movable arm to pivot about a first axis and a second axis with respect to the movable base. Similarly, the second joint can be configured to rotate about a fourth axis with respect to the movable arm and/or allow the end effector to rotate about a third axis with respect to the second joint. In various embodiments, the second joint can include a first retractable component positioned on a first side of the second joint and/or a second retractable component positioned on a second side of the second joint. The second joint can be configured to raise and lower the first retractable component in response to a rotation of the end effector about the third axis to provide and retract additional support for the target object. Similarly, the second joint can be configured to raise and lower the second retractable component opposite the first retractable component in response to the rotation of the end effector about the third axis to provide and retract additional support for the target object. In some embodiments, the second joint includes a track operably coupling the first retractable component to a central component of the second joint. In such embodiments, the rotation of the end effector about the third axis can move the first retractable component to automatically raise and/or lower the first retractable component as the end effector rotates about the third axis. In some embodiments, the second joint includes a first drive system configured to rotate the second joint and the end effector about the fourth axis and a second drive system configured to rotate the end effector about the third axis. In some embodiments, the second joint includes a drive system configured to rotate the second joint and the end effector with respect to the movable arm. In some such embodiments, the drive system includes a linking pulley and a linking belt coupled between the linking pulley and the first joint. The linking belt can be positioned to translate rotation about the second axis of the movable arm with respect to the movable base into motion in the linking pulley.

In some embodiments, the end effector includes a frame having a proximal end region configured to be couplable to the second joint (or another suitable component) and a distal end region opposite the proximal end region. The end effector can also include one or more conveyors and a gripper assembly each carried by the frame. The one or more conveyors can be positioned to move an object toward the proximal end region of the frame. The gripper assembly can include one or more gripper elements that are configured to engage a target object. Further, the gripper assembly can be configured to move the gripper element(s) to a first position at which the gripper element(s) protrude beyond the distal end region of the frame to pick up an object, a second position to place the object on an upper surface of one or more of the one or more conveyors, and a third position below the upper surface such that the one or more of the plurality of conveyors move the object toward the proximal end region of the frame over the gripper element(s).

In some embodiments, the gripper assembly also includes a vertical actuation component operably coupled to the gripper element(s). In such embodiments, the vertical actuation component is movable between a lowered state and a raised state to help move the gripper element(s) between the second position and the third position. In some embodiments, the vertical actuation component includes one or more links each having a first end at a fixed height relative to the upper surface of the one or more conveyors and a second end operably coupled to one of the gripper element(s). In such embodiments, each of the links can pivot about the first end between the lowered state and the raised state. In some embodiments, the vertical actuation component includes one or more expandable components each having a first end region at a fixed height relative to the upper surface of the plurality of conveyors and a second end region operably coupled to one of the gripper element(s). In such embodiments, the expandable component expands to move the second end region in an upward direction between the lowered state and the raised state.

In some embodiments, the gripper assembly includes an actuation base movable in a lateral direction relative to the one or more conveyors. In some embodiments, the gripper assembly includes one or more vacuum generation components carried by the actuation base and operably coupled to one or more of the gripper elements to provide a vacuum force to grip the object. For example, the vacuum generation component(s) can be fluidically coupled to one or more of the gripper elements via a fluid line (e.g., a vacuum line). Further, in some such embodiments, each vacuum generation component is further operably coupled to one or more of the gripper elements to provide a positive pressure to disengage the gripper element(s) from the object. In some embodiments, the end effector includes a plurality of sensors carried by the frame and positioned to detect one or more target objects and/or an environment around the end effector.

Systems and methods for a robotic system with a coordinated transfer mechanism are described herein. The robotic system (e.g., an integrated system of devices that each execute one or more designated tasks) configured in accordance with some embodiments autonomously executes integrated tasks by coordinating operations of multiple units (e.g., robots).

Several details describing structures or processes that are well-known and often associated with robotic systems and subsystems, but that can unnecessarily obscure some significant aspects of the disclosed techniques, are not set forth in the following description for purposes of clarity. Moreover, although the following disclosure sets forth several embodiments of different aspects of the present technology, several other embodiments can have different configurations or different components than those described in this section. Accordingly, the disclosed techniques can have other embodiments with additional elements or without several of the elements described below.

### Terminology

Many embodiments or aspects of the present disclosure described below can take the form of computer- or controller-executable instructions, including routines executed by a programmable computer or controller. Those skilled in the relevant art will appreciate that the disclosed techniques can be practiced on computer or controller systems other than those shown and described below. The techniques described herein can be embodied in a special-purpose computer or data processor that is specifically programmed, configured, or constructed to execute one or more of the computer-executable instructions described below. Accordingly, the terms “computer” and “controller” as generally used herein refer to any data processor and can include Internet appliances and handheld devices (including palm-top computers, wearable computers, cellular or mobile phones, multi-processor systems, processor-based or programmable consumer electronics, network computers, mini computers, and the like). Information handled by these computers and controllers can be presented at any suitable display medium, including a liquid crystal display (LCD). Instructions for executing computer- or controller-executable tasks can be stored in or on any suitable computer-readable medium, including hardware, firmware, or a combination of hardware and firmware. Instructions can be contained in any suitable memory device, including, for example, a flash drive, USB device, and/or other suitable medium.

In the following, numerous specific details are set forth to provide a thorough understanding of the presently disclosed technology. In other embodiments, the techniques introduced here can be practiced without these specific details. In other instances, well-known features, such as specific functions or routines, are not described in detail in order to avoid unnecessarily obscuring the present disclosure. References in this description to “an embodiment,” “one embodiment,” or the like mean that a particular feature, structure, material, or characteristic being described is included in at least one embodiment of the present disclosure. Thus, the appearances of such phrases in this specification do not necessarily all refer to the same embodiment. On the other hand, such references are not necessarily mutually exclusive either. Furthermore, the particular features, structures, materials, or characteristics can be combined in any suitable manner in one or more embodiments. It is to be understood that the various embodiments shown in the figures are merely illustrative representations and are not necessarily drawn to scale.

References in the present disclosure to “an embodiment” or “some embodiments” mean that the feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the terms “comprise,” “comprising,” and “comprised of” are to be construed in an inclusive sense rather than an exclusive or exhaustive sense. That is, in the sense of “including but not limited to.” The term “based on” is also to be construed in an inclusive sense. Thus, the term “based on” is intended to mean “based at least in part on.”

The terms “coupled” and “connected,” along with their derivatives, can be used herein to describe structural relationships between components. It should be understood that these terms are not intended as synonyms for each other. Rather, in particular embodiments, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements co-operate or interact with each other (e.g., as in a cause-and-effect relationship, such as for signal transmission/reception or for function calls), or both.

The term “module” may refer broadly to software, firmware, hardware, or combinations thereof. Modules are typically functional components that generate one or more outputs based on one or more inputs. A computer program may include or utilize one or more modules. For example, a computer program may utilize multiple modules that are responsible for completing different tasks, or a computer program may utilize a single module that is responsible for completing all tasks.

When used in reference to a list of multiple items, the word “or” is intended to cover all of the following interpretations: any of the items in the list, all of the items in the list, and any combination of items in the list.

Embodiments of the present disclosure are described thoroughly herein with reference to the accompanying drawings. Like numerals represent like elements throughout the several figures, and in which example embodiments are shown. However, embodiments of the claims can be embodied in many different forms and should not be construed as limited to the embodiments set forth herein. The examples set forth herein are non-limiting examples and are merely examples, among other possible examples.

Throughout this specification, plural instances (e.g., “610”) can implement components, operations, or structures (e.g., “610a”) described as a single instance. Further, plural instances (e.g., “610”) refer collectively to a set of components, operations, or structures (e.g., “610a”) described as a single instance. The description of a single component (e.g., “610a”) applies equally to a like-numbered component (e.g., “610b”) unless indicated otherwise. These and other aspects, features, and implementations can be expressed as methods, apparatuses, systems, components, program products, means or steps for performing a function, and in other ways. These and other aspects, features, and implementations will become apparent from the following descriptions, including the claims.

For ease of reference, the robotic system and components thereof are sometimes described herein with reference to top and bottom, upper and lower, upwards and downwards, and/or horizontal plane, x-y plane, vertical, or z-direction relative to the spatial orientation of the embodiments shown in the figures. It is to be understood, however, that the robotic system and components thereof can be moved to, and used in, different spatial orientations without changing the structure and/or function of the disclosed embodiments of the present technology.

Further, embodiments herein may refer to various translational and rotational degrees of freedom. “Translation” may refer to linear change of position along an axis. “Rotation” may refer to an angular change of orientation along an axis. A “pose” may refer to a combination of position and orientation in a reference frame. Degrees of freedom as described herein may be with reference to various reference frames, including global reference frames (e.g., with reference to a gravitational direction) or local reference frames (e.g., with reference to a local direction or dimension, such as a longitudinal dimension, with reference to a cargo carrier, with reference to a vertical plane of object within a cargo carrier, or with reference to a local environment of the robotic system). Rotational degrees of freedom may be referred to as “roll”, “pitch”, and “yaw”, which may be based on a local reference frame such as with respect to a longitudinal and/or transverse plane of various components of the robotic unit (e.g., longitudinal and/or transverse plane of the chassis). For example, “roll” may refer to rotational about a longitudinal axis that is at least generally parallel to a longitudinal plane of the chassis, “pitch” may refer to rotation about a transverse axis perpendicular to the longitudinal axis that is at least generally parallel to a transverse plane of the chassis, and “yaw” may refer to rotation about a second transverse axis perpendicular to both the longitudinal axis and the transverse axis and/or perpendicular to both the longitudinal plane and the transverse plane of the chassis gripper. In some embodiments, a longitudinal axis may be aligned with proximal and distal directions. In some cases, “proximal” may refer to direction away from a cargo carrier, and “distal” may refer to a direction toward a cargo carrier.

### Overview of Robotic System

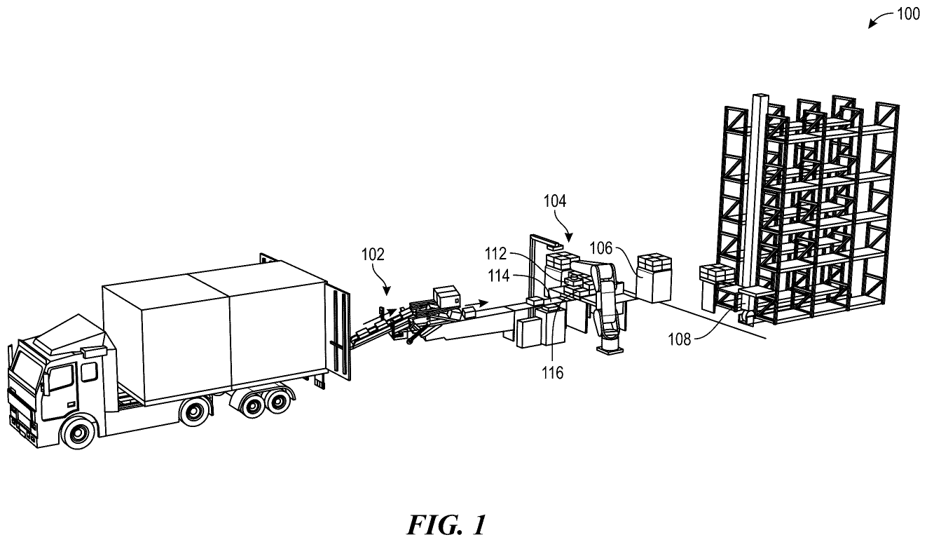

FIG. 1 illustrates an example environment in which a robotic system 100 with a coordinated transfer mechanism may operate. The robotic system 100 can include and/or communicate with one or more units (e.g., robots) configured to execute one or more tasks. Aspects of the coordinated transfer mechanism can be practiced or implemented by the various units.

For the example illustrated in FIG. 1, the robotic system 100 can include an endpoint unit 102, such as a truck loader/unloader, a transfer unit 104 (e.g., a palletizing robot and/or a piece-picker robot), a transport unit 106, a storage interfacing unit 108, or a combination thereof in a warehouse or a distribution/shipping hub. Each of the units in the robotic system 100 can be configured to execute one or more tasks. The tasks can be combined in sequence to perform an operation that achieves a goal, such as to unload objects from a cargo carrier such as a truck or a van and store them in a warehouse or to unload objects from storage locations and prepare them for shipping. In some embodiments, the task can include placing the objects on a target location (e.g., on top of a pallet and/or inside a bin/cage/box/case). As described in detail below, the robotic system 100 can derive individual placement locations/orientations, calculate corresponding motion plans, or a combination thereof for placing and/or stacking the objects. Each of the units can be configured to execute a sequence of actions (e.g., operating one or more components therein) to execute a task.

In some embodiments, the task can include manipulation (e.g., moving and/or reorienting) of a target object 112 (e.g., one of the packages, boxes, cases, cages, pallets, etc. corresponding to the executing task) from a start/source location 114 to a task/destination location 116. For example, the endpoint unit 102 (e.g., a devanning robot) can be configured to transfer the target object 112 from a location in a carrier (e.g., a truck) to a location on a conveyor. Also, the transfer unit 104 can be configured to transfer the target object 112 from one location (e.g., the conveyor, a pallet, or a bin) to another location (e.g., a pallet, a bin, etc.). For another example, the transfer unit 104 (e.g., a palletizing robot) can be configured to transfer the target object 112 from a source location (e.g., a pallet, a pickup area, and/or a conveyor) to a destination pallet. In completing the operation, the transport unit 106 (e.g., a conveyor, an automated guided vehicle (AGV), a shelf-transport robot, etc.) can transfer the target object 112 from an area associated with the transfer unit 104 to an area associated with the storage interfacing 108, and the storage interfacing unit 108 can transfer the target object 112 (by, e.g., moving the pallet carrying the target object 112) from the transfer unit 104 to a storage location (e.g., a location on the shelves). Details regarding the task and the associated actions are described below.

For illustrative purposes, the robotic system 100 is described in the context of a packaging and/or shipping center or warehouse; however, it is understood that the robotic system 100 can be configured to execute tasks in other environments/for other purposes, such as for manufacturing, assembly, storage/stocking, healthcare, and/or other types of automation. It is also understood that the robotic system 100 can include other units, such as manipulators, service robots, modular robots, etc., not shown in FIG. 1. For example, in some embodiments, the robotic system 100 can include a depalletizing unit for transferring the objects from cage carts or pallets onto conveyors or other pallets, a container-switching unit for transferring the objects from one container to another, a packaging unit for wrapping/casing the objects, a sorting unit for grouping objects according to one or more characteristics thereof, a piece-picking unit for manipulating (e.g., for sorting, grouping, and/or transferring) the objects differently according to one or more characteristics thereof, or a combination thereof.

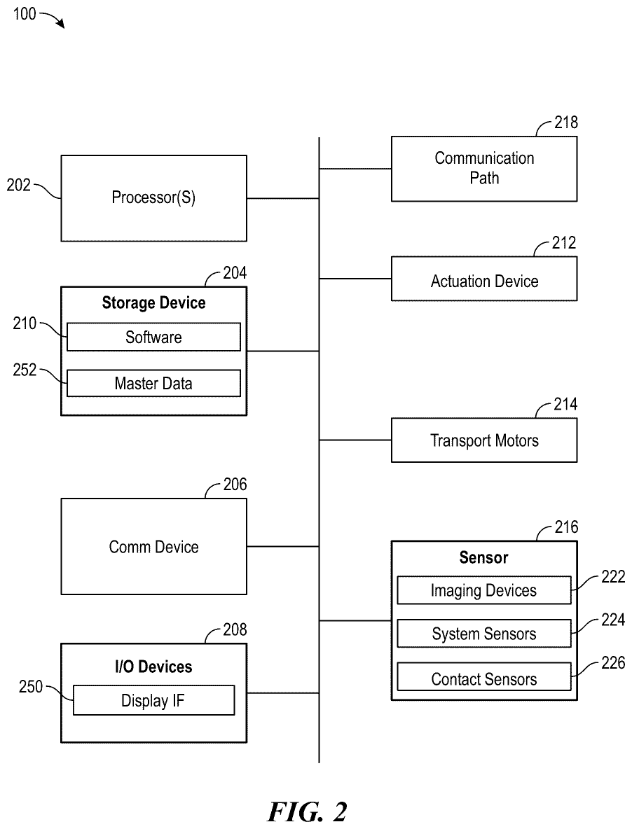

FIG. 2 is a block diagram illustrating the robotic system 100 in accordance with one or more embodiments. In some embodiments, for example, the robotic system 100 (e.g., at one or more of the units and/or robots described above) can include electronic/electrical devices, such as one or more processors 202, one or more storage devices 204 (e.g., non-transitory memory), one or more communication devices 206, one or more input-output devices 208, one or more actuation devices 212, one or more transport motors 214, one or more sensors 216, or a combination thereof. The various devices can be coupled to each other via wire connections and/or wireless connections (e.g., system communication path 218). For example, the robotic system 100 can include a bus, such as a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an Institute of Electrical and Electronics Engineers (IEEE) standard 1394 bus (also referred to as “Firewire”). Also, for example, the robotic system 100 can include bridges, adapters, processors, or other signal-related devices for providing the wire connections between the devices. The wireless connections can be based on, for example, cellular communication protocols (e.g., 3G, 4G, LTE, 5G, etc.), wireless local area network (LAN) protocols (e.g., wireless fidelity (Wi-Fi)), peer-to-peer or device-to-device communication protocols (e.g., Bluetooth, Near-Field communication (NFC), etc.), Internet of Things (IoT) protocols (e.g., NB-IoT, LTE-M, etc.), and/or other wireless communication protocols.

The processors 202 can include data processors (e.g., central processing units (CPUs), special-purpose computers, and/or onboard servers) configured to execute instructions (e.g., software instructions) stored on the storage devices 204 (e.g., computer memory). In some embodiments, the processors 202 can be included in a separate/stand-alone controller that is operably coupled to the other electronic/electrical devices illustrated in FIG. 2 and/or the robotic units illustrated in FIG. 1. The processors 202 can implement the program instructions to control/interface with other devices, thereby causing the robotic system 100 to execute actions, tasks, and/or operations.

The storage devices 204 can include non-transitory computer-readable mediums having stored thereon program instructions (e.g., software 210). Some examples of the storage devices 204 can include volatile memory (e.g., cache and/or random-access memory (RAM)) and/or non-volatile memory (e.g., flash memory and/or magnetic disk drives). Other examples of the storage devices 204 can include portable memory and/or cloud storage devices.

In some embodiments, the storage devices 204 can be used to further store and provide access to processing results and/or predetermined data/thresholds. For example, the storage devices 204 can store master data 252 that includes descriptions of objects (e.g., boxes, cases, and/or products) that may be manipulated by the robotic system 100. In one or more embodiments, the master data 252 can include a dimension, a shape (e.g., templates for potential poses and/or computer-generated models for recognizing the object in different poses), a color scheme, an image, identification information (e.g., bar codes, quick response (QR) codes, logos, etc., and/or expected locations thereof), an expected weight, other physical/visual characteristics, or a combination thereof for the objects expected to be manipulated by the robotic system 100. In some embodiments, the master data 252 can include manipulation-related information regarding the objects, such as a center-of-mass (COM) location on each of the objects, expected sensor measurements (e.g., for force, torque, pressure, and/or contact measurements) corresponding to one or more actions/maneuvers, or a combination thereof.

The communication devices 206 can include circuits configured to communicate with external or remote devices via a network. For example, the communication devices 206 can include receivers, transmitters, modulators/demodulators (modems), signal detectors, signal encoders/decoders, connector ports, network cards, etc. The communication devices 206 can be configured to send, receive, and/or process electrical signals according to one or more communication protocols (e.g., the Internet Protocol (IP), wireless communication protocols, etc.). In some embodiments, the robotic system 100 can use the communication devices 206 to exchange information between units of the robotic system 100 and/or exchange information (e.g., for reporting, data gathering, analyzing, and/or troubleshooting purposes) with systems or devices external to the robotic system 100.

The input-output devices 208 can include user interface devices configured to communicate information to and/or receive information from human operators. For example, the input-output devices 208 can include a display 250 and/or other output devices (e.g., a speaker, a haptics circuit, or a tactile feedback device, etc.) for communicating information to the human operator. Also, the input-output devices 208 can include control or receiving devices, such as a keyboard, a mouse, a touchscreen, a microphone, a user interface (UI) sensor (e.g., a camera for receiving motion commands), a wearable input device, etc. In some embodiments, the robotic system 100 can use the input-output devices 208 to interact with the human operators in executing an action, a task, an operation, or a combination thereof.

The robotic system 100 can include physical or structural members (e.g., robotic manipulator arms) that are connected at joints for motion (e.g., rotational and/or translational displacements). The structural members and the joints can form a kinetic chain configured to manipulate an end-effector (e.g., the gripper and/or the EOAT) configured to execute one or more tasks (e.g., gripping, spinning, welding, etc.) depending on the use/operation of the robotic system 100. The robotic system 100 can include the actuation devices 212 (e.g., motors, actuators, wires, artificial muscles, electroactive polymers, etc.) configured to drive or manipulate (e.g., displace and/or reorient) the structural members about or at a corresponding joint. In some embodiments, the robotic system 100 can include the transport motors 214 configured to transport the corresponding units/chassis from place to place.

The robotic system 100 can include the sensors 216 configured to obtain information used to implement the tasks, such as for manipulating the structural members and/or for transporting the robotic units. The sensors 216 can include devices configured to detect or measure one or more physical properties of the robotic system 100 (e.g., a state, a condition, and/or a location of one or more structural members/joints thereof) and/or of a surrounding environment. Some examples of the sensors 216 can include accelerometers, gyroscopes, force sensors, strain gauges, tactile sensors, torque sensors, position encoders, etc.

In some embodiments, for example, the sensors 216 can include one or more vision sensors 222 (e.g., visual and/or infrared cameras, 2D and/or 3D imaging cameras, distance measuring devices such as lidars or radars, etc.) configured to detect the surrounding environment. The vision sensors 222 can generate representations of the detected environment, such as digital images and/or point clouds, that may be processed via machine/computer vision (e.g., for automatic inspection, robot guidance, or other robotic applications). As described in further detail below, the robotic system 100 (via, e.g., the processors 202) can process the digital image and/or the point cloud to identify the target object 112 of FIG. 1, the start location 114 of FIG. 1, the task location 116 of FIG. 1, a pose of the target object 112, a confidence measure regarding the start location 114 and/or the pose, or a combination thereof.

For manipulating the target object 112, the robotic system 100 (via, e.g., the various circuits/devices described above) can capture and analyze image data of a designated area (e.g., a pickup location, such as inside the truck or on the conveyor belt) to identify the target object 112 and the start location 114 thereof. Similarly, the robotic system 100 can capture and analyze image data of another designated area (e.g., a drop location for placing objects on the conveyor, a location for placing objects inside the container, or a location on the pallet for stacking purposes) to identify the task location 116. For example, the vision sensors 222 can include one or more cameras configured to generate image data of the pickup area and/or one or more cameras configured to generate image data of the task area (e.g., drop area). Based on the image data, as described below, the robotic system 100 can determine the start location 114, the task location 116, the associated poses, and/or other processing results.

In some embodiments, for example, the sensors 216 can include position sensors 224 (e.g., position encoders, potentiometers, etc.) configured to detect positions of structural members (e.g., the robotic arms and/or the end-effectors) and/or corresponding joints of the robotic system 100. The robotic system 100 can use the position sensors 224 to track locations and/or orientations of the structural members and/or the joints during execution of the task.

### Overview of an Example End-Point Interface System

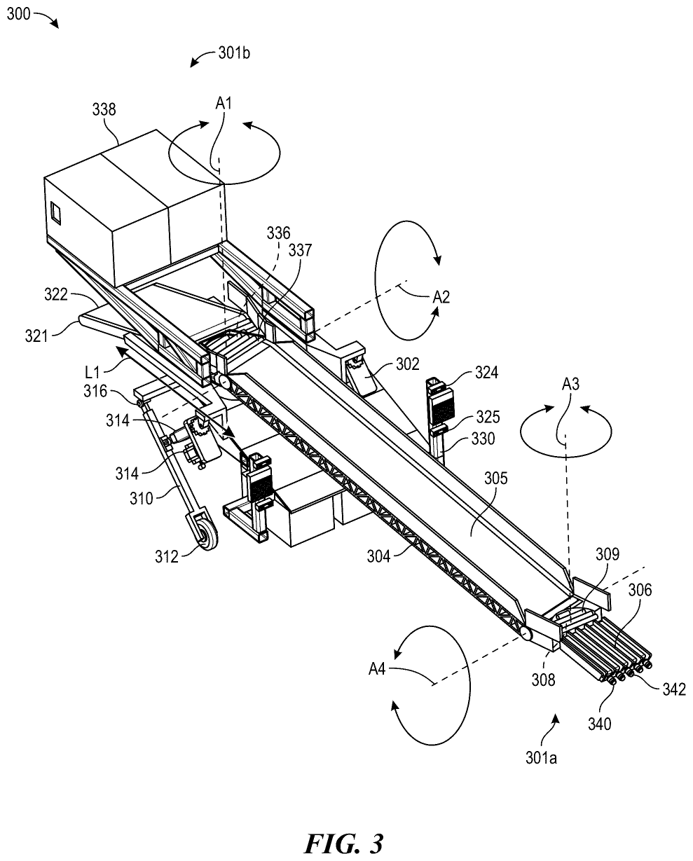

FIG. 3 is a perspective view of a robotic system 300 in accordance with embodiments of the present technology. The robotic system 300 can be an example of the robotic system 100 illustrated in and described above with respect to FIG. 1. In the illustrated embodiment, the robotic system 300 includes a chassis 302, a conveyor arm or first segment 304 (“first segment”) coupled to the chassis 302 and extending toward a distal portion 301a of the robotic system 300, a second segment 321 coupled to the chassis 302 and extending toward a proximal portion 301b of the robotic system 300, and a gripper 306 coupled to the first segment 304 at the distal portion 301a. As discussed above with respect to the robotic system 100, the robotic system 300 can be configured to execute one or more tasks to perform an operation that achieves a goal, such as to unload objects from a cargo carrier (e.g., a truck, a van) and store them in a warehouse, or to unload objects from storage locations and prepare them for shipping. For example, in some embodiments, the robotic system 300 can be positioned such that the second segment 321 is adjacent to a warehouse conveyor. Objects can then be conveyed along a path formed by the warehouse conveyor, the second segment 321, the chassis 302, and the first segment 304 toward or away from the gripper 306. As discussed in further detail herein, the chassis 302, the first segment 304, the second segment 321, and the gripper 306 can be actuated to various positions and/or angular positions, or otherwise operated, such that objects can be conveyed between the warehouse to the cargo carrier in a desired and efficient manner.

The robotic system 300 can also include supporting legs 310 coupled to the chassis 302, one or more controllers 338 supported by the chassis 302, first joint rollers 309 coupled between the first segment 304 and the gripper 306, and second joint rollers 337 coupled between the first segment 304 and the second segment 321. The chassis 302, the first segment 304, the second segment 321, the sensor arms 330, the supporting legs 310, and/or other components of the robotic system 300 can be made from metal (e.g., aluminum, stainless steel), plastic, and/or other suitable materials.

The chassis 302 can include a frame structure that supports the first segment 304, the second segment 321, the controllers 338, and/or one or more sensor arms 330 coupled to the chassis 302. In the illustrated embodiment, two sensor arms 330 each extend vertically on either side of the first segment 304. An upper sensor 324 (e.g., an upper vision sensor) and a lower sensor 325 (e.g., a lower vision sensor) are coupled to each sensor arm 330 along a vertical direction and are positioned to generally face toward the distal portion 301a.

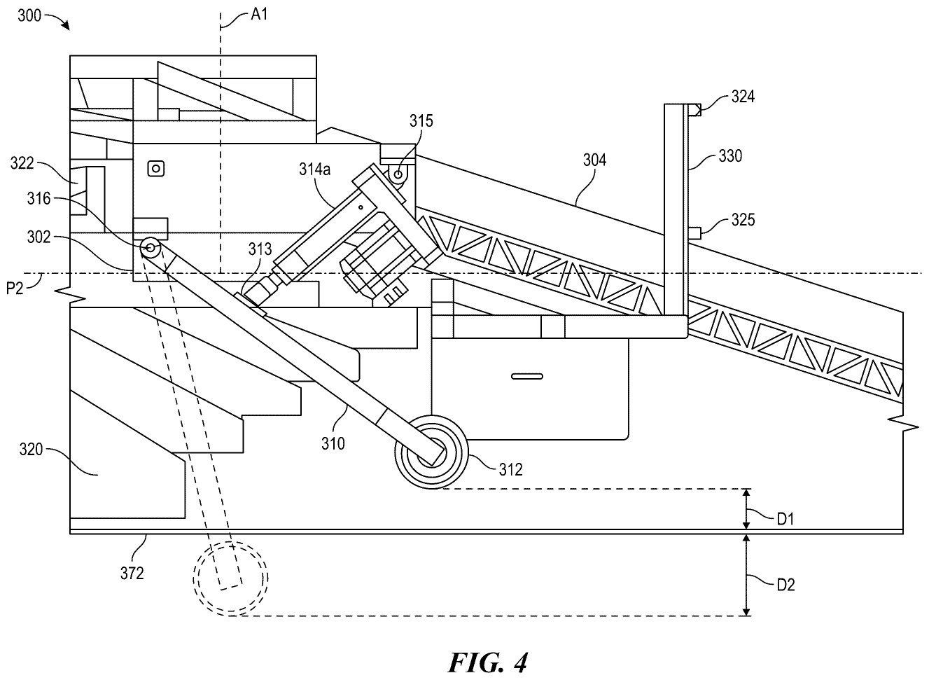

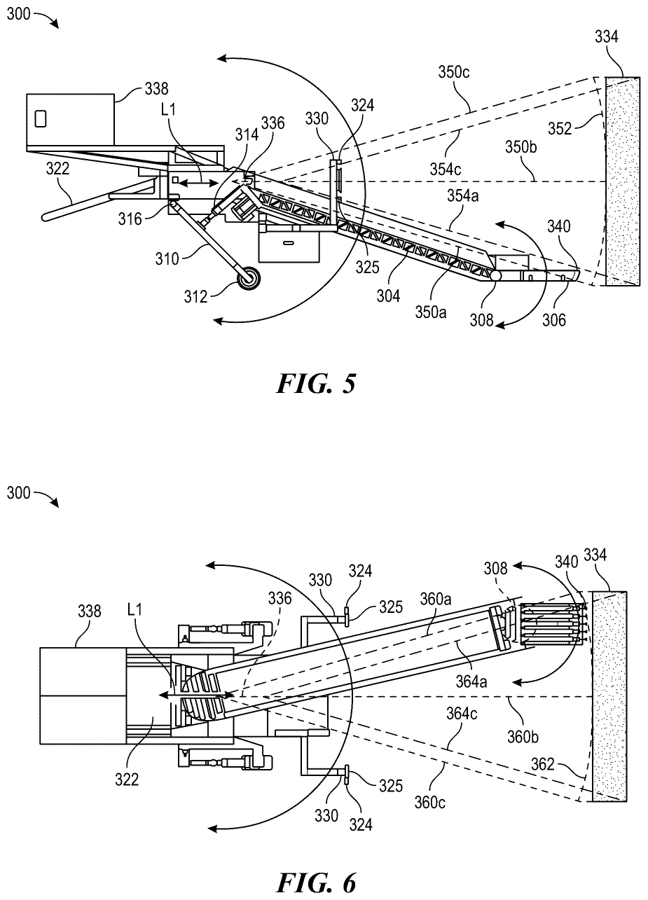

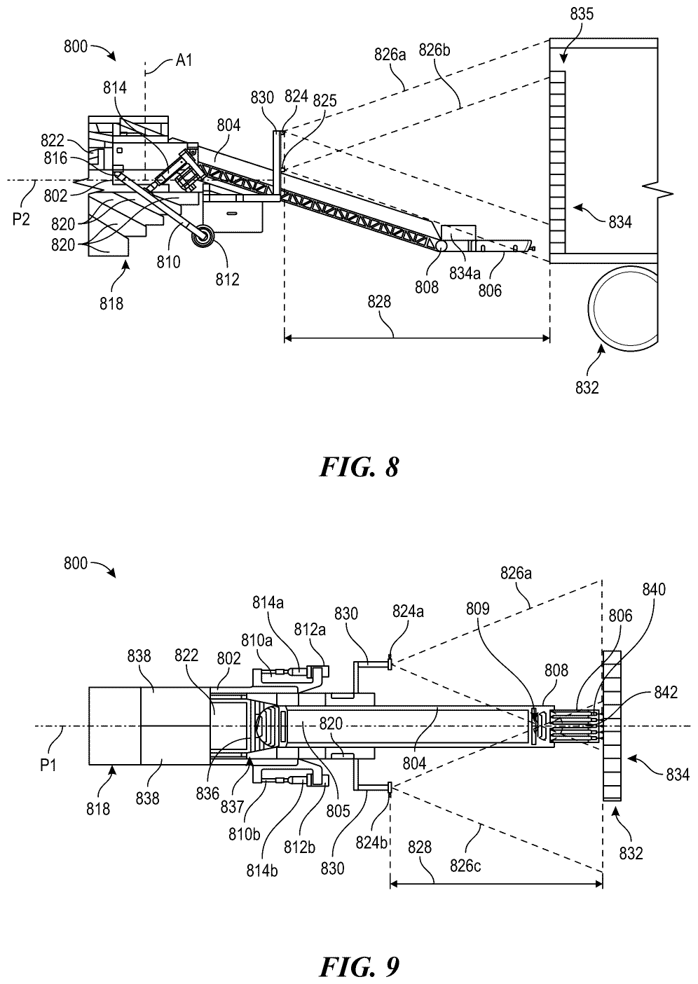

The first segment 304 is coupled to extend from the chassis 302 toward the distal portion 301a in a cantilevered manner. The first segment 304 supports a first conveyor 305 (e.g., a conveyor belt) extending along and/or around the first segment 304. Similarly, the second segment 321 is coupled to extend from the chassis 302 in a cantilevered manner, but toward a proximal portion 301b of the robotic system 300. The second segment 321 supports a second conveyor 322 (e.g., a conveyor belt) extending along and/or around the second segment 321. In some embodiments, one or more actuators 336 (e.g., motors) configured to move the first and second conveyors 305, 322 are coupled to the chassis 302. In some embodiments, the actuators are positioned elsewhere (e.g., housed in or coupled to the first and/or second segments 304, 321). The actuators 336 can also be operated to rotate the first segment 304 about a first axis A₁ and/or a second axis A₂. As illustrated in FIG. 3, the first axis A₁ can be generally orthogonal to a transverse plane of the chassis 302 (e.g., a second plane P₂ illustrated in FIG. 4 and FIG. 8) while the second axis A₂ can be generally parallel to the transverse plane of the chassis 302. Said another way, the first axis A₁ can be in a first plane that is generally orthogonal to a second plane containing the second axis A₂. In some embodiments, the actuators 336 can also pivot the second joint rollers 337 about the first and second axes A₁, A₂ or different axes. Movement and/or rotation of the first segment 304 relative to the chassis 302 are discussed in further detail below with respect to FIGS. 5-7B.

As mentioned above, the gripper 306 can be coupled to extend from the first segment 304 toward the distal portion 301a with the first joint rollers 309 positioned therebetween. In some embodiments, the gripper 306 is configured to grip objects using a vacuum and to selectively release the objects. The gripper 306 can include suction cups 340 (and/or any other suitable gripping element, such as a magnetic component, a mechanical gripping component, and/or the like, sometimes referred to generically as “gripper elements,” “gripping elements,” and/or the like) and/or a distal conveyor 342. The suction cups 340 can pneumatically grip objects such that the suction cups 340 can carry and then place the object the distal conveyor 342, which in turn transports the object in the proximal direction.

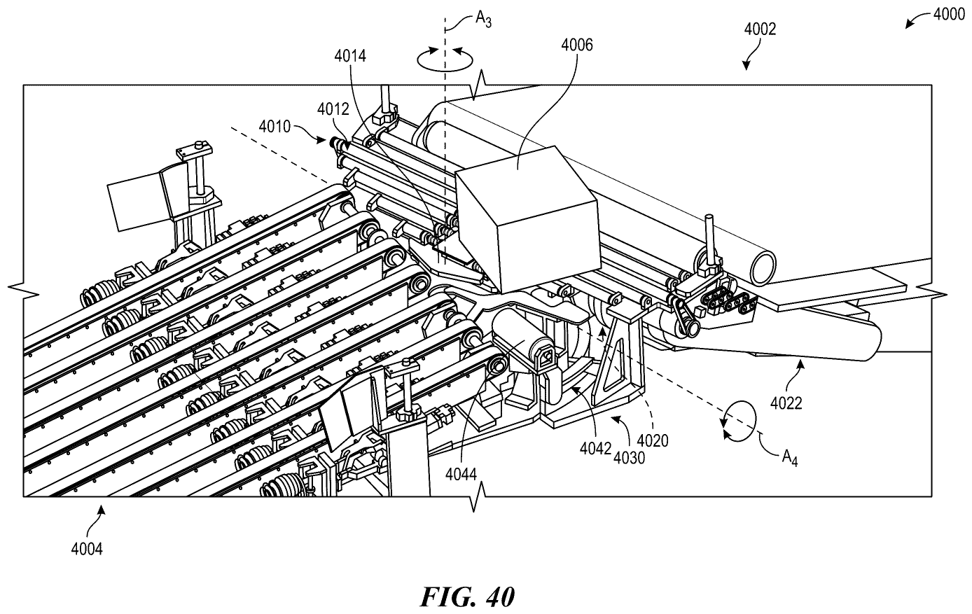

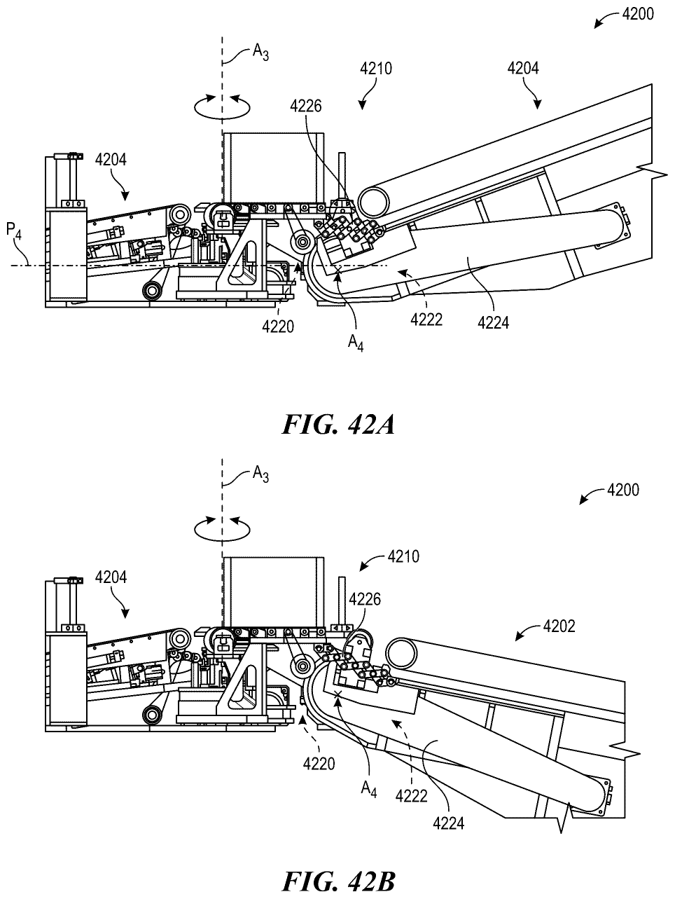

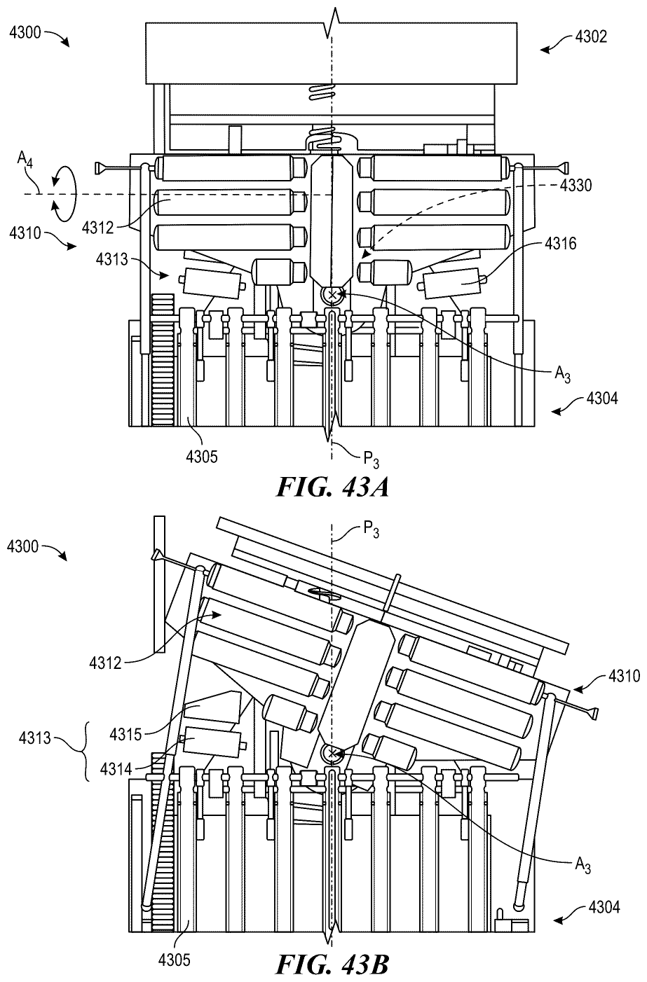

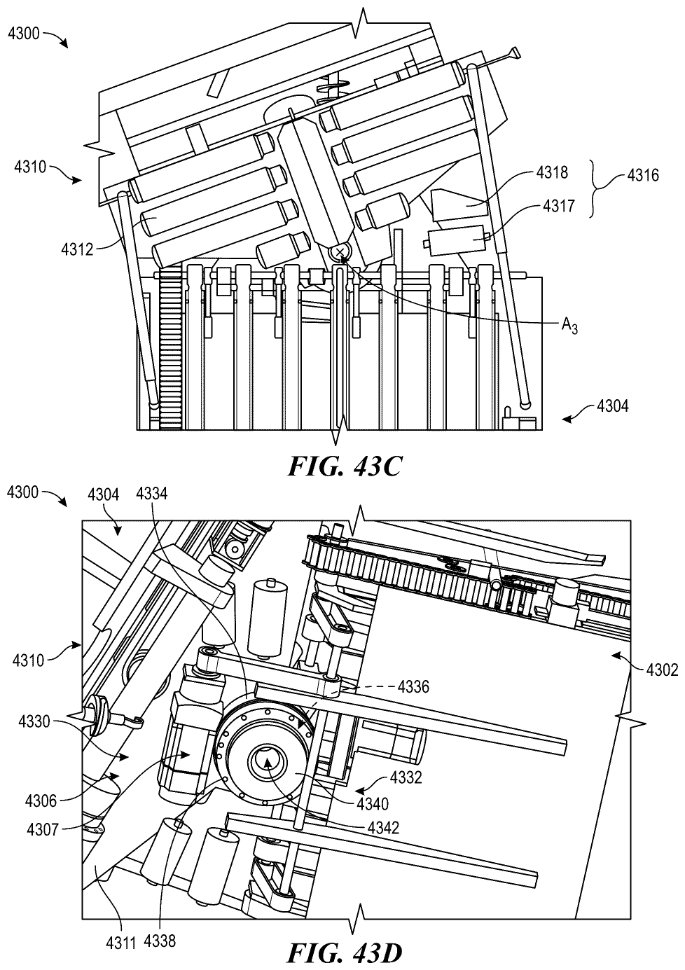

In some embodiments, one or more actuators 308 (e.g., motors) are configurated to rotate the gripper 306 and/or the first joint rollers 309 relative to the first segment 304 about a third axis A₃ and/or a fourth axis A₄. As illustrated in FIG. 3 and discussed in more detail below with reference to FIGS. 40-44C, the third axis A₃ can be generally parallel to a longitudinal plane of the gripper 306 (e.g., a third plane P₃ illustrated in FIG. 43A) while the fourth axis A₄ can be generally orthogonal to the longitudinal plane of the gripper 306. Additionally, or alternatively, the third axis A₃ can be generally orthogonal to a transverse plane of the gripper 306 (e.g., a fourth plane P₄ illustrated in FIG. 42A) while the fourth axis A₄ can be generally parallel orthogonal to the transverse plane of the gripper 306. Said another way, the third axis A₃ can be in a third plane that is generally orthogonal to a fourth plane containing the fourth axis A₄. In some embodiments, as discussed in more detail below, the robotic system 300 can maintain the transverse plane of the gripper 306 generally parallel with the transverse plane of the chassis 302 (e.g., such that rotation about the second axis A₂ is met with an opposite rotation about the fourth axis A₄. As a result, for example, in some embodiments, the third axis A₃ can be generally orthogonal to the transverse plane of the chassis 302 and/or the fourth axis A₄ can be generally parallel to the transverse plane of the chassis 302.

In some embodiments, the actuators 308 are configured to operate the suction cups 340 and/or the distal conveyor 342. In some embodiments, the actuators 308 are coupled to the first segment 304, the first joint rollers 309, and/or the gripper 306. Movement and/or rotation of the gripper 306 relative to the second segment 304 and components of the gripper 306 are described in further detail below.

In the illustrated embodiment, two supporting legs 310 are rotatably coupled to the chassis 302 about pivots 316 positioned on either side of the chassis 302. A wheel 312 is mounted to a distal portion of each supporting leg 310. The chassis 302 also supports actuators 314 (e.g., linear actuators, motors) operably coupled to the supporting legs 310. In some embodiments, the robotic system 300 includes fewer or more supporting legs 310, and/or supporting legs 310 configured in different positions and/or orientations. In some embodiments, the wheels 312 can be motorized to move the chassis 302, and thus the rest of the robotic system 300, along linear direction L1. Operation of the actuators 314 is described in further detail below with respect to FIG. 4.

The controllers 338 can be operably coupled (e.g., via wires or wirelessly) to control the actuators 308, 336, 314. In some embodiments, the controllers 338 are positioned to counterbalance the moment exerted on the chassis 302 by, for example, the cantilevered first segment 304. In some embodiments, the robotic system 100 includes counterweights coupled to the chassis 302 to counterbalance such moments.

FIG. 4 is an enlarged side view of the robotic system 300 illustrating actuation of the supporting legs 310 in accordance with embodiments of the present technology. In the illustrated embodiment, the robotic system 300 is positioned on top of a conveyor segment 320 that may already be present at a warehouse or other operating site. Specifically, the chassis 302 is positioned at or over a distal end of the conveyor segment 320 such that the first segment 304 is able to rotate relative to the chassis 302 without abutting against the conveyor segment 320. The conveyor segment 320 can be on a support surface or floor 372 (or other surface) in the warehouse. The robotic system 300 can compensate for uneven floors, sloped floors, and other environments to position one or more of the components with acceptable ranges of positions for transporting objects. For example, the robot system 300 can level the chassis 302 by, for example, moving the chassis 302 relative to the floor 372. The chassis 302 can then be at a generally level orientation (e.g., a traverse plane of the chassis 302 can be generally horizontal) such the conveyor belts of the robotic system 300 are within target ranges of positions for carrying objects.

In the illustrated embodiment, one end of the actuator 314 is rotatably coupled to the chassis 302 via hinge 315. The other end of the actuator 314 is coupled to the supporting leg 310 via a hinge or bearing 313 such that the actuator 314 and the supporting leg 310 can rotate relative to one another. During operation, the actuator 314 can be controlled (e.g., via the controllers 338 shown in FIG. 2) to move the supporting leg 310 between a first state (illustrated in FIG. 4 with solid lines) and a second state (illustrated in FIG. 4 with dotted lines). In the first state, the supporting leg 310 is pulled or otherwise positioned by the actuator 314 toward the hinge 315 such that the wheel 312 is at a level above the floor 372. In some embodiments, the illustrated first state corresponds to the maximum vertical distance (e.g., height) that the wheel 312 can be lifted relative to the floor 372, defined by distance D1. The distance D1 can be at least 140 millimeters (mm), 160 mm, 180 mm, 200 mm, 220 mm, or within a range of 140-220 mm. In the second state, the supporting leg 310 is pushed or otherwise positioned by the actuator 314 away from the hinge 315 such that the wheel 312 is at a level below the floor 372. In some embodiments, the illustrated second state corresponds to the maximum vertical that the wheel 312 can be lowered relative to the floor 372, defined by distance D2. The distance D2 can be at least 290 mm, 310 mm, 330 mm, 350 mm, 370 mm, or within a range of 290-370 mm.

During operation, the supporting legs 310 and the wheels 312 can provide support to the chassis 302 such that the conveyor segment 320 need not support the entire weight of the robotic system 300. As will be described in further detail below, the wheels 312 can also be motorized to move the chassis 302 closer to or away from, for example, a cargo carrier (e.g., a truck). The wheels 312 can be motorized wheels that include one or more move drive motors, brakes, sensors (e.g., position sensors, pressure sensors, etc.), hubs, and tires. The components and configuration of the wheels 312 can be selected based on the operation and environment. In some embodiments, the wheels 312 are connected to a drive train of the chassis 302. The wheels 312 can also be locked (e.g., using a brake) to prevent accidental movement during, for example, unloading and loading cargo from and onto the cargo carrier.

The ability to lift and lower the supporting legs 310 and the wheels 312 attached thereto can be advantageous for several reasons. For example, the supporting legs 310 can be rotated to the illustrated dotted position (e.g., to the distance D2) to lift and/or rotate the chassis 302, further extending the range of the gripper 306. The supporting legs 310 can also be rotated to the illustrated position (e.g., to the distance D1) to lower and/or rotate the chassis 302. In another example, the floor 372 may be uneven such that the conveyor segment 320 and the wheel 312 contact the floor 372 at different levels. The robotic system 300 can therefore adapt to variability in the warehouse environment without requiring additional support mechanisms. In another example, the wheels 312 can be lifted (e.g., while the wheels 312 are locked) to move the conveyor segment 320 (e.g., extend horizontally). The wheels 312 can be lowered once the conveyor segment 320 is moved or extended to the desired position. In yet another example, the robotic system 300 can be moved at least partially into a cargo carrier (e.g., the rear of a truck) to reach cargo or spaces deeper within the cargo carrier. If the floor of the cargo carrier is higher or lower than the floor 372 of the warehouse, the supporting legs 310 can be lifted or lowered accordingly.

In other embodiments, the components described above can be arranged differently from the illustrated embodiment. For example, the actuator 314 can be fixedly coupled to the chassis 302. In another example, the actuator 314 can be positioned behind or proximal of the supporting leg 310 such that the supporting leg 310 is pushed to be lifted and pulled to be lowered.

FIG. 5 is a side view of the robotic system 300 illustrating vertical actuation of the first segment 304 in accordance with embodiments of the present technology. In the illustrated embodiment, the robotic system 300 is positioned and operated to reach a target area 334. The target area 334 can include cargo (e.g., a stack of object, such as boxes, containers, etc.) or other items to be loaded and unloaded. The first segment 304 is shown angled in a lowered position. The gripper 306, which can be rotated (e.g., via the actuators 308) about a pivot point near the actuators 308, is shown oriented generally horizontally. The illustrated position of the first segment 304 can correspond to dotted line 350a, which extends from a pivot point near the actuators 336. During operation, the first segment 304 can be rotated (e.g., by the actuators 336) about the pivot point to a horizontal position corresponding to dotted line 350b, to a raised position corresponding to dotted line 350c, and any position therebetween. In some embodiments, the dotted lines 350a and 350c represent the lowest and highest positions that the first segment 304 can be rotated.

Due to the rotation of the first segment 304 about the pivot point near the actuators 336, the reach of the suction cups 340 of the gripper 306 extends along dotted curve 352. In the illustrated embodiment, the dotted curve 352 can be tangent to the target area 334 such that the suction cups 340 can reach the target area 334 when the first segment 304 is in the horizontal position (dotted line 350b), but not when the first segment 304 is in the lowered (dotted line 350a) or raised (dotted line 350c) positions. To allow the suction cups 340 to reach the entirety of the target area 334 (e.g., position the suction cups 340 generally along the vertical planar target area 334), the robotic system 300 can be moved (e.g., via the motorized wheels and/or extension of the conveyor segment 320 (FIG. 4)) along the linear direction L1. Movement of the robotic system 300 translates the first segment 304 to a new lowered position corresponding to dotted line 354a and a new raised position corresponding to dotted line 354c. As shown by dotted lines, the suction cups 340 can reach the distal-most edge of the target area 334 when the first segment 304 is either in the new lowered (dotted line 354a) or new raised positions (dotted line 354c). As will be discussed in further detail below, the actuators 308 can be operated to rotate the gripper 306 vertically relative to the first segment 304 at any time to reach objects as needed. Furthermore, the upper vision sensors 324 and the lower vision sensors 325 on sensor arms 330 can be used to determine the positions and/or orientations of the first segment 304, the gripper 306, and/or regions of the target area 334, and relay the information to the controllers 338 for real-time control.

FIG. 6 is a top view of the robotic system 300 illustrating horizontal actuation the first segment 304 in accordance with embodiments of the present technology. In the illustrated embodiment, the first segment 304 is shown angled in a left-leaning position. The gripper 306, which can be rotated (e.g., via the actuators 308) about a pivot point near the actuators 308, is shown oriented generally parallel to the chassis 302 (e.g., facing the target area 334). The illustrated position of the first segment 304 can correspond to dotted line 360a, which extends from a pivot point near the actuators 336. During operation, the first segment 304 can be rotated (e.g., by the actuators 336) about the pivot point to a straight position corresponding to dotted line 360b, to a right-leaning position corresponding to dotted line 360c, and any position therebetween. In some embodiments, the dotted lines 360a and 360c represent the most left-leaning and most right-leaning positions that the first segment 304 can be rotated.

Due to the rotation of the first segment 304 about the pivot point near the actuators 336, the reach of the suction cups 340 of the gripper 306 extends along dotted curve 362. In the illustrated embodiment, the dotted curve 362 is tangent to the target area 334 such that the suction cups 340 can reach the target area 334 when the first segment 304 is in the straight position (dotted line 360b), but not when the first segment 304 is in the left-leaning (dotted line 360a) or right-leaning (dotted line 360c) positions. To allow the suction cups 340 to reach the entirety of the target area 334, the robotic system 300 can be moved (e.g., via the motorized wheels and/or extension of the conveyor segment 320 (FIG. 4)) along the linear direction L1. Movement of the robotic system 300 translates the first segment 304 to a new left-leaning position corresponding to dotted line 364a and a new right-leaning position corresponding to dotted line 364c. As shown by dotted lines, the suction cups 340 can reach the distal-most edge of the target area 334 when the first segment 304 is either in the new left-leaning (dotted line 364a) or new right-leaning positions (dotted line 364c). As will be discussed in further detail below, the actuators 308 can be operated to rotate the gripper 306 horizontally relative to the first segment 304 at any time to reach objects as needed. Furthermore, the upper vision sensors 324 and the lower vision sensors 325 on sensor arms 330 can be used to determine the positions and/or orientations of the first segment 304 and the gripper 306, and relay the information to the controllers 338 for real-time control.

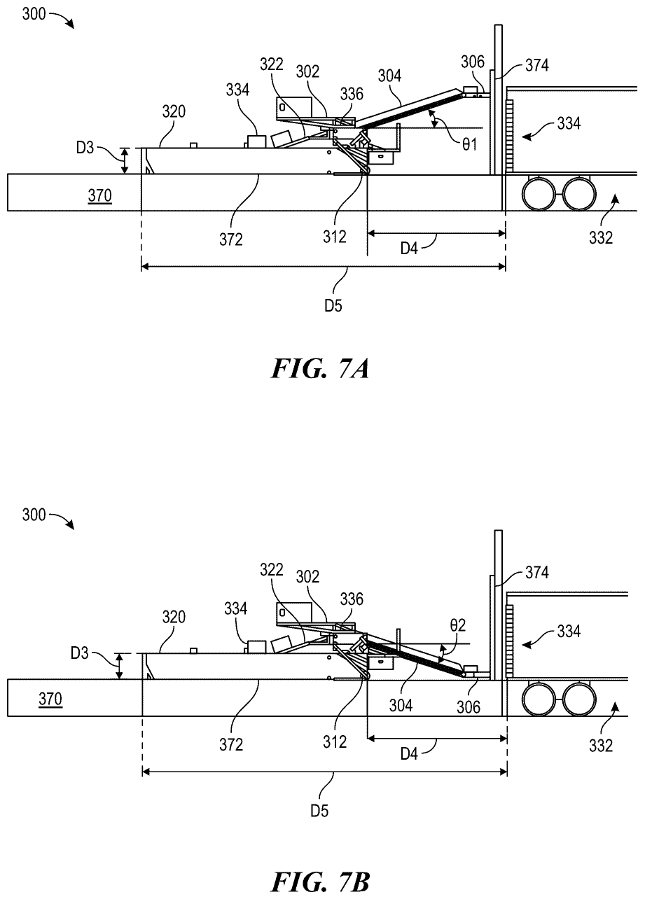

In some embodiments, the vertical motions of the first segment 304 and the gripper 306 illustrated in FIG. 5 can be combined with the horizontal motions of the first segment 304 and the gripper 306 illustrated in FIG. 6. For example, the target area 334 may comprise a rectangular volume (e.g., corresponding to the interior of a truck) and the first segment 304 can be controlled to pivot horizontally, pivot vertically, pivot diagonally, move laterally, and/or move in other directions to reach any desired position in the rectangular target area 334. The entire or most of the length of the robotic system 300 can be moved distally into the trailer (e.g., semi-trailer of FIGS. 1 and 7B) to access objects at the front of the trailer so that robotic system 300 can unload the entire trailer without contacting the sidewalls or ceiling of the trailer. The robotic system 300 can use maximum envelopes for environments, restricted envelopes for accessing objects, and operating or work envelopes for performing tasks. The robotic system 300 can determine robotic work envelops for emptying trailers using, for example, trailer-specific robotic work envelops, user selected robotic work envelops, or the like. The trailer-specific robotic work envelops can be determined based on inspection of the interior of the trailer and be modified any number times during use. A user selected robotic work envelops can be inputted by a user based on the configuration (e.g., dimensions, model type of trailer, etc.) of the trailer. The robotic work envelops can include areas the robotic system 300 is allowed to move or reach, range of motion, etc. The robotic system 300 can perform one or more simulations to evaluate a set of robotic work envelops and predicted outcomes, including unloading times, potential adverse events (e.g., object slippage, likelihood of dropped objects, likelihood of damage to fragile objects, etc.), acceptable conveyor belts speeds based on conveyor belt orientations. The robotic system 300 can select the robotic work envelop from the set of simulated robotic work envelop based on the simulations and predicted outcomes.

FIGS. 7A and 7B are side views of the robotic system 300 illustrating vertical actuation of the first segment 304 relative to a cargo carrier in accordance with embodiments of the present technology. Referring to FIGS. 7A and 7B together, the conveyor segment 320 is on the floor 372 and the chassis 302 is positioned atop the conveyor segment 320 while the wheels 312 are contacting the floor 372. A cargo carrier 332 (e.g., a loading truck) is positioned such that a rear end of the cargo carrier 332 faces a warehouse bay opening 374. In particular, the conveyor segment 320 can be positioned such that a distal end of the conveyor segment 320 is at a distance D4 from the rear end cargo carrier 332 and a proximal end of the conveyor segment 320 is at a distance D5 from the rear end of the cargo carrier 332. The conveyor segment 320 can have a height of D3 such the chassis 302 is raised from the floor 372 at the height D3. In some embodiments, the distance D4 can be at least 3 meters (m), 4 m, 5 m, 6 m, 7 m, or within a range of 3-7 m (e.g., 4.7 m). In some embodiments, the distance D5 can be at least 8 meters (m), 10 m, 12 m, 14 m, 16 m, or within a range of 8-16 m (e.g., 12.2 m). In some embodiments, the height D3 can be at least 0.7 meters (m), 0.8 m, 0.9 m, 1.0 m, 1.1 m, or within a range of 0.7-1.1 m. These dimensions can be used to generate, for example, a trailer-specific robotic work envelop. Cargo items 334 can be positioned anywhere in the cargo carrier 332 (e.g., at the rear section, as illustrated) for unloading and/or loading by the robotic system 300. The trailer-specific robotic work envelop can be used to access any of those cargo items 334 can be updated or modified when cargo items 334 are removed.

Referring first to FIG. 7A, the first segment 304 is in the raised position such that the first segment 304 forms angle θ1 with the horizontal. The angle θ1 represent the maximum angle by which the first segment 304 can be raised, and can be at least 16°, 18°, 20°, 22°, 24°, or within a range of 16-24°. In the illustrated embodiment, the length of the first segment 304 and the angle θ1 are such that the gripper 306 reaches the top of the rear end of the cargo carrier 332. To reach farther into the cargo carrier 332, the robotic system 300 and/or the conveyor segment 320 can be distally advanced toward the cargo carrier 332 such that the gripper 306 can reach farther in the cargo carrier 332.

Referring next to FIG. 7B, the first segment 304 is in the lowered position such that the first segment 304 forms angle θ2 with the horizontal. The angle θ2 represent the maximum angle by which the first segment 304 can be lowered, and can be at least 16°, 18°, 20°, 22°, 24°, or within a range of 16-24°. In the illustrated embodiment, the length of the first segment 304 and the angle θ1 are such that the gripper 306 reaches the bottom of the rear end of the cargo carrier 332. The angles θ1, θ2 can be used to determine a robotic work envelop designed to access the objects.

As discussed above, the first segment 304 and the gripper 306 can be moved (e.g., pivoted) between various angles in multiple directions (e.g., vertically, horizontally, diagonally) and the robotic system 300 can be moved distally to reach any desired cargo 334 or space in the cargo carrier 332. For example, conveyor segment 320 may be extended distally and/or the wheels 312 may be operated to move the chassis 302 distally such that the wheels 312 enter the cargo carrier 332. In the illustrated embodiment, the floor 372 of the warehouse 370 and the floor of the cargo carrier 332 are level, so the wheels 312 can remain at the illustrated height while entering the cargo carrier 332. In some embodiments, the wheels 312 can be lifted to avoid any gap between the floor 372 of the warehouse 370 and the floor of the cargo carrier 332. In some embodiments, the floor of the cargo carrier 332 is higher or lower than the floor 372 of the warehouse, in which case the robotic system 300 can lift or lower the wheels 312 accordingly, as discussed above with respect to FIG. 4.

### Methods of Operating Robotic System

FIG. 8 is a side schematic of a robotic system 800 in accordance with one or more embodiments. In the embodiment of FIG. 8, the robotic system includes a chassis 802. The chassis 802 supports a segment 804. As will be discussed herein, the segment 804 is configured to rotate relative to the chassis 802 in two rotational degrees of freedom. The robotic system further includes a gripper 806 that is operatively coupled to the segment 804 at a joint 808. The joint 808 may provide multiple degrees of freedom for the gripper 806 relative to the segment 804. The rotational degrees of freedom of the gripper 806 may be the same as those of the segment 804. In this manner, an orientation of the gripper 806 may be maintained with respect to an environmental reference frame or local reference frame, while the position of the gripper 806 is changed by a change in orientation of the segment 804.

As shown in FIG. 8, the robotic system 800 includes a leg 810 supporting the chassis 802. The leg 810 includes a wheel 812 at a lower end of the leg. The wheel 812 is configured to rotate to allow the chassis 802 to move in a first translational degree of freedom (e.g., a horizontal degree of freedom). For example, the chassis 802 can move linearly in a direction generally parallel to its longitudinal axis, midplane, etc. If the chassis 802 is located on a horizontal surface, the chassis 802 can be moved linearly in a horizontal direction. In the depicted embodiment, the leg is coupled to the chassis at an upper end at a leg joint 816. In the example of FIG. 8, the leg 810 is configured to rotate about the leg joint 816 to move the wheel 812 in a vertical direction to correspondingly move the chassis 802 in a second translational degree of freedom (e.g., a vertical degree of freedom) perpendicular to the first translational degree of freedom. For example, the chassis 802 can move linearly in a direction generally parallel to its traverse plane. If the chassis 802 is located on a horizontal surface, the chassis 802 can be moved linearly in a vertical direction. In some embodiments as shown in FIG. 8, the robotic system 800 includes a leg actuator 814 configured to move the leg in a vertical direction. The leg actuator 814 is configured to rotate the leg 810 about the leg joint 816 in the example of FIG. 8.

The robotic system 800 is configured to move objects 834 (e.g., boxes) disposed in a cargo carrier 832 in a proximal direction to unload the objects from the cargo carrier. In the example of FIG. 8, the robotic system 800 is configured to move the objects to a warehouse conveyor 818 disposed in a warehouse or other object processing center. The warehouse conveyor 818 includes telescoping segments 820 that are configured to extend and retract. The chassis 802 may be coupled to a distal end of the warehouse conveyor 818. As shown in FIG. 8, the robotic system may include a proximal conveyor 822 positioned above the warehouse conveyor and configured to move objects from the segment 804 to the warehouse conveyor 818. The segment 804 includes a segment conveyor configured to move the object 834 to the proximal conveyor 822.

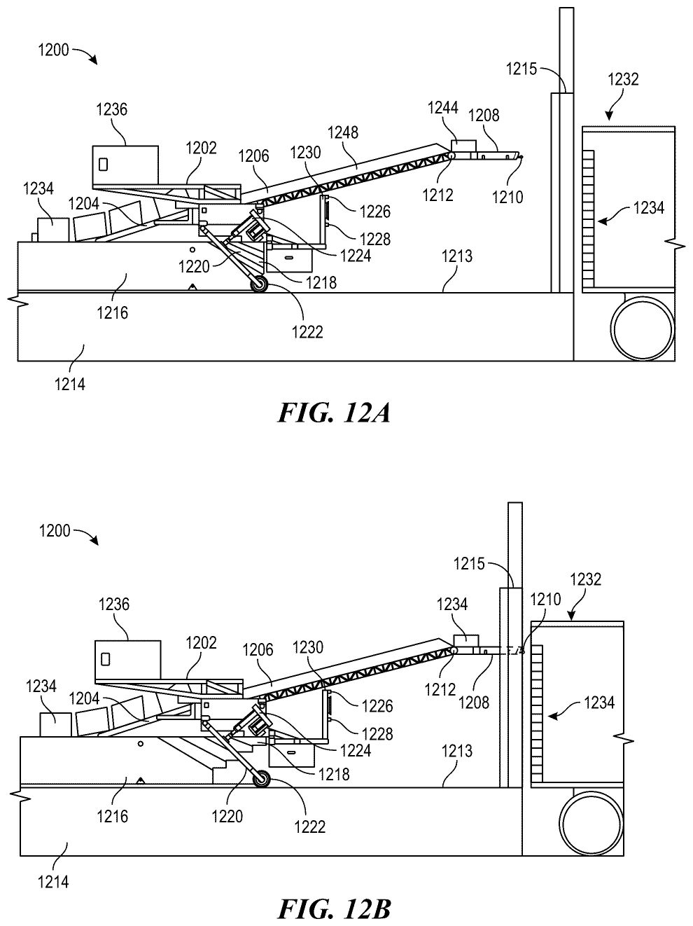

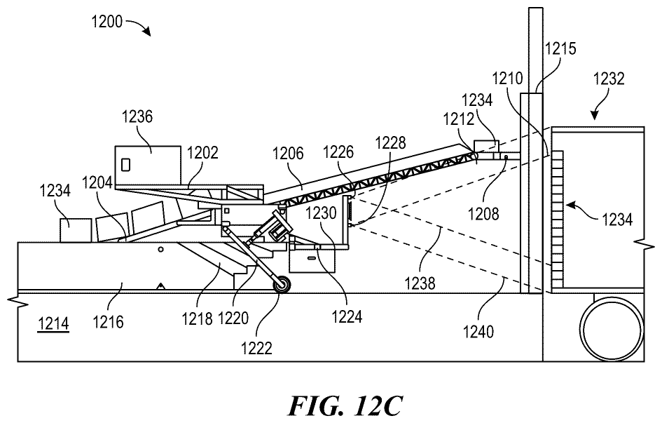

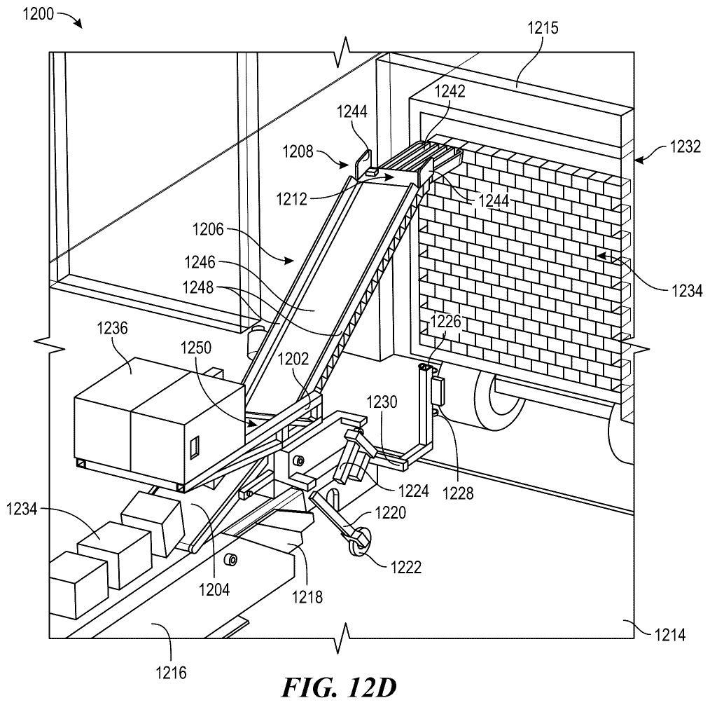

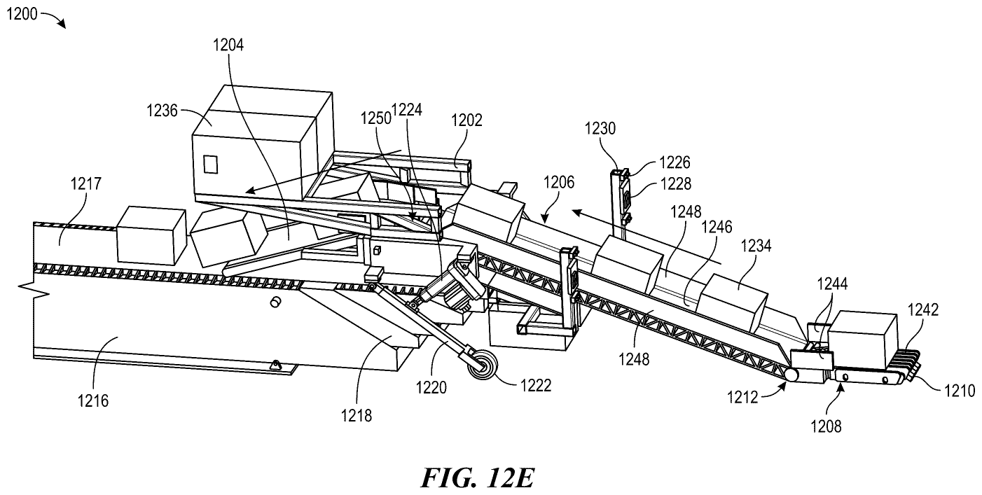

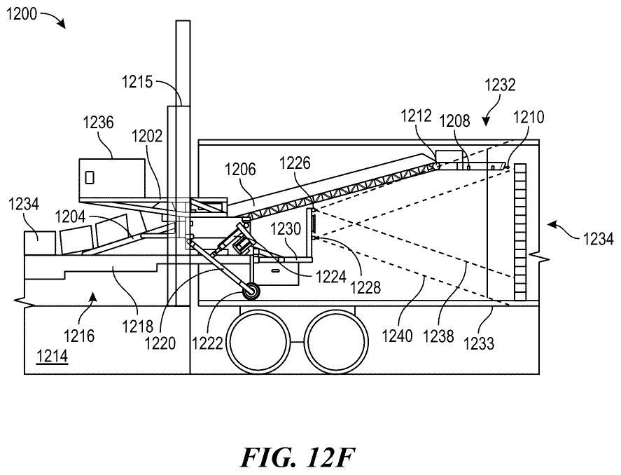

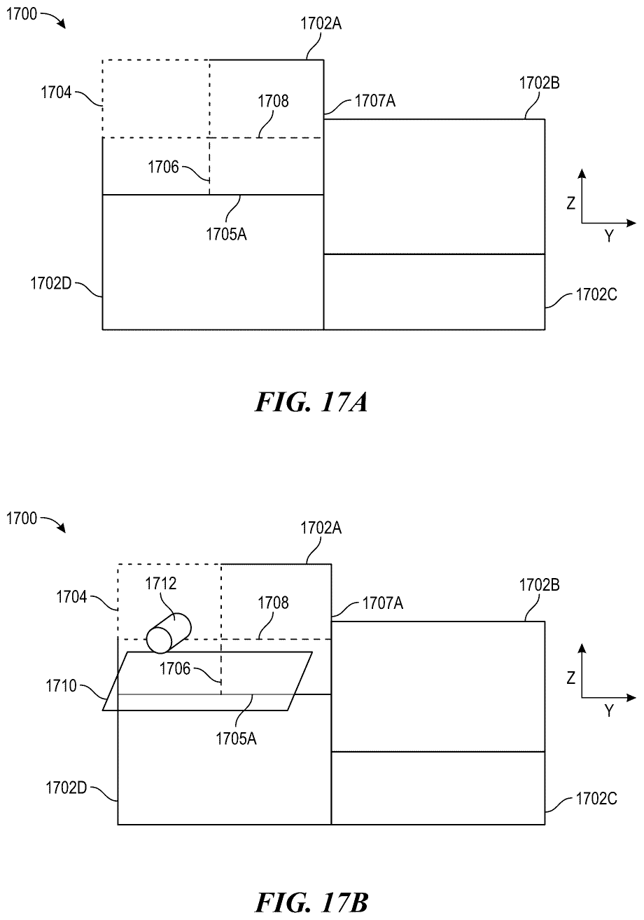

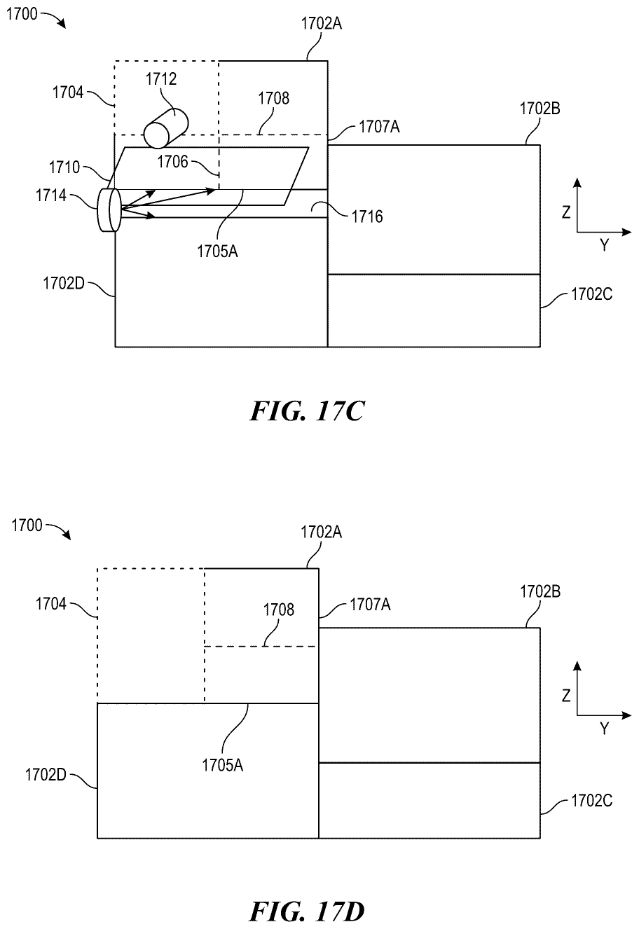

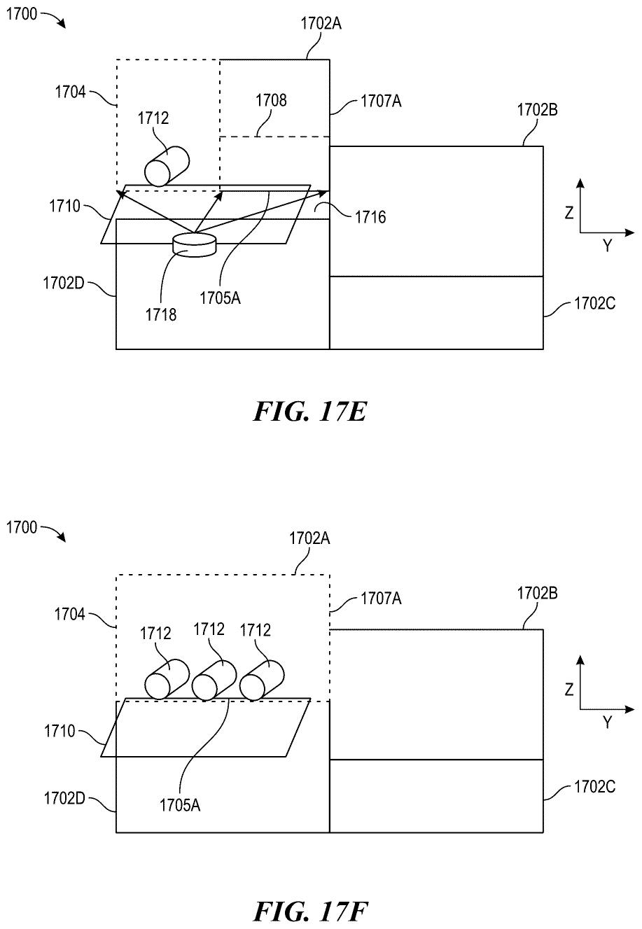

In the example depicted in FIG. 8, the cargo carrier 832 is a truck trailer and includes a plurality of objects 834. As shown in FIG. 8, the plurality of objects may be arranged in a vertical plane (e.g., generally parallel to a coronal and/or frontal plane of the cargo carrier, such as the y-z plane illustrated in FIGS. 17A-17F). In some cases, the objects may not be arranged in a perfect vertical plane, but rather a vertical stack approximating a vertical plane. The robotic system 800 includes ones or more upper vision sensors 824 and one or more lower vision sensors 825 configured to obtain an image of the cargo carrier 832 and the plurality of objects 834. Specifically, the vision sensors are configured to capture an image of the vertical plane of objects 834. The image information may be employed by a local controller to control operation of the robotic system, examples of which are discussed further with reference to FIGS. 12A-12E and 15-18. As shown in the example of FIG. 8, the upper vision sensor 824 may have a first field of view 826a and the lower vision sensor 825 may have a second field of view 826b. In some cases, it may be desirable to employ multiple vision sensors to ensure complete coverage of a cargo carrier 832 and all of the objects 834 disposed therein. In other embodiments, a single vision sensor or any number of vision sensors may be employed. The upper and lower vision sensors may be cameras, in some embodiments. As shown in FIG. 8, the upper vision sensor 824 and the lower vision sensor 825 are supported by an arm 830 coupled to the chassis 802. The placement of the vision sensors on the arm 830 may reduce obstructions caused by portions of the robotic system itself. Additionally, the placement of the vision sensors on the arm 830 may allow the vision sensors to enter the cargo carrier 832. The vision sensors are configured to image the objects 834 at an imaging distance 828 that is less than the combined length of the segment 804 and the gripper 806.

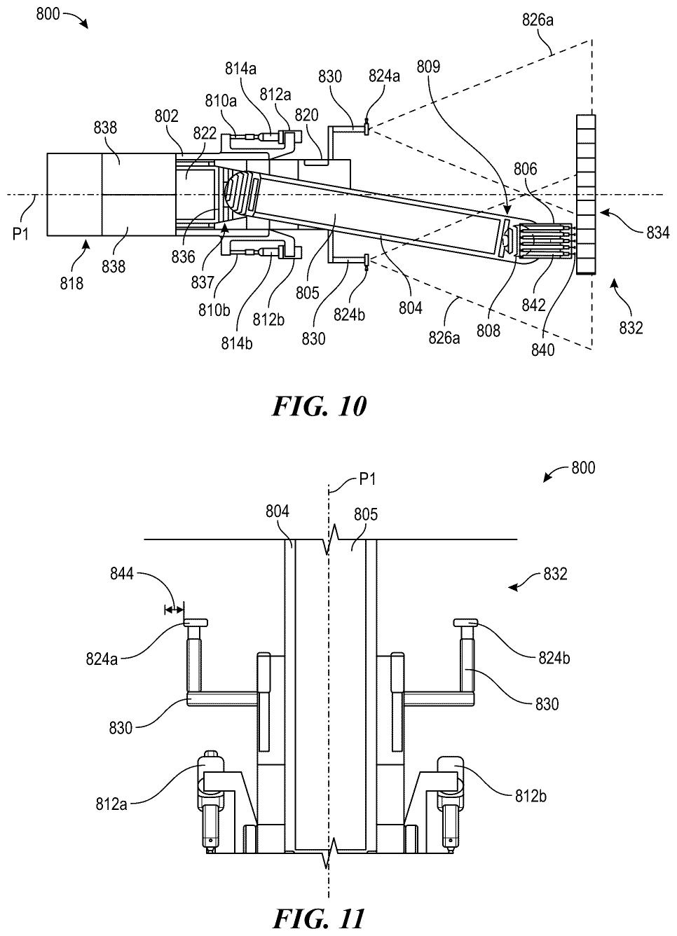

FIG. 9 is a top schematic of the robotic system 800 of FIG. 8 in a first state. In the state shown in FIG. 9, the robotic system 800 has reached into the cargo carrier 832. Specifically, a distal end of the robotic system 800 is disposed within the cargo carrier 832, while a proximal end of the robotic system remains outside of the cargo carrier. Accordingly, the gripper 806 of the robotic system 800 is able to access objects 834 disposed within the cargo carrier 832. As shown in FIG. 9, the segments 820 of the warehouse conveyor 818 extend to accommodate the movement of the robotic system 800 into the cargo carrier 832. Also shown in FIG. 9 are local controllers 838 of the robotic system 800 that are disposed on the chassis 802. The controllers 838 may control the various components of the robotic system, as discussed further herein with reference to exemplary methods.

FIG. 9 illustrates that the robotic system 800 can be generally symmetrical about its longitudinal axis. For example, the robotic system 800 can include a first leg 810a and a first wheel 812a. On an opposing side, the robotic system 800 includes a second leg 810a and a second wheel 812a. The first leg 810a is moveable in a vertical direction by a first leg actuator 814a and the second leg 810b is movable by a second leg actuator 814b. In the example of FIG. 9, the robotic system 800 includes a first upper vision sensor 824a and a second upper vision sensor 824b disposed on opposite sides of a longitudinal axis of the robotic system. The upper vision sensors are each supported on symmetrical arms 830 are mirrored across the longitudinal axis. The first upper vision sensor 824a has a first field of view 826a and the second upper vision sensor 824b has a second field of view 826c. The fields of view ensure complete coverage of a plurality of objects 834 disposed in the cargo carrier 832. Additionally, the placement of the vision sensors on two sides of the segment 804 (as well as above and below the segment 804 as shown in FIG. 8) ensures that a complete image of the objects 834 may be captured without obstruction by the segment 804 and the gripper 806. In some embodiments, positioning the vision sensors below the segment 804 (or below a zero pitch position of a segment) may have certain benefits in cases where an unloading process begins at a top of a vertical stack. In such cases, a segment may be placed at a high pitch angle to begin, allowing vision sensors placed below the segment to obtain an unobstructed view of a plurality of objects.

As shown in FIG. 9, the segment 804 is coupled to the chassis 802 and the proximal conveyor 822 by a joint 836. The joint 836 is configured to provide multiple rotational degrees of freedom of the segment 804 with respect to the chassis 802 and the proximal conveyor 822. In some embodiments, the proximal conveyor 822 may be fixed with respect to the chassis 802. The joint 836 provides two rotational degrees of freedom for the segment 804. In the embodiment of FIG. 9, the joint 836 provides a yaw degree of freedom (e.g., rotation about a vertical axis and generally parallel to a longitudinal plane P₁ of the chassis 802 illustrated in FIG. 9) and a pitch degree of freedom (e.g., rotation about a transverse horizontal axis that is vertical on the page and generally parallel to the transverse plane P₂ of the chassis 802). In some embodiments as shown in FIG. 9, the join 836 includes a plurality of rollers 837 configured to move an object 834 in a proximal direction from the segment 804 to the proximal conveyor 822.

The gripper 806 coupled to the segment 804 by a joint 808. The joint 808 is configured to provide multiple rotational degrees of freedom of the gripper 806 with respect to the segment 804. The joint 808 provides two rotational degrees of freedom for the gripper 806. In the embodiment of FIG. 9, the joint 808 provides a yaw degree of freedom (e.g., rotation about the vertical axis, such as the first axis A₁ of FIG. 3) and a pitch degree of freedom (e.g., rotation about the transverse horizontal axis, such as the second axis A₂ of FIG. 3). In some embodiments as shown in FIG. 9, the joint 808 includes a plurality of rollers 809 configured to move an object 834 in a proximal direction from the gripper 806 to the segment 804.

According to the example of FIG. 9, the robotic system 800 is configured to grasp an object 834 of the plurality of objects with the gripper 806 and move the object in a proximal direction along a series of conveyors. As shown FIG. 9, the gripper 806 includes a plurality of suction cups 840 (and/or any other suitable gripper element) and a plurality of distal conveyors 842. The suction cups 840 are configured to be place in contact with an object 834 and grasp the object when a vacuum force (or other suitable drive force) is applied to the suction cup 840. The distal conveyors 842 are belt conveyors in the example of FIG. 9 and are configured to move the object in a proximal direction once the object is grasped by the suction cups 840. Examples of grasping object is discussed further herein with reference to grippers and end of arm tool (EOAT) arrangements. The object 834 is moved in a proximal direction to the joint 808 and comes into contact with the rollers 809. The rollers 809 may be driven and may further move the object 834 on a segment conveyor 805 disposed on the segment 804. The segment conveyor 805 may be a belt conveyor and may be configured to move the object to the joint 836 and the rollers 837. The rollers 837 may move the object to the proximal conveyor 822. The proximal conveyor may also be a belt conveyor. The proximal conveyor may move the object to the warehouse conveyor 818. In some embodiments, the warehouse conveyor may be a belt conveyor or roller conveyor.

FIG. 10 is a top schematic of the robotic system 800 of FIG. 9 in a second state demonstrating a yaw range of motion provided by the joint 808 and the joint 836. Compared to the state shown in FIG. 9, the segment 804 has rotated about the joint 836 in a yaw direction (e.g., clockwise about an axis into the page, such as the first axis A₁ of FIG. 3). Correspondingly, the gripper 806 has rotated about joint 808 in an opposite direction (e.g., counterclockwise about the axis into the page). The rotation of the segment 804 has changed the position of the gripper 806 with respect to the cargo carrier 832 and objects 834. However, the orientation of the gripper 806 with respect to the cargo carrier 832 and objects 834 remain the same. Such an arrangement may be beneficial in allowing the gripper 806 to reach edges of a rectangular prism shaped cargo carrier (such as a box truck, shipping container, semi-truck trailer, etc.). For example, as shown in FIG. 10, the gripper 806 may be able to align with the side walls of the cargo container even as its position changes due to the rotation of the segment 804. Additionally, the suction cups 840 of the gripper may remain square with the objects 834 to ensure the suction cups can reliably grasp the objects. In the example of FIG. 10, the distal conveyors 842 and proximal conveyor 822 may remain parallel to one another throughout the change of position of the gripper. The angle of the segment conveyor 805 may change as the gripper is moved through its range of motion. The rollers 809 of the joint 808 and the rollers 837 of the joint 836 may accommodate this change in angle and allow an object to move in a proximal direction from the distal conveyors 842 to the segment conveyor 805 and the proximal conveyor 822.

FIG. 11 is a schematic illustrating a robotic system 800 positioned inside of a cargo carrier 832 in accordance with one or more embodiments. FIG. 11 represents an enlarged view of the state shown in FIG. 8. A segment 804 is disposed within the cargo carrier 832 and includes a segment conveyor 805. On a first side of the segment 804 is a first vision sensor 824a disposed on an arm 830a. On a second opposing side of the segment 804 is a second vision sensor 824b disposed on a second arm 830b. The overall width between the first vision sensor 824a and the second vision sensor 824b may be less than an overall width of the cargo carrier 832. A tolerance gap distance 844 is provided between the walls of the cargo carrier (not shown) and the vision sensors. In some embodiments as shown in FIG. 11, wheels 812a, 812b of the robotic system 800 may enter the cargo carrier 832.

FIGS. 12A-12E illustrate a robotic system through a process of unloading a cargo carrier 1232 adjacent to a warehouse or other structure 1213 in accordance with one or more embodiments. Specifically, FIGS. 12A-12E illustrate how the various components of a robotic system interact and are controlled (e.g., by a local controller 1236) to access and unload a plurality of objects 1234 that may be stacked in vertical columns within the cargo carrier 1232.

As shown in FIG. 12A, the robotic system 1200 includes a chassis 1202, a proximal conveyor 1204 a segment 1206, and a gripper 1208. The segment is operatively coupled to the proximal conveyor 1204 at a proximal end of the segment via a first joint providing two rotational degrees of freedom. Accordingly, a distal end of the segment 1206 may have a semispherical range of motion. The gripper 1208 is operatively coupled to the segment 1206 via a second joint 1212 providing two rotational degrees of freedom. Accordingly, a distal end of the gripper 1208 may have a semispherical range of motion. The gripper 1208 includes a plurality of suction cups 1210 (or other suitable gripper element) configured to grasp the objects 1234. The chassis 1202 is supported by legs 1220 which each include a wheel 1222. The wheels 1222 contact an environment 1214 in which the robotic system is placed, which in the example of FIGS. 12A-12E may be a warehouse. The environment 1214 includes a warehouse bay opening 1215 through which the cargo carrier 1232 is accessed. The legs 1220 are movable in a vertical direction by corresponding leg actuators 1224. In the example of FIGS. 12A-12E, the robotic system includes two legs, two wheels, and two leg actuators. In the example of FIGS. 12A-12E, the robotic system 800 cooperated with a warehouse conveyor 1216, which in some cases may be pre-existing in the environment 1214. The warehouse conveyor 1216 includes a plurality of telescoping segments 1218, allowing the warehouse conveyor to extend and retract. The warehouse conveyor 1216 of FIGS. 12A-12E includes a belt 1217. The chassis 1202 may be connected to a distal end of the warehouse conveyor, such that the distal end of the warehouse conveyor and the chassis move together in a translational degree of freedom.

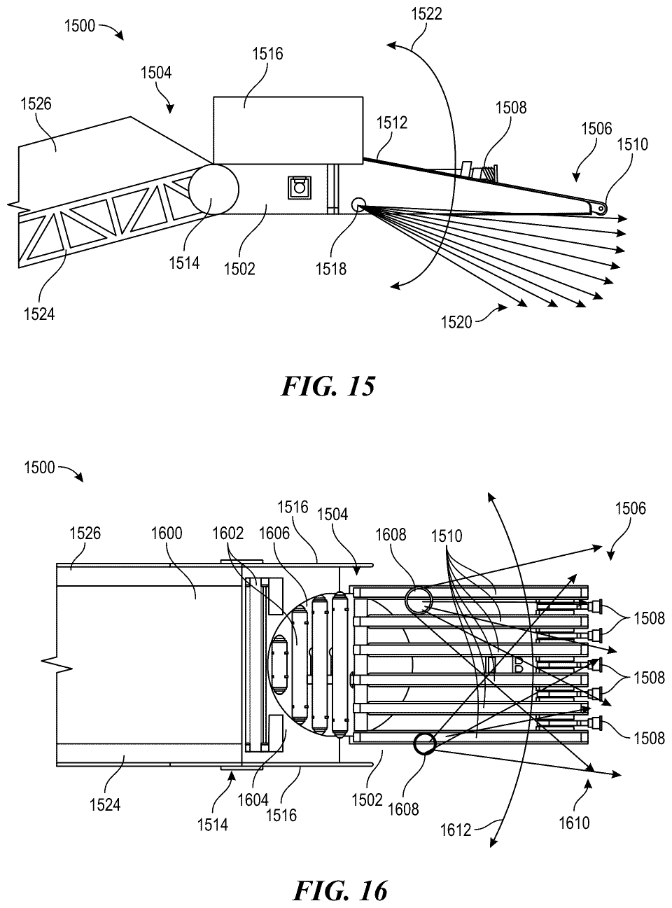

According to the embodiment of FIGS. 12A-12E, the robotic system 1200 includes a controller 1236 configured to control the various components of the robotic system with one or more actuators. The controller 1236 is also configured to receive information from one or more sensors, include upper vision sensors 1226 and lower vision sensor 1228 mounted on arms 1230. Control algorithms that may be implemented by the controller 1236 are discussed further with reference to FIGS. 15-18.

The state of FIG. 12A may represent a starting state, with the robotic system 1200 positioned entirely on one side of the warehouse bay opening 1215. The warehouse conveyor segments 1218 are fully retracted. The segment 1206 may be positioned such that the gripper 1208 is at an uppermost position. For example, with respect to pitch, the segment 1206 may be at an uppermost end of its range of motion. As shown in FIG. 12A, the gripper 1208 may rotate about the second joint 1212 to ensure the gripper remains level (e.g., aligned with a horizontal plane, such as the transverse plane of the chassis illustrated in FIG. 9). In the state of FIG. 12B, the chassis 1202 of the robotic system has moved in a distal direction (e.g., right relative to the page). Correspondingly, the telescoping segments 1218 have extended in the distal direction. The gripper 1208 and its suction cups 1210 pass through the warehouse bay opening 1215 and approach the plurality of objects 1234 in the cargo carrier 1232, which are arranged in a vertical column, approximating a vertical plane (e.g., a plane generally parallel to a coronal and/or frontal plane of the cargo carrier, such as the y-z plane illustrated in FIGS. 17A-17F). The movement of the chassis 1202 in the distal direction may be provided by driving the wheels 1222 with one or more wheel motors. In some embodiments, the unloading process of the cargo carrier 1232 may begin with unloading the objects 1234 disposed at the top of the cargo carrier.

FIG. 12C illustrates a perspective view the robotic system 1200 of FIG. 12A in the second state of the process of unloading a cargo carrier in accordance with one or more embodiments. The upper vision sensors 1226 can have a first field of view 1238 and the lower vision sensors 1228 can have a second field of view 1240. FIG. 12C illustrates how the gripper 1208 and the segment 1206 are positioned to allow the gripper 1208 to reach the top of the plurality of objects 1234. FIG. 12C, further illustrates the first joint 1250 providing rotational degrees of freedom for the segment 1206 relative to the chassis 1202 and the proximal conveyor 1204. The gripper 1208 includes distal conveyors 1242 configured to move the objects 1234 sequentially in a proximal direction toward the segment 1206. The segment 1206 includes a segment conveyor 1246 that moves the objects 1234 sequentially in a proximal direction toward the proximal conveyor 1204. The proximal conveyor 1204 is positioned above the warehouse conveyor 1216 and is configured to move the objects 1234 sequentially in the proximal direction onto the warehouse conveyor. In some embodiments as shown in FIG. 12C, the robotic system 1200 may include guides for objects to ensure the objects remain on the sequence of conveyors. The first joint 1212 includes gripper guides 1244 that serve as boundaries for objects moving in the proximal direction. The segment 1206 also includes segment guides 1248 that serve has boundaries for moving objects along the segment conveyor 1246.

FIG. 12D illustrates the robotic system 1200 of FIG. 12A in a third state of a process of unloading a cargo carrier in accordance with one or more embodiments. FIG. 12D specifically illustrates how the objects 1234 are moved along the series of conveyors of the robotic system so that the objects can be delivered to the warehouse conveyor 1216. In the robotic system of FIGS. 12A-12E, the objects 1234 are moved sequentially (e.g., one at a time) along the series of conveyors. An object 1234 is first grasped by the suction cups 1210 of the gripper 1208. The suction cups 1210 place the object 1234 onto the distal conveyors 1242, which move the object 1234 in a proximal direction to the second joint 1212. The object 1234 then continues to the segment conveyor 1246 which continues to move the object in the proximal direction to the first joint 1250. The object 1234 then continues to the proximal conveyor 1204, which continues to move the object in the proximal direction to the warehouse conveyor 1216. In some embodiments, the joints between the various components include joint conveyors (e.g., rollers) that assist in transferring the objects between the components. In some embodiments as shown in FIG. 12D, the proximal conveyor 1204 is inclined downward to the warehouse conveyor 1216. The segment conveyor 1246 may be inclined upward or downward in the proximal direction depending on the orientation of the segment about the first joint 1250.

The robotic system 1200 of FIGS. 12A-12E may repetitively grasp and move objects in a proximal direction until an entire vertical stack of objects is removed. Subsequently, the chassis 1202 may be moved in a distal direction to advance the gripper 1208 to the next stack of objects 1234. The grasping and moving process may then repeat for the next stack of objects. Subsequently, the chassis 1202 may be moved again in a distal direction to advance the gripper 1208 to the next stack of objects 1234. This pattern may repeat until all objects 1234 from the cargo carrier 1232 are unloaded. The chassis 1202 may be moved any time throughout this process.

As discussed above with reference to FIGS. 5-6, the rotation of the segment 1206 effects a position change of the gripper 1208. However, as the gripper 1208 is coupled to a distal end of the segment 1206, the gripper 1208 moves in an arc with the rotation of the segment 1206. With two degrees of freedom (e.g., pitch and yaw), the segment 1206 moves the gripper 1208 in a semispherical range of motion. Accordingly, with respect to the vertical plane of objects 1234, if the chassis 1202 remains stationary, the gripper 1208 will move toward or away the objects depending on the angle of the segment 1206 in pitch and yaw. A maximum reach of the gripper 1208 will be at a location corresponding to zero pitch and zero yaw of the segment 1206. Correspondingly, a minimum reach of the gripper 1208 will be at a location corresponding to maximum pitch or maximum yaw of the segment 1206. At the minimum reach, the suction cups 1210 may not be able to reach the objects 1234 arranged in the vertical plane. Accordingly, in some embodiments, the chassis 1202 may move in a distal or proximal direction to compensate for the change in position of the gripper 1208 with respect to the objects 1234 caused by the rotation of the segment 1206. For example, as the segment increases in pitch angle, the wheels 1222 may be driven (e.g., by wheel motors) to move the chassis 1202 in a distal direction to maintain the gripper 1208 at a desired distance from the plane of the objects 1234. Continuing this example, as the segment decreases in pitch angle (e.g., returning to zero), the wheels 1222 may be driven to move the chassis 1202 in a proximal direction to maintain the gripper 1208 at the desired distance from the plane of the objects 1234. A similar approach may be employed for change of a yaw angle of the segment 1206. In this manner, the position of the gripper 1208 may be changed with respect to the objects 1234 without moving the gripper 1208 out of range of the objects.

FIG. 12E illustrates the robotic system 1200 of FIG. 12A in a fourth state of a process of unloading a cargo carrier in accordance with one or more embodiments. The state of FIG. 12E in particular illustrates how the robotic system 1200 moves into the cargo carrier 1232 to continue to unload objects 1234 in additional vertical stacks. In some embodiments as shown in FIG. 12E, the wheels 1222 of the robotic system 1200 may move into the cargo carrier 1232 and may rest on a floor 1233 of the cargo carrier. The legs 1220 may move in a vertical direction to ensure the components of the robotic system 1200 clear the internal vertical dimension of the cargo carrier. As shown in FIG. 12E, the telescoping segments 1218 may extend past a warehouse bay opening 1215 in some embodiments and into the cargo carrier 1232. In other embodiments a warehouse conveyor may remain entirely in a warehouse, as the present disclosure is not so limited. Additionally, in some embodiments the proximal conveyor 1204 may extend and retract instead of or in addition to the warehouse conveyor 1216.

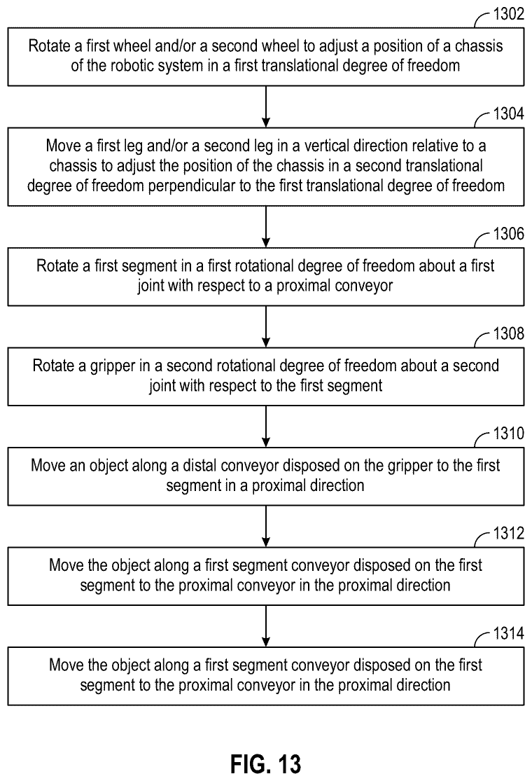

FIG. 13 is a flow diagram illustrating a process of operating a robotic system in accordance with one or more embodiments. At block 1302, the process includes rotating a first wheel and/or a second wheel to adjust a position of a chassis of the robotic system in a first translational degree of freedom (e.g., a distal/proximal degree of freedom). In some embodiments, rotating the first wheel and/or second wheel may include driving a first wheel motor coupled to the first wheel and a second wheel coupled to the second wheel. At block 1304, the process further includes moving a first leg and/or a second leg in a vertical direction relative to a chassis to adjust the position of the chassis in a second translational degree of freedom perpendicular to the first translational degree of freedom. In some embodiments, moving the first leg and/or second leg includes rotating the first leg and/or second leg relative to the chassis. In some embodiments, the first leg and second leg may be moved in the vertical direction independently of one another. Moving the first leg and/or second leg may include commanding one or more leg actuators to move the first leg and/or second leg relative to the chassis.

At block 1306, the process further includes rotating a first segment in a first rotational degree of freedom about a first joint with respect to a proximal conveyor. In some embodiments, the first rotational degree of freedom is a pitch degree of freedom. In some embodiments, the process may further include rotating the first segment in a roll degree of freedom. Rotating the first segment may include commanding one or more actuators to move the first segment about the first joint. In some embodiments, the one or more actuators may be disposed in the first joint.

At block 1308, the process further includes rotating a gripper in a second rotational degree of freedom about a second joint with respect to the first segment. In some embodiments, the second rotational degree of freedom is a pitch degree of freedom. In some embodiments, the process may further include rotating the gripper in a roll degree of freedom. Rotating the gripper may include commanding one or more actuators to move the gripper about the second joint. In some embodiments, the one or more actuators may be disposed in the second joint.

At block 1310, the process includes moving an object along a distal conveyor disposed on the gripper to the first segment in a proximal direction. At block 1312, the process further includes moving the object along a first segment conveyor disposed on the first segment to the proximal conveyor in the proximal direction. At block 1314, the process further includes moving the object along the proximal conveyor in the proximal direction. In some embodiments, the object may be moved onto a warehouse conveyor from the proximal conveyor. In some embodiments, the process may include detecting the object with one or more vision sensors. That is, image information including the object may be obtained and processed to identify the object. The acts of 1306 and 1308 may be based in part on the image information and the identified object. The object may be grasped (e.g., by one or more gripping elements in the gripper) and placed on the distal conveyor of the gripper.

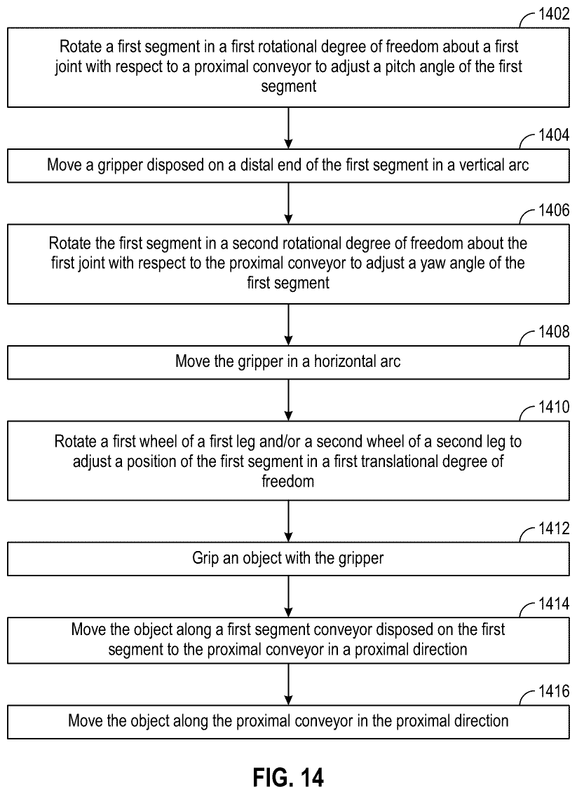

FIG. 14 is a flow diagram illustrating a process of operating a robotic system in accordance with one or more embodiments. At block 1402, the process includes rotating a first segment in a first rotational degree of freedom about a first joint with respect to a proximal conveyor to adjust a pitch angle of the first segment. In some embodiments, rotating the first segment may include operating one or more actuators to move the first segment. In some embodiments, the one or more actuators may be disposed in the first joint.

At block 1404, the process includes moving a gripper disposed on the distal end of the first segment in a vertical arc. The movement in the vertical arc may be based on the rotation of the first segment, as the gripper may be attached to a distal end of the first segment, and the first segment may rotate about its proximal end at the first joint. Accordingly, a change in pitch of the first segment moves the gripper in a vertical arc.

At block 1406, the process includes rotating a first segment in a second rotational degree of freedom about the first joint with respect to the proximal conveyor to adjust a yaw angle of the first segment. In some embodiments, rotating the first segment may include operating the one or more actuators to move the first segment.

At block 1408, the process includes moving a gripper disposed on the distal end of the first segment in a horizontal arc. The movement in the horizontal arc may be based on the rotation of the first segment, as the gripper may be attached to a distal end of the first segment, and the first segment may rotate about its proximal end at the first joint. Accordingly, a change in pitch of the first segment moves the gripper in a horizontal arc. In some embodiments, the movement in the horizontal arc and the vertical arc moves the gripper within a semispherical range of motion.

At block 1410, the process includes rotating a first wheel of a first leg and/or a second wheel of a second leg to adjust a position of the first segment in a first translational degree of freedom. The translational degree of freedom may be in a distal/proximal direction, aligned with a longitudinal axis of the robotic system. The rotation of the first wheel and/or second wheel may move the gripper in the translational degree of freedom as well. In this manner, a distance between the gripper and a vertical plane may be maintained despite the movement of the gripper in an arc. In some embodiments, the first translational degree of freedom is perpendicular to the vertical plane. The vertical plane may be representative of a stack of objects within a cargo carrier (e.g., a plane generally parallel to a coronal and/or frontal plane of the cargo carrier, such as the y-z plane illustrated in FIGS. 17A-17F).

At block 1412, the process includes gripping an object with the gripper. In some embodiments, gripping the object with a gripper includes applying a vacuum force to one or more suction cups in contact with the object (and/or another suitable drive force to another suitable gripping element).

At block 1414, the process includes moving the object along a first segment conveyor disposed on the first segment to the proximal conveyor in a proximal direction. In some embodiments, the gripper may place the object on the first segment conveyor. In some embodiments, the one or more suction cups may place the object onto one or more distal conveyors of the gripper, which move the object in a proximal direction to the first segment conveyor.

At block 1416, the process includes moving the object along the proximal conveyor in the proximal direction. In some embodiments, the process may include moving the object to a warehouse conveyor. In some embodiments, the first segment conveyor may include a belt, and the proximal conveyor may include a belt.

In some embodiments, the process further includes moving the gripper both linearly and arcuately to position the gripper to a target gripping position for gripping the object (e.g., a position immediately in front of or otherwise adjacent to the object). In some embodiments, the process further includes selecting the object and translating the first segment relative to the object while the gripper moves along the first arc and/or the second arc to move the gripper toward a target gripping position for gripping the object. In some embodiments, the process further includes determining a pick-up path (e.g., including linear and/or arcuate path portions) for moving the gripper toward a target gripping position for gripping the object, and reconfiguring the robotic system to move the gripper along the pick-up path while the gripper moves along the first arc and/or the second arc. In some embodiments, the pick-up path is determined based, at least in part, on one or more joint parameters of the first joint and/or the second joint. In some embodiments, the one or more joint parameters includes at least one of a range of motion, a joint speed, joint strength (e.g., high torque), or a joint accuracy.

In some embodiments, the process further includes controlling the robotic system to move the gripper along a pick-up path toward a target gripping position for the gripper to grip the object, and wherein the pick-up path is a linear path or a non-linear path. In some embodiments, the process further includes moving the robotic system along a support surface while the first joint and/or second joint move the gripper. In some embodiments, the process further includes controlling the robotic system to move the gripper toward the object to compensate for movement along at least one of the first arc or the second arc to position the gripper at a gripping position for gripping the object.

### Example EOAT for the End-Point Interface System

FIG. 15 is a side schematic of a gripper assembly 1500 for a robotic system in accordance with one or more embodiments. According to the embodiment of FIG. 15, the gripper assembly includes a gripper frame 1502. The gripper frame has a proximal end 1504 and a distal end 1506. The gripper includes a plurality of suction cups 1508 (and/or any other suitable gripping element). As discussed further herein, the suction cups 1508 may move relative to the gripper frame 1502 to lift and drag objects onto distal conveyors 1510. In some embodiments as shown in FIG. 15, the distal conveyors 1510 may extend to the distal end 1506 of the gripper assembly. The distal conveyors may each include a belt configured to move objects toward the proximal end, in some embodiments. In some embodiments as shown in FIG. 15, the gripper frame 1502 includes an inclined portion 1512. The inclined portion may assist the gripper frame 1502 in fitting into a cargo carrier and reaching objects disposed near the internal walls of the cargo carrier. Additionally, such an arrangement may assist in moving objects onto the conveyors and avoiding object stiction. The distal conveyors 1510 may be inclined along with the inclined portion 1512. The gripper assembly also includes gripper guides 1516 configured to guide the object across a joint 1514. The joint 1514 couples the gripper frame 1502 to a segment 1524. The segment 1524 includes segment guides 1526 which keep objects on the segment.

As shown in FIG. 15, the gripper assembly 1500 includes a distance sensor 1518. The distance sensor 1518 may be a distance sensor configured to collect a plurality of distance measurements 1520 in a vertical direction 1522. As discussed further below, such distance measurements may supplement image information and may be used to identify and remove objects from a vertical stack of objects. In some embodiments as shown in FIG. 15, the distance sensor 1518 may obtain its distance measurements 1520 below the gripper frame 1502 in a distal direction.

FIG. 16 is a top schematic of the gripper assembly 1500 of FIG. 15. The view of FIG. 16 better illustrates the conveyor arrangement and the joint 1514. As shown in FIG. 16, the gripper assembly 1500 includes a plurality of suction cups 1508 (and/or another suitable gripping element) and distal conveyors 1510. In the depicted example, the distal conveyors 1510 and suction cups 1508 alternate with one another. For example, each suction cup is positioned between two conveyors, and the conveyors are positioned between two suction cups. Each distal conveyor 1510 includes a belt in the example of FIG. 16 that is configured to support an object and move the object in a proximal direction toward the segment 1524. The segment 1524 includes a segment conveyor 1600 configured to receive the object and continue moving the object in the proximal direction.

The joint 1514 shown In FIG. 16 provides rotational degrees of freedom to the gripper frame 1502 as discussed with reference to other embodiments herein. In the depicted example, the joint 1514 includes a first joint portion 1604 (e.g., a socket portion) and a second joint portion 1606 (e.g., a ball portion) configured to rotate within the first joint portion 1604. The joint 1514 also includes a plurality of rollers 1602 that may be driven to move an object across the first joint from the distal conveyors 1510 to the segment conveyor 1600. In some embodiment, at least some of the rollers may be driven to rotate. In some embodiments, at least some of the rollers may be passive and free spinning. As shown in FIG. 16, the rollers on the first joint portion 1604 and the rollers on the second joint portion 1606 overlap with one another, such that even as the joint moves an object may move from the first joint portion to the second joint portion on the roller.

As shown in FIG. 16, the gripper assembly 1500 further includes distance sensors 1608. The distance sensors 1608 may be distance sensors configured to collect a plurality of distance measurements 1610 in a horizontal direction 1612. As discussed further below, such distance measurements may supplement image information and may be used to identify and remove objects from a vertical stack of objects. In some embodiments as shown in FIG. 15, the distance sensors 1608 may obtain their distance measurements 1610 in a distal direction. In some embodiments, the distance measurements 1610 may be taken below the gripper frame 1502. In some embodiments, the distance sensors 1608 may include the distance sensor 1518. For example, a single distance sensor may be configured to obtain distance measurements in a vertical direction and a horizontal direction. In some embodiments, while two distance sensors 1608 are shown in FIG. 16, in other embodiments a single distance sensor may be employed or any number of distance sensors, as the present disclosure is not so limited.

FIGS. 17A-17F are schematics illustrating a process of operating a robotic system in accordance with one or more embodiments. The schematic shown in FIGS. 17A-17F is representative of an image 1700 and how that image is used to control a gripper to remove objects from a vertical stack in a reliable and efficient manner. In the example of FIG. 17A, the image includes a first object 1702A, a second object 1702B, a third object 1702C, and a fourth object 1702D. The objects of FIGS. 17A-17F may be representative of boxes, for example, of mixed sizes (e.g., mixed stock keeping units) disposed in a cargo carrier. The image 1700 may be taken in a horizontal direction perpendicular to a vertical plane in which the objects 1702A-1702D are arranged (e.g., a plane generally parallel to a coronal and/or frontal plane of the cargo carrier, such as the y-z plane). According to the example of FIGS. 17A-17F, each object includes four boundaries: two side boundaries (e.g., side boundary 1707A), a top boundary, and a bottom boundary (e.g., bottom boundary 1705A).

FIG. 17A is a schematic illustrating a first state of the process. The image in FIG. 17A may be obtained from one or more vision sensors (e.g., cameras). The vision sensors may be mounted on a portion of a robotic system. Based on the image 1700, a minimum viable region 1704 is identified and applied to the image 1700. The minimum viable region 1704 corresponds to one of the objects 1702A-1702D. In some embodiments as shown in FIG. 17A, an initial minimum viable region identified may correspond to the uppermost and leftmost object. In other embodiments, an initial minimum viable region identified may correspond to the uppermost and rightmost object. In some embodiments, an initial minimum viable region identified may correspond to any uppermost object. The minimum viable region 1704 may be a region of image corresponding to a high confidence of being a single object. In some cases, a minimum viable region 1704 may be assigned based on known smallest dimensions of the various objects 1702A-1702D within the cargo carrier. For example, the minimum viable region may be identified based on the known smallest SKU. In some embodiments, the initially identified minimum viable region 1704 may be smaller than the dimensions of the object to which it corresponds. In this manner, the minimum viable region represents a safe location for the object to be grasped, and is spaced from the boundaries of the object bordering other objects, for example, bottom boundary 1705A and side boundary 1707A. As a result, the minimum viable region 1704 has a vertical delta 1706 to the bottom boundary 1705A and a horizontal delta 1708 to the side boundary 1707A. In other embodiments, the minimum viable region 1704 may be assigned by one or more computer vision algorithms with a margin of error.

FIG. 17B is a schematic illustrating a second state of the process. After the minimum viable region 1704 is identified in the image 1700, a gripper 1710 is used to grasp the first object 1702A corresponding to the minimum viable region 1704. Specifically, a suction cup 1712 (and/or another suitable gripping elements) grasps the first object within the minimum viable region 1704. In the case that the gripper 1710 includes multiple suction cups 1712, in some embodiments only the suction cups disposed within the minimum viable region 1704 may grasp the first object 1702A. In some embodiments, the gripper 1710 may be positioned adjacent the first object 1702A by rotating a segment and moving a chassis in a translational degree of freedom, as discussed with reference to other embodiments herein. In some embodiments, the gripper includes a vacuum generator connected to the suction cup configured to generate and supply a vacuum force to the suction cup. In such embodiments, grasping the first object 1702A may include placing the suction cup 1712 in contact with the first object and generating the vacuum force for the suction cup with the vacuum generator.

FIG. 17C is a schematic illustrating a third state of the process. As shown in FIG. 17C, the gripper 1710 lifts the first object 1702A after the first object 1702A is grasped within the minimum viable region 1704. Lifting the first object 1702A creates a gap 1716 between the bottom boundary 1705A of the first object 1702A and an underlying object (e.g., fourth object 1702D). As shown in FIG. 17C, the gripper 1710 may include a distance sensor 1714 configured to obtain a plurality of distance measurements in a vertical direction. In the example of FIG. 17C, the distance sensor 1714 is configured to obtain a series of distance measurements in a vertical direction (e.g., the z-direction) across the gap 1716 and the bottom boundary 1705A of the first object 1702A. In some embodiments, the distance sensor may be a laser rangefinder, for example, measuring distances by time of flight or phase shift of a laser. The plurality of distance measurements may be used to detect the position of the bottom boundary 1705A of the first object 1702A. For example, there may be a stepwise change in the distance measurements between measurements of the gap 1716 and the bottom boundary 1705A. In some cases, such a stepwise change may be indicative of the presence of the bottom boundary 1705A. In some such embodiments, the change in distance measurements may be compared to a predetermined non-zero threshold, where exceeding the threshold is indicative of the bottom boundary 1705A. In other embodiments other criteria may be employed, such as a profile of distance measurements matching a predetermined profile, as the present disclosure is not so limited.

FIG. 17D is a schematic illustrating a fourth state of the process. In some cases as shown in FIG. 17D, the first object 1702A may be released by the gripper, such that the gap 1716 of FIG. 17C is eliminated. Based on the distance measurements taken in the vertical direction, the position of the bottom boundary 1705A may be identified and the minimum viable region 1704 updated to remove the vertical delta 1706 shown in FIGS. 17A-17C. Accordingly, as of the state in FIG. 17D, the minimum viable region shares a vertical dimension with the first object 1702A. In some cases, the step of releasing the first object shown in FIG. 17D may be optional.

FIG. 17E is a schematic illustrating a fifth state of the process. As shown in FIG. 17E, the first object 1702A is grasped in the updated minimum viable region 1704 with a suction cup 1712. The gripper 1710 further lifts the first object 1702A to generate the gap 1716 again. In some embodiments, the suction cup 1712 may lift the first object 1702A relative to a gripper conveyor, for example, in a vertical direction. As shown in FIG. 17E, the gripper 1710 may include a second distance sensor 1718 configured to obtain a plurality of distance measurements in a horizontal direction. In the example of FIG. 17E, the second distance sensor 1718 is configured to obtain a series of distance measurements in a horizontal direction (e.g., the y-direction) across the gap 1716 and the side boundary 1707A of the first object 1702A. In some embodiments, the second distance sensor may be a laser rangefinder, for example, measuring distances by time of flight or phase shift of a laser. The plurality of distance measurements may be used to detect the position of the side boundary 1707A of the first object 1702A. For example, there may be a stepwise change in the distance measurements between measurements of the gap 1716 and measurements of the second object 1702B that is adjacent with the first object 1702A. In some cases, such a stepwise change may be indicative of the presence of the side boundary 1707A, inferred from the boundary being shared with the second object 1702B. In some such embodiments, the change in distance measurements may be compared to a predetermined non-zero threshold, where exceeding the threshold is indicative of the side boundary 1707A. In other embodiments other criteria may be employed, such as a profile of distance measurements matching a predetermined profile, as the present disclosure is not so limited. In some embodiments, the distance sensor 1714 and the second distance sensor 1718 may be a single distance sensor. In some embodiments, multiple distance sensors may be employed to obtain distance measurements in a vertical direction and a horizontal direction. In some embodiments, a distance sensor may include a LiDAR sensor. In some embodiments, the measurements shown in FIG. 17E and the measurements shown in 17C may be taken at the same time.

FIG. 17F is a schematic illustrating a sixth state of the process. In some cases, as shown in FIG. 17F, the first object 1702A may be again released by the gripper, such that the gap 1716 of FIG. 17E is eliminated. Based on the distance measurements taken in the horizontal direction, the position of the side boundary 1707A may be identified and the minimum viable region 1704 updated to remove the horizontal delta 1708 shown in FIGS. 17A-17E. Accordingly, as of the state in FIG. 17F, the minimum viable region shares a horizontal dimension with the first object 1702A. In some cases, the step of releasing the first object shown in FIG. 17F may be optional. Once the minimum viable region 1704 is updated in the vertical and horizontal directions, the gripper 1710 may regrasp the first object 1702A across the entire minimum viable region, for example, with multiple suction cups 1712. In some embodiments, multiple suction cups 1712 may be arranged in a line (e.g., a horizontal line). For example, a first suction cup, a second suction cup, and a third suction cup are arranged in a line (e.g., in the y-direction), as shown in FIG. 17F. In some embodiments, once the minimum viable region 1704 has been fully updated, the gripper 1710 may grasp the first object proximate the bottom boundary 1705A.

The process of FIGS. 17A-17F may be repeated for each object in a vertical stack in the image 1700. Once the first object is removed after updating the minimum viable region 1704, the minimum viable region may be subtracted from the image 1700. Accordingly, the next minimum viable region may be assigned based on the remaining image including the other objects. In this manner, no new image 1700 may be obtained for continued operation of the robotic system to remove an entire vertical stack of objects. In some embodiments, the process described with reference to FIGS. 17A-17F may be repeated for each object within a vertical stack. In some embodiments, a robotic system may prioritize removal of object at an uppermost level within a cargo container, in a left to right direction.

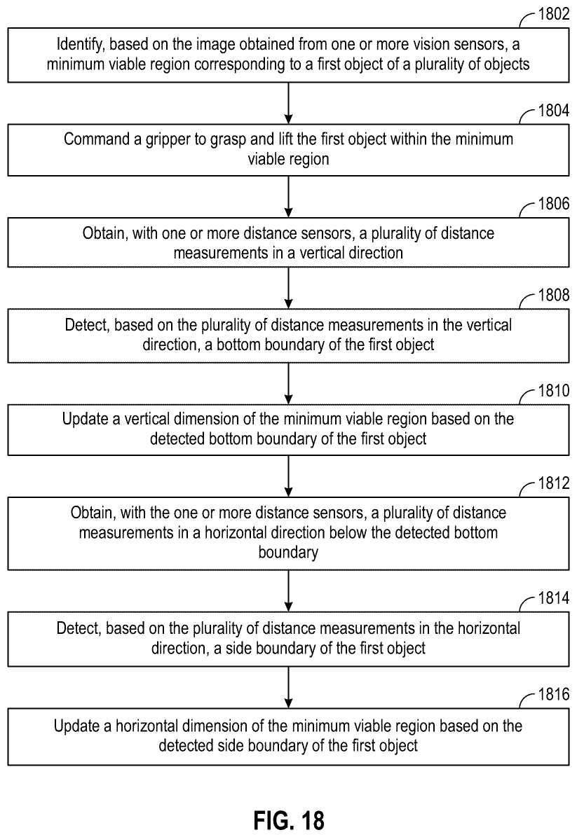

FIG. 18 is a flow diagram illustrating a process of operating a robotic system in accordance with one or more embodiments. The flow diagram of FIG. 18 may correspond to the process shown in FIGS. 17A-17F, in some embodiments. At block 1802, the process includes identifying, based on an image obtained from one or more vision sensors, a minimum viable region corresponding to a first object of a plurality of objects. At block 1804, the process further includes commanding a gripper to grasp and lift the first object within the minimum viable region. At block 1806, the process includes obtaining, with one or more distance sensors, a plurality of distance measurements in a vertical direction. At block 1808, the process includes detecting, based on the plurality of distance measurements in the vertical direction, a bottom boundary of the first object. At block 1810, the process includes updating a vertical dimension of the minimum viable region based on the detected bottom boundary of the first object. At block 1812, the process includes obtaining, with the one or more distance sensors, a plurality of distance measurements in a horizontal direction below the detected bottom boundary. At block 1814, the process includes detecting, based on the plurality of distance measurements in the horizontal direction, a side boundary of the first object. At block 1816, the process includes updating a horizontal dimension of the minimum viable region based on the detected side boundary of the first object.

### Example Chassis for Robotic System

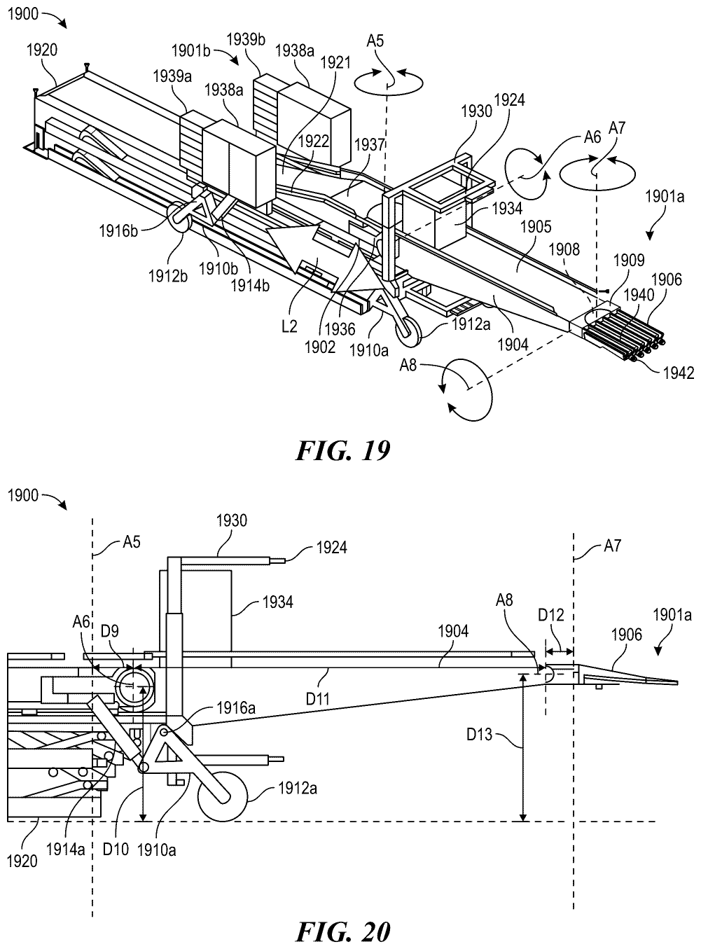

FIG. 19 is a perspective view of a robotic system 1900 in accordance with embodiments of the present technology. The robotic system 1900 can be an example of the robotic system 100 illustrated in and described above with respect to FIG. 1. The robotic system 1900 is positioned on top of a conveyor segment 1920 that may already be present at a warehouse or other operating site. In the illustrated embodiment, the robotic system 1900 includes a chassis 1902, a first segment 1904 coupled to the chassis 1902 and extending toward a distal portion 1901a of the robotic system 1900, a second segment 1921 coupled to the chassis 1902 and extending toward a proximal portion 1901b of the robotic system 1900, and a gripper 1906 coupled to the first segment 1904 at the distal portion 1901a. The robotic system 1900 can also include supporting legs 1910 coupled to the chassis 1902, one or more controllers (individually labeled 1938a, 1938b, collectively referred to as “controllers 1938”) and one or more counterweights (individually labeled 1939a, 1939b, collectively referred to as “counterweights 1939”) supported by the chassis 1902, first joint rollers 1909 coupled between the first segment 1904 and the gripper 1906, and second joint rollers 1937 coupled between the first segment 1904 and the second segment 1921. The chassis 1902, the first segment 1904, the second segment 1921, the supporting legs 1910, and/or other components of the robotic system 1900 can be made from metal (e.g., aluminum, stainless steel), plastic, and/or other suitable materials.

The chassis 1902 can include a frame structure that supports the first segment 1904, the second segment 1921, the controllers 1938, the counterweights 1939, and/or a sensor mount 1930 coupled to the chassis 1902. In the illustrated embodiment, the sensor mount 1930 extends vertically on either side of the first segment 1904 and horizontally over the first segment 1904. One or more sensors 1924 (e.g., vision sensors) are coupled to the sensor mount 1930 and are positioned to generally face toward the distal portion 1901a. In some embodiments, the sensor mount 1930 does not extend horizontally over the first segment 1904 such that cargo 1934 may travel along the first segment 1904 without a height restriction imposed by the sensor mount 1930.

The first segment 1904 is coupled to extend from the chassis 1902 toward the distal portion 1901a in a cantilevered manner. The first segment 1904 supports a first conveyor 1905 (e.g., a conveyor belt) extending along and/or around the first segment 1904. The second segment 1921 is coupled to extend from the chassis 1902 toward a proximal portion 1901b of the robotic system 1900. The second segment 1921 supports a second conveyor 1922 (e.g., a conveyor belt) extending along and/or around the second segment 1921. In some embodiments, one or more actuators 1936 (e.g., motors) configured to move the first and second conveyors 1905, 1922 are coupled to the chassis 1902. In some embodiments, the actuators are positioned elsewhere (e.g., housed in or coupled to the first and/or second segments 1904, 1921). The actuators 1936 (or other actuators) can be operated to rotate the first segment 1904 about a fifth axis A₅ and/or a sixth axis A₆. In some embodiments, the actuators 1936 can also pivot the second joint rollers 1937 about the first and second axes A₅, A₆ or different axes. In some embodiment, as illustrated in FIG. 19, the fifth axis A₅ can be generally orthogonal to a transverse plane of the chassis 1902 (e.g., a second plane P₂ illustrated in FIG. 8) while the sixth axis A₆ can be generally parallel to the transverse plane of the chassis 1902. As a result, movement and/or rotation of the first segment 1904 relative to the chassis 1902 can be generally similar to the movement and/or rotation of the first segment 304 as discussed in further detail above with respect to FIGS. 5-7B.

As mentioned above, the gripper 1906 can be coupled to extend from the first segment 1904 toward the distal portion 1901a with the first joint rollers 1909 positioned therebetween. In some embodiments, the gripper 1906 includes suction cups 1940, any other suitable gripping element, and/or a distal conveyor 1942. In some embodiments, one or more actuators 1908 (e.g., motors) are configurated to rotate the gripper 1906 and/or the first joint rollers 1909 relative to the first segment 1904 about a seventh axis A₇ and/or an eighth axis A₈. As illustrated in FIG. 19, the seventh axis A₇ can be generally parallel to a longitudinal plane of the gripper 1906 (e.g., the third plane P₃ illustrated in FIG. 43A) while the eighth axis A₈ can be generally orthogonal to the longitudinal plane of the gripper 1906. Additionally, or alternatively, the seventh axis A₇ can be generally orthogonal to a transverse plane of the gripper 1906 (e.g., the fourth plane P₄ illustrated in FIG. 42A) while the eighth axis A₈ can be generally parallel orthogonal to the transverse plane of the gripper 1906. In some embodiments, as discussed in more detail below, the robotic system 1900 can maintain the transverse plane of the gripper 1906 generally parallel with the transverse plane of the chassis 1902 (e.g., such that rotation about the sixth axis A₆ is met with an opposite rotation about the eighth axis A₈. As a result, for example, in some embodiments, the seventh axis A₇ can be generally orthogonal to the transverse plane of the chassis 1902 and/or the eighth axis A₈ can be generally parallel to the transverse plane of the chassis 1902.

In some embodiments, the actuators 1908 (or other actuators) are configured to operate the suction cups 1940 and/or the distal conveyor 1942. In some embodiments, the actuators 1908 are coupled to the first segment 1904, the first joint rollers 1909, and/or the gripper 1906. Movement and/or rotation of the gripper 1906 relative to the first segment 1904 and components of the gripper 1906 are described in further detail herein.

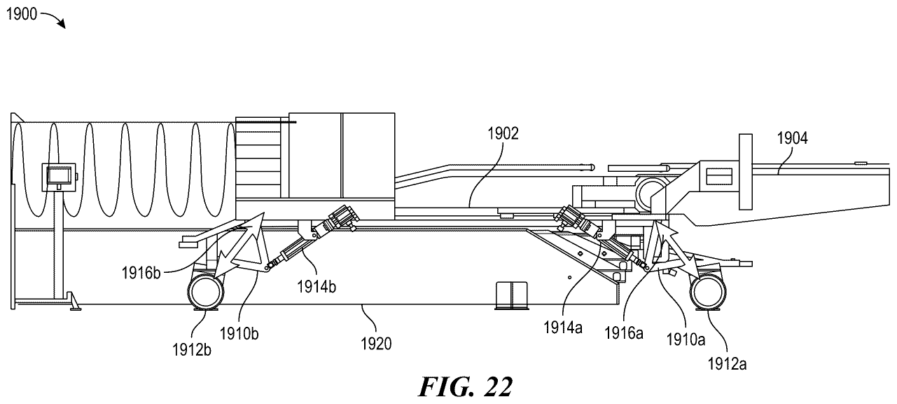

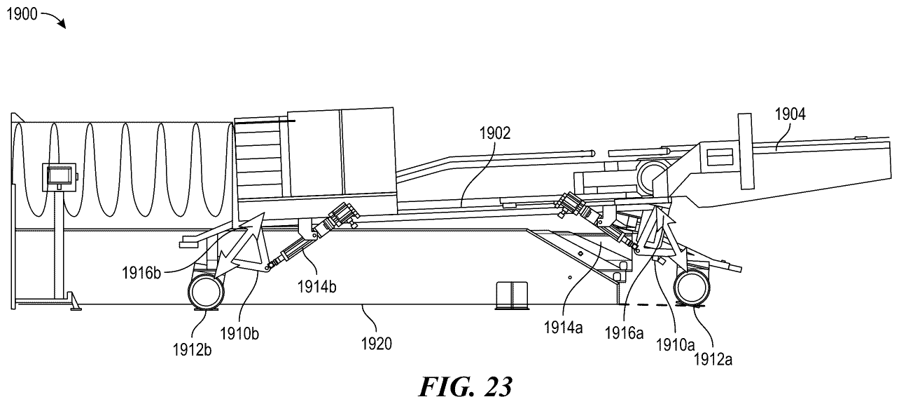

In the illustrated embodiment, two front supporting legs 1910a are rotatably coupled to the chassis 1902 about respective front pivots 1916a (see FIG. 20) positioned on either side of the chassis 1902. A front wheel 1912a is mounted to a distal portion of each front supporting leg 1910a. Similarly, two rear supporting legs 1910b are rotatably coupled to the chassis 1902 about respective rear pivots 1916b positioned on either side of the chassis 1902. A rear wheel 1912b is mounted to a distal portion of each rear supporting leg 1910b. The chassis 1902 also supports two front actuators 1914a (e.g., linear actuators, motors) (see FIG. 20) operably coupled to the front supporting legs 1910a and two rear actuators 1914b operably coupled to the rear supporting legs 1910b. In some embodiments, the robotic system 1900 includes fewer or more supporting legs 1910, and/or supporting legs 1910 configured in different positions and/or orientations. In some embodiments, the wheels 1912 can be motorized to move the chassis 1902, and thus the rest of the robotic system 1900, along linear direction L2. Operation of the actuators 1914 is described in further detail below with respect to FIGS. 22 and 23.

The controllers 1938 (e.g., the processor(s) 202 of FIG. 2 therein) can be operably coupled (e.g., via wires or wirelessly) to control the actuators 1908, 1936, 1914, and/or other actuators (e.g., corresponding to the actuation device 212 of FIG. 2). The counterweights 1939 can be positioned (e.g., towards the proximal portion 1901b) to counter any moment exerted on the chassis 1902 by, for example, cargo 1934 carried by the grippers 1906 and/or the first segment 1904.

FIG. 20 is an enlarged side view of the robotic system 1900 in accordance with embodiments of the present technology. As shown, while the first segment 1904 is rotatable about the axes A₅, A₆, the axes A₅, A₆ may not intersect and instead be separated by distance D9. The distance D9 can be around 200 mm, 300 mm, 400 mm, 500 mm, 600 mm, any distance therebetween, or other distances. When the chassis 1902 sits atop the conveyor segment 1920, as illustrated, the sixth axis A₆ can be positioned at a distance D10 from the floor on which the conveyor segment 1920 and the wheels 1912 sit. The distance D10 can be about 1100 mm, 1200 mm, 1300 mm, 1400 mm, 1500 mm, any distance therebetween, or other distances. However, as discussed in further detail herein, the wheels 1912 can be moved vertically to change the distance D10.

The sixth and eighth axes A₆, A₈ can be separated horizontally (e.g., along the first segment 1904) by distance D11. The distance D11 can be about 3000 mm, 3500 mm, 4000 mm, 4500 mm, 5000 mm, any distance therebetween, or other distances.

While the gripper 1906 is rotatable about the axes A₇, A₈, the axes A₇, A₈ may not intersect and instead be separated by distance D12. The distance D12 can be around 220 mm, 250 mm, 280 mm, 310 mm, 340 mm, any distance therebetween, or other distances. When the chassis 1902 sits atop the conveyor segment 1920 and the first segment 1904 remains in a horizontal orientation, as illustrated, the eighth axis A₈ can be positioned at a distance D13 from the floor on which the conveyor segment 1920 and the wheels 1912 sit. The distance D13 can be about 1200 mm, 1300 mm, 1400 mm, 1500 mm, 1600 mm, any distance therebetween, or other distances. However, as discussed in further detail herein, the first segment 1904 can be rotated about the sixth axis A₆ to change the distance D13.

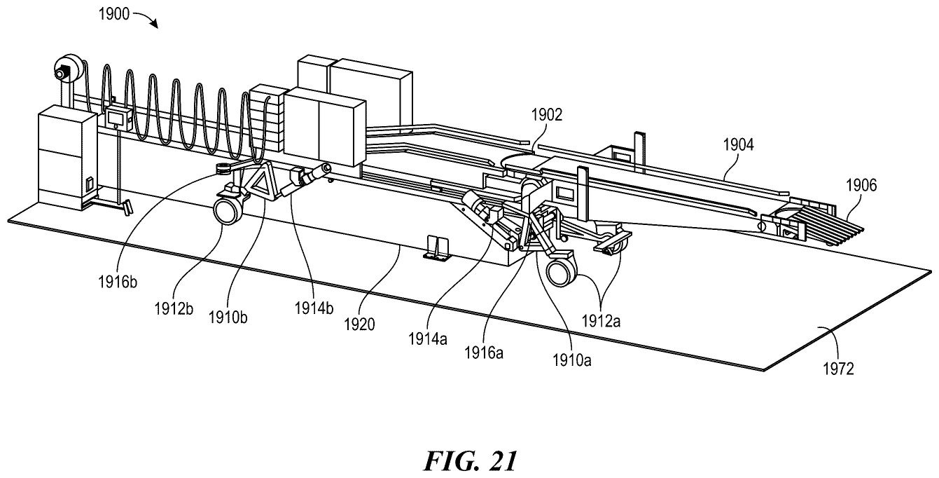

FIG. 21 is a perspective view of the robotic system 1900 on a warehouse floor 1972 in accordance with embodiments of the present technology. The discussed above, the robotic system 1900 can include two front wheels 1912a, each positioned on either side of the chassis 1902 and near the first segment 1904, and two rear wheels 1912b (one of which is obscured from view), each positioned on either side of the chassis 1902 and near the second segment 1921. Each front wheel 1912a is coupled to a front supporting leg 1910a rotatably mounted on the chassis 1902 about front pivot 1916a, and each rear wheel 1912b is coupled to a rear supporting leg 1910b rotatably mounted on the chassis 1902 about rear pivot 1916b. Front actuators 1914a and rear actuators 1914b are coupled between the chassis 1902 and the front supporting legs 1910a and rear supporting legs 1910b, respectively.

In the illustrated embodiment, each supporting leg 1910 has a triangular shape with a first vertex coupled to the pivot 1916, a second vertex coupled to the wheel 1912, and a third vertex coupled to the actuator 1914. Furthermore, the actuators 1914 (e.g., motorized linear actuators) can be coupled to the chassis 1902 between the front and rear pivots 1916 such that in operation, the front actuators 1914a can push the front supporting legs 1910a towards the front and pull the front supporting legs 1910a towards the rear, and the rear actuators 1914b can push the rear supporting legs 1910b towards the rear and pull the front supporting legs 1910a towards the front. When the actuators 1914 push the supporting legs 1910, the corresponding wheels 1912 are lifted vertically off the floor 1972. Conversely, when the actuators 1914 pull the supporting legs 1910, the corresponding wheels 1912 are lowered vertically toward the floor 1972. As discussed above with respect to FIG. 4, lowering the wheels 1912 can be advantageous when moving the robotic system 1900 to a lower floor. Furthermore, in some embodiments, the vertical distance that the wheels 1912 can be lifted and/or lowered can be generally similar to the distances D1 and D2 discussed above with respect to FIG. 4.

FIGS. 22 and 23 are enlarged side views of the robotic system 1900 illustrating actuation of supporting legs in accordance with embodiments of the present technology. In some embodiments, the four actuators 1914 (e.g., the two front actuators 1914a and the two rear actuators 1914b) can be operated independently of one another. For example, comparing FIG. 23 to FIG. 22, the two front actuators 1914a can be operated to lift the first segment 1904 while the two rear actuators 1914b remain stationary, thereby rotating the chassis 1902 about a pitch axis in one direction. More specifically, the front actuators 1914a can be operated to pull the front supporting legs 1910a such that the front wheels 1912a remain in contact with the ground and the front pivots 1916a are raised accordingly.

In another example, the two rear actuators 1914b can be operated to lift the second segment 1921 while the two front actuators 1914a remain stationary, thereby rotating the chassis 1902 about the pitch axis in the opposite direction. In yet another example, the front and rear actuators 1914 on the right side (e.g., shown in FIGS. 22 and 23) can be operated to lift the right side of the chassis 1902 while the front and rear actuators 1914 on the left side (e.g., obscured from view) can remain stationary such that the chassis 1902 rotates about a roll axis. In yet another example, the four actuators 1914 can be operated to move by different amounts to also achieve rotation of the chassis 1902 about the pitch and/or roll axes. Other combinations of controlling the four actuators 1914 are within the scope of the present technology

Raising, lowering, and/or rotating the chassis 1902 about the pitch and/or roll axes can be advantageous in extending the range of the gripper 1906, maneuvering the robotic system 1900 through constrained spaces, and shifting the weight distribution and mechanical stress on the robotic system 1900. In some embodiments, the robotic system 1900 also includes sensors (e.g., distance sensors) coupled to, for example, the chassis 1902 to measure and detect the degree of rotation of each supporting leg 1910 and/or the height of the wheels 1912 relative to the chassis 1902.

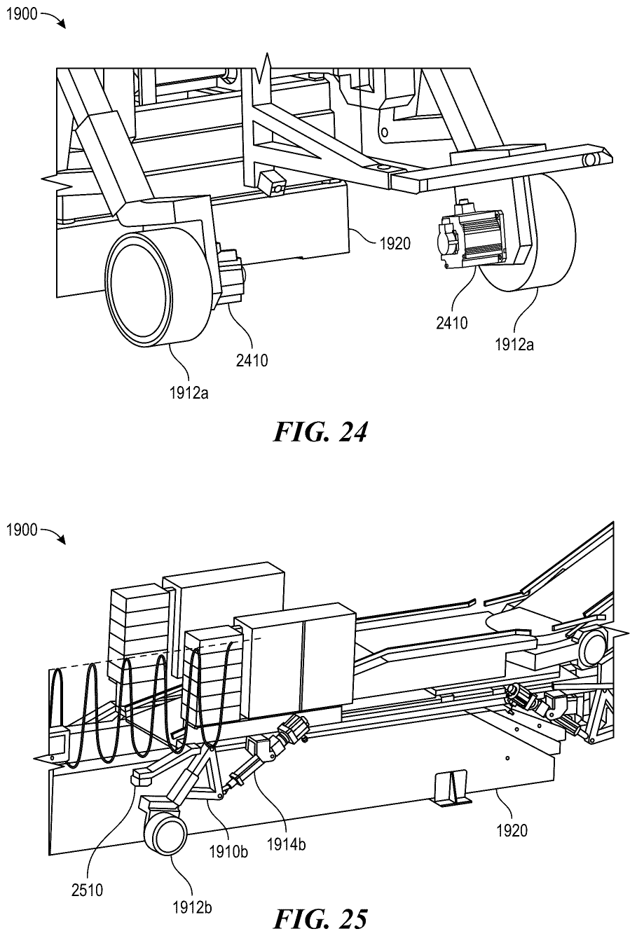

FIG. 24 is an enlarged perspective view of front wheels 1912a in accordance with embodiments of the present technology. In the illustrated embodiment, a motor 2410 is operably coupled to each front wheel 1912a. In operation, the motors 2410 can be used to drive the front wheels 1912a and move the robotic system 1900 in a desired direction (e.g., forward, backward). In some embodiments, the motors 2410 are coupled to a reducer (e.g., a gearbox) and/or a braking component such that the speed and acceleration of the front wheels 1912a can be controlled to slow down and/or brake.

In some embodiments, the front wheels 1912a are motorized, as shown, while the rear wheels 1912b are not motorized. In some embodiments, alternatively or additionally, the rear wheels 1912b are motorized. In some embodiments, the front wheels 1912a are made from a relatively high-traction material (e.g., rubber) and the rear wheels 1912b are made from a relatively normal-traction material (e.g., polyurethane). The different materials can help improve the consistency between the telescopic direction of the conveyor segment 1920 and the movement direction of the robotic system 1900.

FIG. 25 is an enlarged perspective view of the rear supporting leg 1910b and the corresponding rear wheel 1912b in accordance with embodiments of the present technology. As shown, the robotic system 1900 includes a stopper 2510 positioned above the rear wheels 1912b. The stopper 2510 can be coupled to the chassis 1902. The stopper 2510 can be configured to define a maximum degree of rotation of the rear supporting leg 1910b by physically preventing the rear supporting leg 1910b and/or the rear wheel 1912b from moving past the stopper 2510. The stopper 2510 can be made from silicone, rubber, or other suitable material to avoid damaging the rear supporting leg 1910b and/or the rear wheel 1912b. In some embodiments, the stopper 2510 is relied upon only under emergency circumstances, such as when the rear actuator 1914b fails and/or breaks off from the chassis 1902. In some embodiments, alternatively or additionally, the robotic system 1900 includes other stoppers configured to define a maximum degree of rotation for the front supporting legs 1910a.

In some embodiments, a method of operating a robotic system (e.g., the robotic system 1900) includes obtaining, from one or more sensors (e.g., the sensors 1924), an image of at least one object (e.g., the cargo 1934) to be engaged by a gripper (e.g., the gripper 1906) and conveyed along a chassis conveyor belt of a chassis (e.g., the chassis 1902) and an arm conveyor belt of an arm (e.g., the first segment 1904), determining, based on the image: (1) at least one of a first position for the chassis or a first angular position for the chassis, (2) a second position for the gripper, and (3) a second angular position for the arm, actuating (e.g., via the actuators 1914) one or more supporting legs (e.g., the supporting legs 1910) coupled to the chassis such that the chassis is at least at one of the first position or the first angular position, and actuating one or more joints (e.g., about axes A₅-A₈) of the robotic system such that the gripper is at the second position and the arm is at the second angular position.

In some embodiments, a combination of the first and second angular positions is configured to prevent or at least reduce slippage of the object along the chassis conveyor belt and/or the arm conveyor belt. In some embodiments, the method further includes detecting slippage of the object along the arm conveyor belt. Upon detecting such slippage, the method can further include actuating the one or more supporting legs to raise or lower the first position of the chassis while maintaining the gripper at the second position, thereby lowering the second angular position of the arm. Alternatively, the method can further include actuating the one or more joints to raise or lower the second position of the gripper while maintaining the chassis at the first position, thereby lowering the second angular position of the arm. Alternatively, the method can further include actuating the one or more supporting legs to raise or lower the first position of the chassis, and actuating the one or more joints to raise or lower the second position of the gripper, thereby lowering the second angular position of the arm.

In some embodiments, the method further includes detecting, via the one or more sensors, slippage of the object along the chassis conveyor belt, and actuating the one or more supporting legs to decrease the first angular position of the chassis. In some embodiments, the method further includes detecting, via the one or more sensors, a tilt of the robotic system caused by an uneven surface on which the robotic system is positioned, and actuating at least a subset of the one or more supporting legs to compensate for the tilt of the robotic system caused by the uneven surface. For example, the surface may be uneven such that the chassis tilts sideways (e.g., laterally and away from a longitudinal axis extending along the chassis conveyor belt). Supporting legs on either side of the chassis can be actuated independently (e.g., by different degrees) to tilt the chassis in the opposite direction to compensate for the uneven surface.

In some embodiments, the method further includes driving one or more wheels (e.g., the wheels 1912) attached to corresponding ones of the one or more supporting legs to move the chassis in a forward or backward direction relative to the at least one object such that the gripper maintains the second position relative to the at least one object. For example, rotating a supporting leg about a pivot (e.g., pivot 1916) on the chassis may cause the chassis to move forward or backward as the wheel maintains contact with the surface.

In some embodiments, the robotic system is positioned over a warehouse conveyor belt such that the chassis conveyor belt and the warehouse conveyor belt form a continuous travel path for the at least one object, and the one or more supporting legs are actuated such that the continuous travel path is maintained while the chassis is actuated to at least at one of the first position or the first angular position.

In some embodiments, determining the at least one of the first position or the first angular position comprises determining a first range of acceptable positions or a first range of acceptable angular positions. In some embodiments, determining the second position comprises determining a second range of acceptable positions. In some embodiments, determining the second angular position comprises determining a second range of acceptable angular positions. In some embodiments, the first and second positions are determined relative to a support surface on which the robotic system is positioned. In some embodiments, the first and second positions are determined relative to the at least one object.

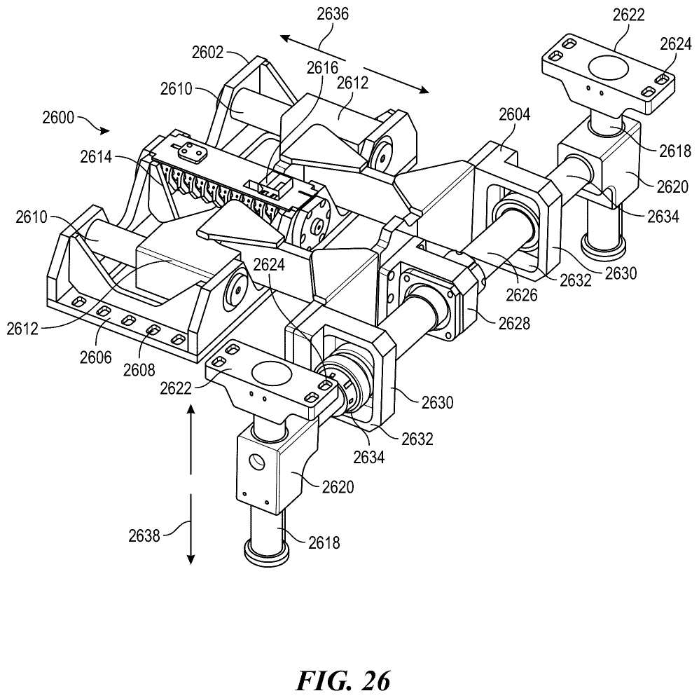

FIG. 26 is a perspective view of a chassis joint 2600 for a robotic system in accordance with one or more embodiments. As discussed above with reference to FIGS. 22-25, a chassis of a robotic system may have multiple degrees of freedom. For example, independent movement of four legs of a robotic system may (1) move the chassis in a translation degree of freedom (e.g., vertically); (2) rotate the chassis in a chassis roll degree of freedom; and (3) rotate the chassis in a chassis pitch degree of freedom. Such movements may be desirable to allow the robotic system to adapt to various environments and cargo containers, especially in retrofit environments. However, conveyors fixed to a local environment (e.g., a warehouse conveyor) typically are typically limited to a single degree of freedom: extension and retraction. As discussed further below, the chassis joint 2600 provides the chassis these degrees of freedom while allowing a warehouse conveyor or other proximal conveyor to which the chassis is operatively coupled to remain fixed or otherwise constrained to a single degree of freedom. Additionally, control of the robotic system to maintain a relative positioning between a distal end of an extending conveyor is challenging where the conveyor and the robotic system have separate controllers. As discussed further below, the chassis joint 2600 allows a robotic system to automatically follow a warehouse conveyor to which the chassis is operatively coupled when the warehouse conveyor is extended or retracted. Conversely, in some embodiments, the chassis joint 2600 may allow the conveyor to extended or retract following the movement of a robotic system chassis in a distal or proximal direction.

The chassis joint 2600 includes a conveyor mount 2602 and a chassis mount 2604. The conveyor mount 2602 is configured to be coupled to a portion of a conveyor (e.g., a warehouse conveyor or other proximal conveyor). The chassis mount 2604 is configured to be coupled to a chassis of a robotic system. In some embodiments as shown in FIG. 26, the conveyor mount 2602 includes a conveyor mounting plate 2606 having a plurality of holes 2608 that receive fasteners (e.g., bolts, screws, rivets, etc.). The chassis mount similar includes mounting plates 2622 having holes 2624 configured to received fasteners.

According to the embodiment of FIG. 26, the chassis mount 2604 is configured to move relative to the conveyor mount 2602 in a first translational degree of freedom 2636, for example, a horizontal direction along a proximal/distal axis. The conveyor mount 2602 includes two horizontal shafts 2610. The chassis mount includes two horizontal couplers 2612 configured to slide on the horizontal shafts. Accordingly, the chassis mount 2604 may slide relative to the conveyor mount 2602 in the example of FIG. 26 and therefore accommodated relative movements between extension of a conveyor and movement of the chassis of a robotic system. In some embodiments as shown in FIG. 26, the chassis joint 2600 includes a spring 2614 configured to bias the chassis mount 2604 and the conveyor mount 2602 to a predetermined position. In some embodiments, the predetermined position may be a neutral position where the chassis mount and conveyor mount can slide relative to one another in either direction. In some embodiments, the spring 2614 may be a compression spring.

The chassis joint 2600 includes a position sensor 2616 configured to provide information indicative of a relative position of the chassis mount 2604 and the conveyor mount 2602. In some embodiments, the position sensor may be a linear potentiometer. In other embodiments other sensors may be employed, as the present disclosure is not so limited. In some embodiments, an output of the position sensor may be received by a local controller and used to command rotation of wheels of a robotic system. For example, a change in relative position measured by the position sensor 2616 may trigger a controller to drive wheels of the robotic system. In this manner, the robotic system may be automatically controlled to follow the conveyor (as indicated by movement of the conveyor mount 2602). In other embodiments, the output of the position sensor 2616 may be received by a controller of a conveyor. In such embodiments, a change in relative position measured by the position sensor 2616 may trigger a conveyor controller to extend or retract the conveyor. In this manner, the conveyor may be automatically controlled to follow the robotic system (as indicated by movement of the chassis mount 2604).

The chassis joint 2600 is further configured to accommodate relative vertical movement between a robotic system chassis and a conveyor in a second translational degree of freedom 2638 (e.g., in a vertical direction). In the example of FIG. 26, the chassis mount 2604 includes two vertical shafts 2618 and two vertical couplers 2620 configured to slide on the vertical shafts 2618. The vertical shafts 2618 are attached to the chassis mounting plates 2622. Accordingly, the remainder of the chassis joint 2600 including the conveyor mount 2602 is configured to slide in a vertical direction along the vertical shafts 2618.

The chassis joint 2600 is further configured to accommodate relative pitch rotation between a robotic system chassis and a conveyor (e.g., from movement of the chassis in a chassis pitch rotational degree of freedom). In some embodiments, the vertical couplers 2620 may be further configured to rotate about a pitch axis perpendicular to a plane of the vertical axis of the vertical shafts 2618. According to such an arrangement, the chassis mounting plates 2622 and vertical shafts 2618 may rotate with a change in pitch angle of the chassis. The vertical couplers 2620 may pivot about their respective axes to accommodate this change in pitch angle without movement of the conveyor mount 2602.

The chassis joint 2600 is further configured to accommodate relative roll rotation between a robotic system chassis and a conveyor (e.g., from movement of the chassis in a chassis roll rotational degree of freedom). The vertical couplers 2620 are both coupled to an axle 2626. The axle 2626 is coupled to the conveyor mount 2602 via a swivel joint 2628. The swivel joint is configured to allow the axle to rotate about a roll axis (e.g., parallel to a plane of a longitudinal axis or a distal/proximal axis). In some embodiments as shown in FIG. 26, the chassis mount includes a pair of support brackets 2630 that support the axle 2626 and allow the axle to rotate in the roll direction. The axle includes two bushings 2634 that slide within a channel 2632 of each support bracket. In this manner, the relative heights of the first vertical coupler and the second vertical coupled may be different. For example, rotation of the axle in the swivel joint 2628 may move a first vertical coupler upwards, and a second vertical coupler downwards. The rotation of the axle 2626 in the swivel joint 2628 may occur while the conveyor mount 2602 remains stationary.

According to the embodiment of FIG. 26, a single position sensor 2616 for the first translation degree of freedom (e.g., horizontal direction) is included in the chassis joint 2600. In other embodiments, additional sensors may be included to monitor the relative position of the chassis mount 2604 and a conveyor mount 2602 in the other degrees of freedom. Outputs of such sensors may be received by a local controller and used to control various actuators of a robotic system, for example, to avoid reaching end of travel. In some embodiments, a chassis joint may include a vertical position sensor configured to obtain position information of the vertical couplers 2620 on the vertical shafts 2618. In some embodiments, a chassis joint may include a pitch position sensor configured to obtain orientation information of the vertical couplers 2620 with respect to a vertical axis. In some embodiments, a chassis joint may include roll position sensors configured to obtain orientation information of the axle 2626 with respect to a longitudinal axis. Any single sensor, subcombination, or combination of these sensors may be employed. A sensor may include, but is not limited, to a potentiometer or an encoder. In some embodiments, such sensors may be located on a robotic system and/or conveyor, and may not be included as a part of a chassis joint.

While in the embodiment of FIG. 26 the chassis joint provides for relative movement of a chassis and a conveyor in four degrees of freedom (e.g., horizontal, vertical, pitch, and roll), in other embodiments a chassis joint may provide fewer or more degrees of freedom. For example, a chassis joint may only provide for relative horizontal movement between a chassis and a conveyor, in some embodiments. Any single relative degree of freedom, subcombination, or combination of relative degrees of freedom may be provided by a chassis joint of some embodiments.

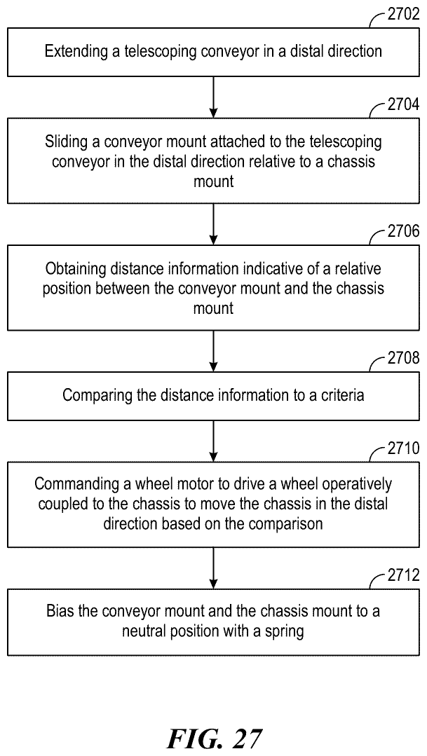

FIG. 27 is a flow diagram illustrating a process of operating a robotic system in accordance with one or more embodiments. At block 2702, the process includes extending a telescoping conveyor in a distal direction. Extending the conveyor in the distal direction may include moving a distal end of the conveyor in the distal direction, in some embodiments. At block 2704, the process includes sliding a conveyor mount attached to the telescoping conveyor in the distal direction relative to a chassis mount. The chassis mount may be attached to a chassis that remains stationary relative to the telescoping conveyor. At block 2706, the process including obtaining position information indicative of a relative position between the conveyor mount and the chassis mount. In some embodiments, the position information may be obtained from one or more distance sensors. In some embodiments, the one or more distance sensors may include a potentiometer. At block 2708, the process includes comparing the distance information to a criterion or criteria. In some embodiments, the criteria may be a numerical threshold. For example, if a magnitude of a position change as indicated by the position information may be compared against a predetermined non-zero threshold.

At block 2710, the process includes commanding a wheel motor to drive a wheel operatively coupled to the chassis to move the chassis in the distal direction based on the comparison to the criteria. For example, if the magnitude of a position change as indicated by the position information exceeds the predetermined non-zero threshold, the wheel motor may be commanded to rotate a wheel to move the chassis in the distal direction. In some embodiments, the speed of a wheel motor may be controlled based on the position information. For example, the wheel motor may be controlled such that the chassis is moved to maintain a neutral position with the telescoping conveyor. For example, for a bigger change in relative position, the wheel speed may be increased to allow the delta from the neutral position to be reduced. Correspondingly, as the delta decreases and the telescoping conveyor and chassis are close to their neural position with respect to one another, wheel speed may be decreased to match a speed of the distal end of the conveyor. In this manner, the method may include driving the wheel motor to ensure the chassis follows the telescoping conveyor. In other embodiments, the process may be inverted, such that the conveyor is controlled to follow the chassis. In optional act 2712, the process includes biasing the conveyor mount and the chassis mount to a neutral position with a spring. The spring may reduce shock loads and may assist the chassis in returning to a neutral position with respect to the telescoping conveyor.

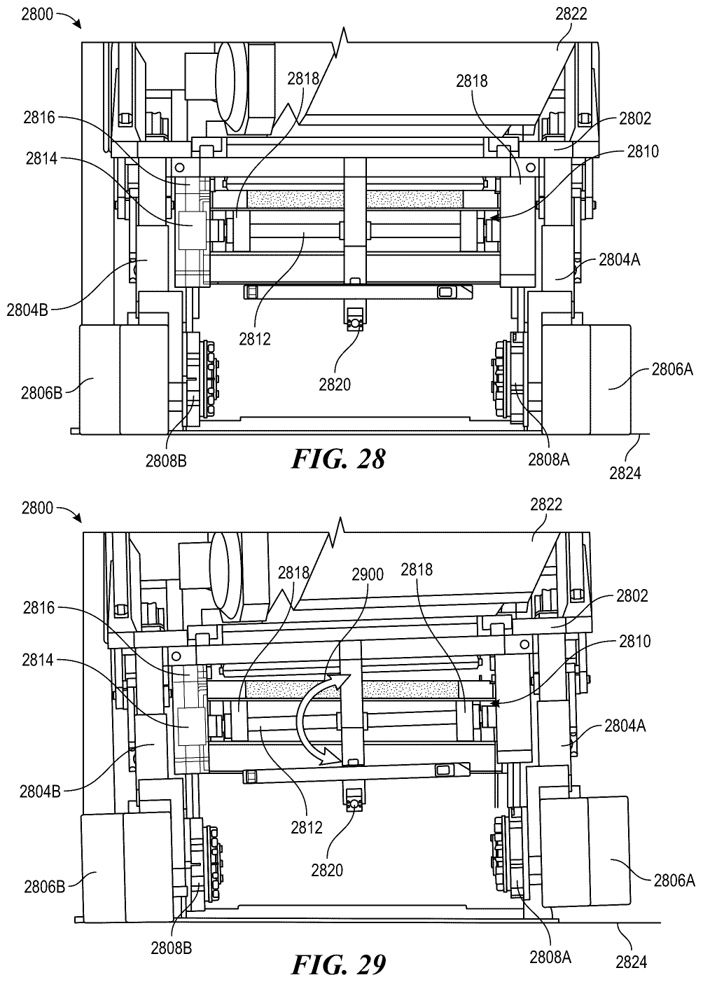

FIG. 28 is a front view of a robotic system 2800 and chassis joint in a first state in accordance with one or more embodiments, and FIG. 29 is the front view of the robotic system in a second state. The view of FIGS. 28-29 are taken looking in a proximal direction along a longitudinal axis of the robotic system 2800. As shown in FIG. 28, the robotic system 2800 includes a chassis 2802, a first leg 2804A, and a second leg 2804B. The first leg 2804A is disposed on a first side of the chassis 2802, and the second leg 2804B is disposed on a second side of the chassis 2802. The first leg 2804A includes a first wheel 2806A, and the second leg includes a second wheel 2806B. The first and second wheels are configured to rotate to allow the chassis to move in translational degree of freedom corresponding to movement along a longitudinal axis of the robotic system (e.g., moving the chassis in a proximal or distal direction). In some embodiments as shown in FIG. 28, the first wheel 2806A is coupled to a first wheel motor 2808A and the second wheel 2806B is coupled to a second wheel motor 2808B. The first wheel may be driven directly by the first wheel motor and the second wheel may be driven directly by the second wheel motor. Additionally, the wheel may be driven independently, in some embodiments. The first wheel 2806A and the second wheel 2806B may be front wheels formed of a rubber material. In some embodiments, this rubber material may be a different material than that of rear wheels, which may be polyurethane in some embodiments.

As shown in FIG. 28, the robotic system includes a chassis mount 2810. The chassis mount may be like that shown and described with reference to FIG. 26, in some embodiments. In the depicted example, the chassis mount 2810 includes an axle 2812. The axle 2812 is connected on both ends to a vertical coupler 2814, one of which is shown through transparency. The vertical coupler 2814 is configured to slide along a vertical shaft 2816, which is attached to the chassis 2802. The axle 2812 may be configured to rotate in a roll direction 2900, for example about an axis into the page (e.g., parallel to a longitudinal axis of the robotic system). As the axle 2812 rotates in the roll direction 2900, one end of the axle may move upward and one downward in an opposite direction. Accordingly, one vertical coupler 2814 may move upward and the other may move downward. In some embodiments as shown in FIG. 29, the axle 2812 slides within support brackets 2818. Such a rotation may allow the chassis mount 2810 to accommodate rotation of the chassis 2802 in a chassis roll degree of freedom. As shown in FIG. 29, as the chassis rolls, the axle 2812 may also roll while allowing an associated conveyor to retain a fixed orientation. Roll of the chassis 2802 may be caused by irregularities in the floor 2824 of an operating environment, for example, bumps, holes, and non-level surfaces. Roll of the chassis 2802 may also be caused by differences in height of the first leg 2804A and the second leg 2804B.

In some embodiments as shown in FIGS. 28-29, a robotic system 2800 may include a vision sensor 2820 that is positioned below a segment 2822 of the robotic system as described with reference to other embodiments herein. Such an arrangement may allow the vision sensor 2820 to obtain images of a plurality of objects within a cargo carrier more easily with less obstruction from the segment 2822 and other components of the robotic system.

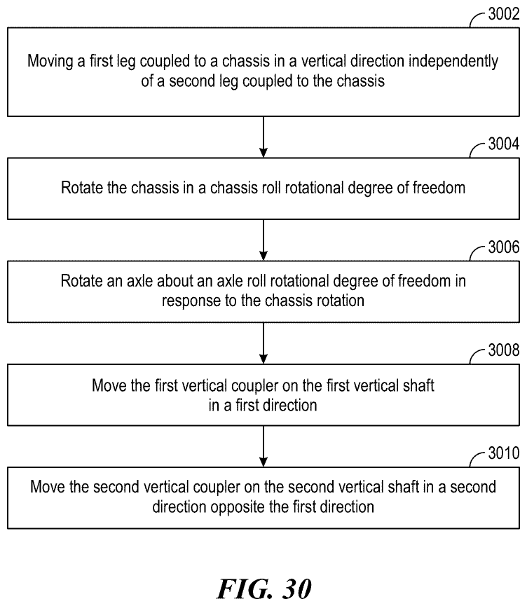

FIG. 30 is a flow diagram illustrating a process of operating a robotic system in accordance with one or more embodiments. At block 3002, the process includes moving a first leg coupled to a chassis in a vertical direction independently of a second leg coupled to the chassis. At block 3004, the process includes rotating the chassis in a chassis roll rotational degree of freedom. At block 3006, the process includes rotating an axle about an axle roll rotational degree of freedom in response to the chassis rotation. At block 3008, the process includes moving the first vertical coupler on the first vertical shaft in a first direction. At block 3010, the method includes moving the second vertical coupler on the second vertical shaft in a second direction opposite the first direction. The robotic system (e.g., the robotic system 1900 of FIG. 19) can use one or more controllers, such as the controllers 1938 of FIG. 19 the circuitry therein to operate the various actuation devices (e.g., actuators 1908, 1936, etc. of FIG. 19 and corresponding to the actuation device 212 of FIG. 2) to perform one or more actions described above.

### Example EOATs for the Robotic System

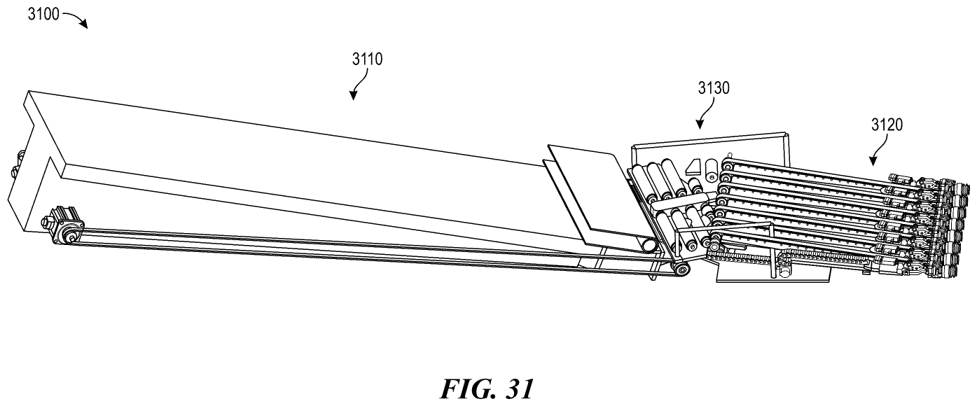

FIG. 31 is a partially schematic isometric view of a robotic system 3100 configured in accordance with some embodiments of the present technology. In the illustrated embodiment, the robotic system 3100 includes a movable arm 3110, an end effector 3120, and a distal joint 3130 operably coupled between the movable arm 3110 and the end effector 3120. The movable arm 3110 can be generally similar to any of the movable arms discussed above with reference to FIGS. 3-12F to position the end effector 3120 (sometimes also referred to herein as an “end-of-arm tool”) adjacent to one or more target objects (e.g., boxes in a cargo carrier, such as a shipping container and/or a truck). Additionally, or alternatively, the movable arm 3110 can establish a transfer pathway between the target objects and an offload unit (e.g., a warehouse conveyor system, a warehouse cart, a warehouse truck, and/or the like). As discussed in more detail below, the end effector 3120 and the distal joint 3130 can include various features that help pick up and/or otherwise grip target objects from a variety of locations. For example, the end effector 3120 can include features that allow the robotic system 3100 to at least partially lift individual target objects onto a conveyor system to pick up the individual target objects without disturbing (or with a reduced disturbance) surrounding target objects. In another example, the distal joint 3130 can include various features that help improve the range of motion for the robotic system 3100 and/or the end effector 3120 therein.

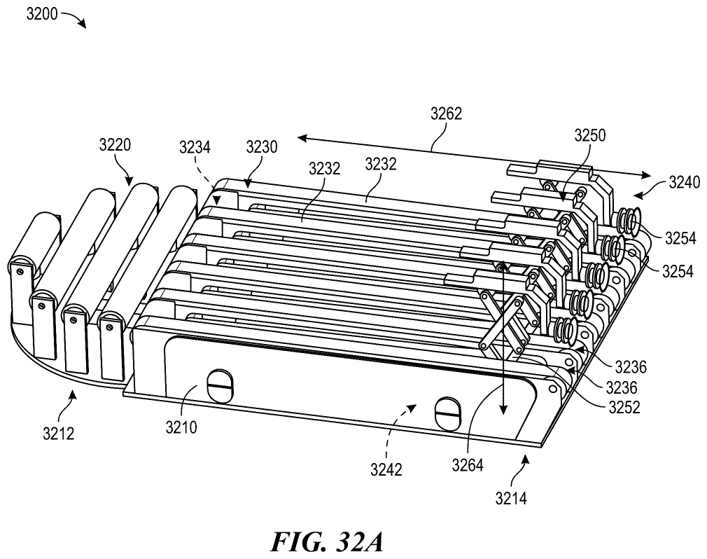

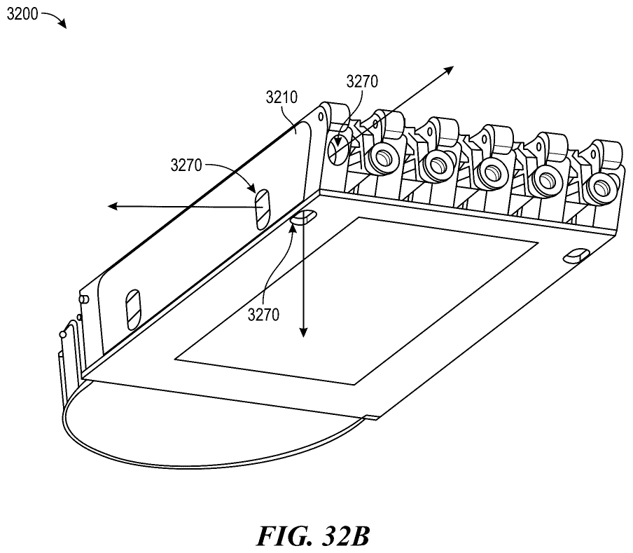

FIGS. 32A and 32B are partially schematic upper and lower side views of an end effector 3200 configured in accordance with some embodiments of the present technology. The end effector 3200 can be generally similar (or identical) to the end effectors (sometimes also referred to as an “end of arm tool,” a “gripper,” and/or the like) discussed above with reference to FIGS. 3-12F. As best illustrated in FIG. 32A, the end effector 3200 includes a frame 3210, a plurality of joint conveyors 3220, a plurality of frame conveyors 3230, and a gripping component 3240. The frame 3210 has a proximal end region 3212 that is couplable to a robotic system (e.g., via the distal joint 3130 of FIG. 31) and a distal end region 3214 opposite the proximal end region 3212. The plurality of joint conveyors 3220 are coupled to the proximal end region 3212 of the frame 3210. Each of the plurality of frame conveyors 3230 extends from the distal end region 3214 to the proximal end region 3212.

In the embodiment illustrated in FIG. 32A, the plurality of joint conveyors 3220 are rollers extending laterally along a transverse axis of the end effector 3200 while the plurality of frame conveyors 3230 include a plurality of individual conveyor belts 3232 extending along (or generally parallel to) a longitudinal axis of the end effector 3200. The individual conveyor belts 3232 are each operably coupled to a common drive component 3234 (e.g., a common drive pulley, drive shaft, and/or the like) to operate each of the plurality of frame conveyors 3230 at the same (or generally the same) speed.

As further illustrated in FIG. 32A, each of the individual conveyor belts 3232 is spaced apart from the neighboring conveyor belts to define channels 3236 between the individual conveyor belts 3232. The gripping component 3240 (sometimes also referred to herein as a “gripping component”) includes a drive component 3242 that is carried by the frame 3210 and a plurality of gripping assemblies 3250 that includes an extendible component 3252 and a gripping element 3254 (sometimes also referred to herein as a “gripper element,” an “engagement element,” and/or the like) carried by the extendible component 3252. Each of the gripping assemblies (sometimes also referred to herein as “gripper assemblies”) is coupled to the drive component 3242 and positioned in one of the channels 3236. Accordingly, the drive component 3242 can move each of the plurality of gripping assemblies 3250 along a first motion path 3262 between the distal end region 3214 and the proximal end region 3212 (e.g., generally along the longitudinal axis of the end effector 3200) within and/or above a corresponding one of the channels 3236. Further, each of the extendible components 3252 can move a corresponding one of the gripping elements 3254 along a second motion path 3264

As discussed in more detail below, during a gripping operation with the end effector 3200, the gripping component 3240 can move between various positions to pick up (and/or otherwise grip) a target object beyond the distal end region 3214 of the frame 3210, place (and/or otherwise release) the target object on top of the frame conveyors 3230, and clear a path for the target object to move proximally along the frame conveyors 3230. Further, once a target object is placed on the plurality of frame conveyors 3230, the plurality of frame conveyors 3230 and the plurality of joint conveyors 3220 can move the target object in a proximal direction (e.g., toward a movable base component to unload a cargo carrier). Additionally, or alternatively, the plurality of joint conveyors 3220 and the plurality of frame conveyors 3230 can move a target object in a distal direction, then the gripping component 3240 can pick the target objects up and place them distal to the distal end region 3214 of the frame 3210 (e.g., to pack a cargo carrier, sometimes also referred to herein as a “shipping unit”).

As best illustrated in FIG. 32B, the end effector 3200 can also include one or more sensors 3270 (three illustrated in FIG. 32B). The sensors 3270 can include proximity sensors, image sensors, motion sensors, and/or any other suitable sensors to monitor an environment around the end effector 3200, to help identify one or more target objects, to help identify one or more placement locations for a target object, and/or the like. In a specific, non-limiting example, the sensors 3270 can include an imaging sensor that images a shipping unit to allow a suitable component (e.g., the processors 202 of FIG. 2 and/or another suitable component) to identify one or more target objects in the shipping unit and/or an operational plan to unpack the shipping unit. While unpacking the shipping unit, the sensors 3270 can then monitor the shipping unit and/or an environment around the end effector 3200 to prompt changes to the operational plan and/or detect changes in the environment. For example, the operational plan can be updated when one or more target objects shift (fall, tilt, rotate, and/or otherwise move) during the unpacking process. In another example, the sensors 3270 can detect and avoid hazards (e.g., a human or other living being, other robotic unit, movements in the shipping unit, and/or the like) in the environment around the end effector 3200.

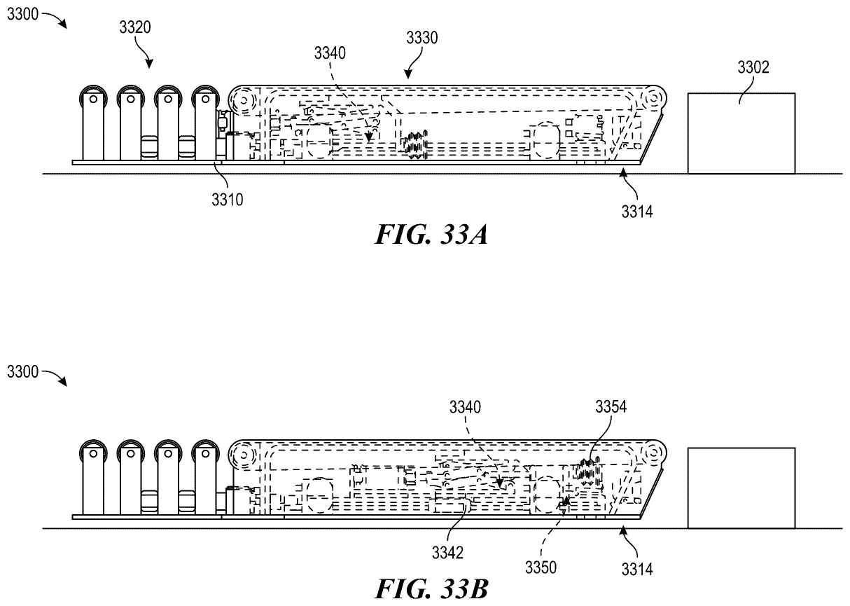

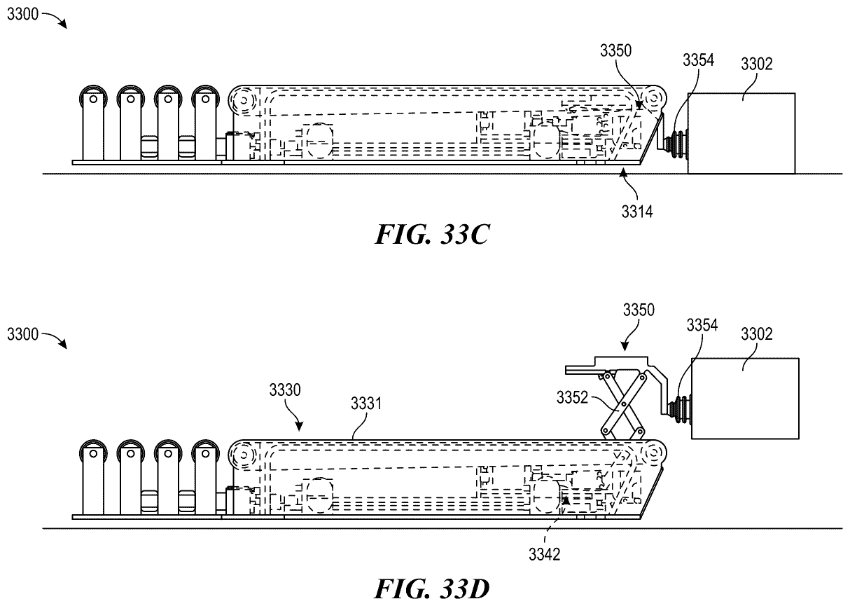

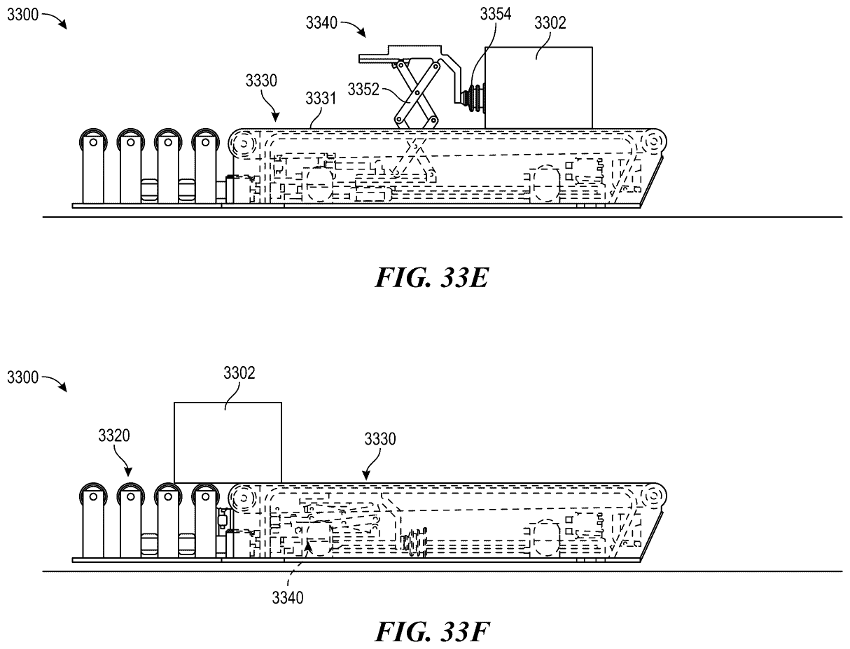

FIGS. 33A-33F are partially schematic side views of an end effector 3300 at various stages of a process for picking up a target object in accordance with some embodiments of the present technology. As illustrated in FIG. 33A, the end effector 3300 can be generally similar (or identical) to the end effector 3200 discussed above with reference to FIGS. 32A and 32B. For example, the end effector 3300 (sometimes also referred to herein as an end-of-arm tool) includes a frame 3310, a plurality of joint conveyors 3320, a plurality of frame conveyors 3330, and a gripper component 3340.

FIG. 33A illustrates the end effector 3300 after identifying a target object 3302 (e.g., using the sensors 3270 discussed above with reference to FIG. 32B and/or any other suitable sensors) and positioning the end effector 3300 adjacent to the target object 3302. In this position, the target object 3302 is distal to a distal end region 3314 of the frame 3310.

FIG. 33B illustrates the end effector 3300 while actuating the gripper component 3340 distally toward the distal end region 3314. In various embodiments, the end effector 3300 can actuate the gripper component 3340 by expanding (or contracting) an expandable component (e.g., a piston, a scissor mechanism, and/or the like), driving one or more carts along a guide track, driving a pulley to move a belt and/or gear track coupled to the gripper component 3340, and/or any other suitable mechanism. As discussed in more detail below, the end effector 3300 can actuate the gripper component 3340 by moving a common drive component 3342 to move multiple gripping assemblies 3350 in tandem (e.g., concurrently, generally simultaneously, and the like). In turn, the concurrent movement of the gripping assemblies 3350 can help ensure that the gripping assemblies 3350 are aligned at their distal-most point, helping to ensure that gripping elements 3354 in the gripping assemblies 3350 can engage an object (e.g., the target object 3302) at the same time (or generally the same time).

FIG. 33C illustrates the end effector 3300 after the gripping element 3354 (sometimes also referred to herein as a “gripper element,” an “engagement element,” and/or the like) in one or more of the gripping assemblies 3350 is positioned distal to the distal end region 3314 and operated to engage the target object 3302 (sometimes referred to herein as a “first position,” a “pick-up position,” and “engagement position,” and/or the like). In various embodiments, the gripping elements 3354 can include a vacuum component (sometimes also referred to herein as a suction component), a magnetic component, a mechanical gripper component, and/or the like to engage (e.g., grip, pick up, and/or otherwise couple to) the target object 3302. In the illustrated embodiment, the gripping elements 3354 include vacuum components that use a vacuum (or suction) force to engage the target object 3302. Once engaged, the gripping assemblies 3350 can at least partially lift and/or move the target object 3302.

FIG. 33D illustrates the end effector 3300 after actuating extendible components 3352 in the gripping assemblies 3350 to move the gripping elements 3354, and the target object 3302 engaged thereby, at least partially above an upper surface 3331 of the plurality of frame conveyors 3330. In the illustrated embodiment, the extendible components 3352 (sometimes also referred to herein as “vertical actuation components”) include a scissor mechanism coupled between the gripping elements 3354 and the common drive component 3342. In various embodiments, the extendible components 3352 can include a shape-memory device, a piston, a telescoping component, a scissor mechanism, a linkage mechanism, and/or any other suitable expanding component that are movable between an extended configuration (e.g., as illustrated in FIG. 33D) and a collapsed configuration (e.g., as illustrated in FIG. 33C).

Once the target object 3302 has been lifted at least partially above an upper surface 3331 of the plurality of frame conveyors 3330, the end effector 3300 can actuate the gripper component 3340 proximally, as illustrated in FIG. 33E. As a result, the gripper component 3340 moves the target object 3302 onto the upper surface 3331 of one or more of the plurality of frame conveyors 3330 (sometimes referred to herein as a “second position,” an “object drop-off position,” a “disengagement position,” and/or the like). Once the target object 3302 is movably carried by the upper surface 3331 of one or more of the plurality of frame conveyors 3330, the end effector 3300 can operate the gripping elements 3354 to disengage the target object 3302, then actuate the gripper component 3340 to clear a path for the plurality of frame conveyors 3330 to move the target object 3302 proximally. In some embodiments, disengaging from the target object can include providing a burst of fluid (e.g., air, argon gas, and/or another suitable fluid) to the gripping elements 3354 to counteract the vacuum and/or suction force therein, thereby releasing the target object 3302. Once disengaged, actuating the gripper component 3340 can include moving the common drive component 3342 proximally while collapsing the extendible components 3352. The drive component 3342 can move proximally more quickly than the plurality of frame conveyors 3330 move the target object 3302. As a result, the gripper component 3340 can move proximally more quickly than the target object 3302 to create some separation between the gripper component 3340 and the target object 3302 while positioning every component of the gripper component 3340 beneath the upper surface 3331 of the plurality of frame conveyors 3330.

FIG. 33F illustrates the end effector 3300 after the gripper component 3340 has been fully positioned beneath the upper surface 3331 of the plurality of frame conveyors 3330 to clear a path for the target object 3302 (sometimes referred to herein as a “third position,” a “lowered position,” a “standby position,” and/or the like). As illustrated in FIG. 33F, the plurality of frame conveyors 3330 can then move the target object 3302 proximally and onto the plurality of joint conveyors 3320. In turn, the joint conveyors can continue to move the target object 3302 proximally (e.g., toward a movable base component carrying the end effector 3300, such as the chassis 302 of FIG. 3).

In the embodiments of the end effector illustrated in FIGS. 33A-33F, the frame has a generally consistent thickness between the proximal end region and the distal end region. The consistent thickness can help improve a stability of the frame (and/or the end effector thereof). However, as illustrated in FIGS. 33A-33F, the consistent thickness can require that the gripper component 3340 can fully lift any objects targeted by the end effector in order to place them on the upper surface of the frame conveyors, which can limit the number of objects that an end effector of the type illustrated in FIGS. 33A-33F can, for example, unload from a shipping unit (e.g., from a truck, a shipping container, and/or the like). In various other embodiments, however, the frame can have different shapes that can help expand the usability of the end effector.

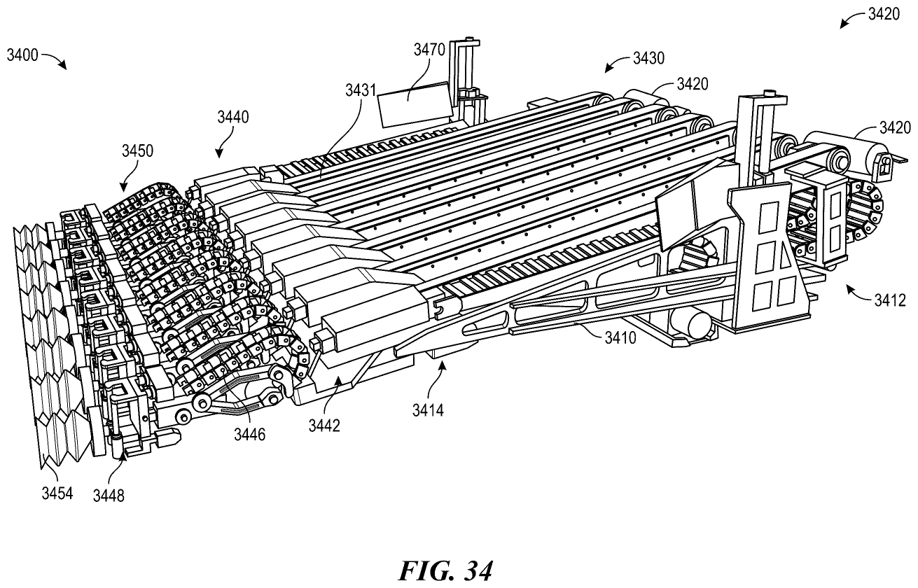

FIG. 34 is a partially schematic upper-side view of an end effector 3400 configured in accordance with some embodiments of the present technology. As illustrated in FIG. 34, the end effector 3400 is generally similar to the end effector 3200 discussed above with reference to FIGS. 32A and 32B. For example, the end effector 3400 (sometimes also referred to herein as an end-of-arm tool) includes a frame 3410, a plurality of joint conveyors 3420, a plurality of frame conveyors 3430, and a gripper component 3440. Further, the frame 3410 extends from a proximal end portion 3412 to a distal end portion 3414, the plurality of joint conveyors 3420 are carried by the proximal end portion 3412, and the plurality of frame conveyors 3430 extend from the distal end portion 3414 to the proximal end portion 3412. Still further, the gripper component 3440 includes a drive component 3442 and one or more gripping assemblies 3450 (eight illustrated in FIG. 34) coupled to the drive component 3442. Similar to the components discussed above, the drive component 3442 can move the gripping assemblies 3450 along a longitudinal axis of the end effector 3400. Further, the gripping assemblies 3450 can be actuated to move gripping elements 3454 in the gripping assemblies 3450 in an upward direction.

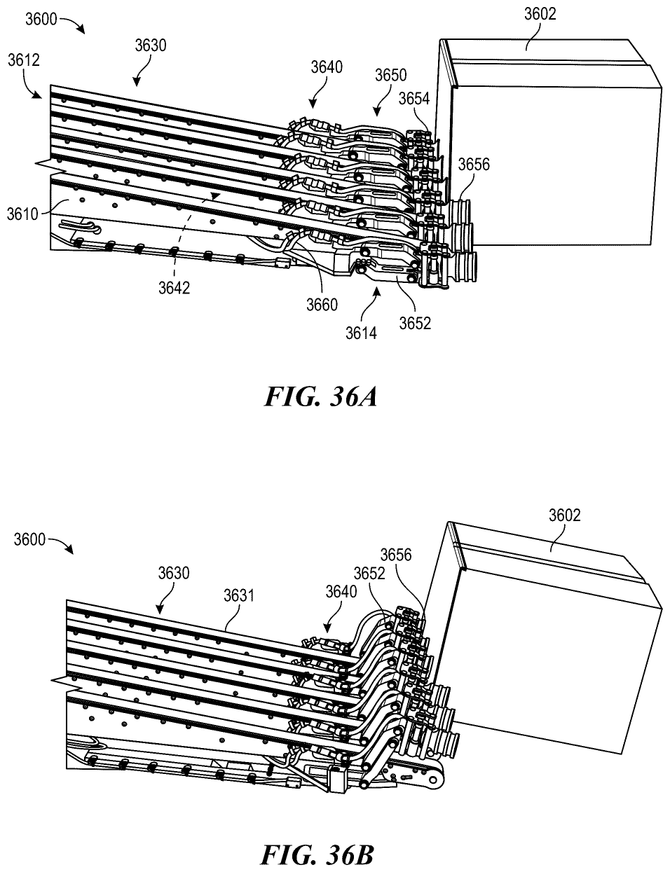

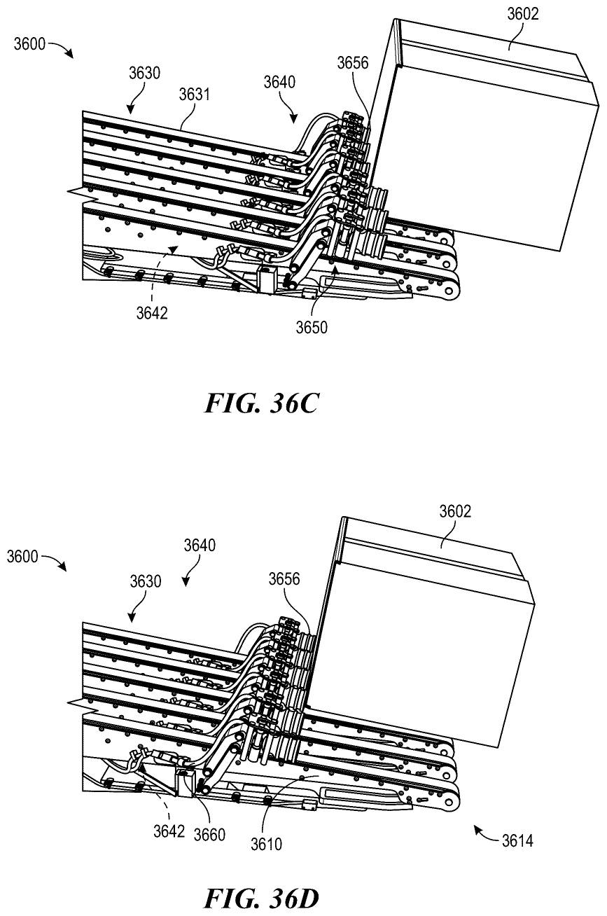

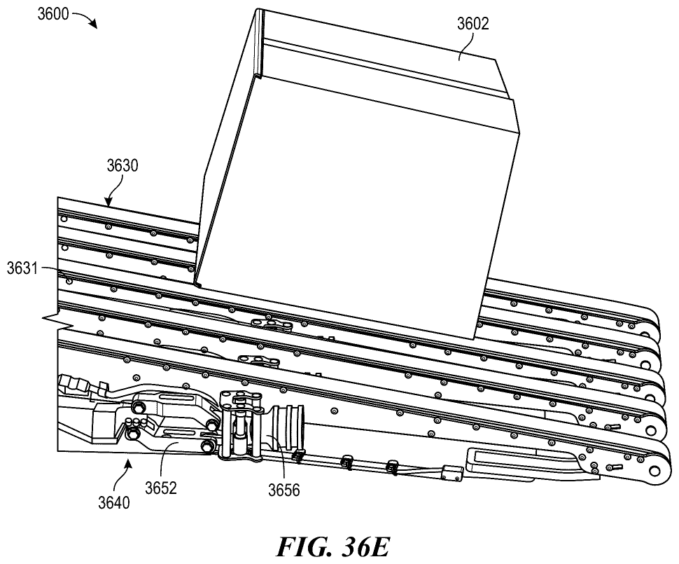

In the illustrated embodiment, however, the frame 3410 has a wedge-shaped construction with a smaller vertical thickness at the distal end portion 3414 than at the proximal end portion 3412. As illustrated and discussed in more detail with reference to FIGS. 36A-36E, the wedge-shaped construction can allow the gripping assemblies 3450 to place and/or otherwise position objects on at least a portion of an upper surface 3431 of the plurality of frame conveyors 3430 without needing to fully lift the objects. As a result, the end effector 3400 can be employed to unpack a variety of objects from a shipping unit, including objects that cannot be fully lifted by the gripper component 3440 (e.g., due to their weight).

As further illustrated in FIG. 34, the end effector 3400 can include one or more guide components 3470 (two illustrated in FIG. 34) coupled to the frame 3410. The guide components 3470 can be positioned to help direct an object on the upper surface 3431 of the plurality of frame conveyors 3430 toward a central portion of the upper surface 3431 as the plurality of frame conveyors 3430 move the object in a proximal direction. Said another way, the guide components 3470 can act as side rails to help prevent an object placed on the plurality of frame conveyors 3430 from falling off lateral sides of the end effector 3400 as it moves proximally.

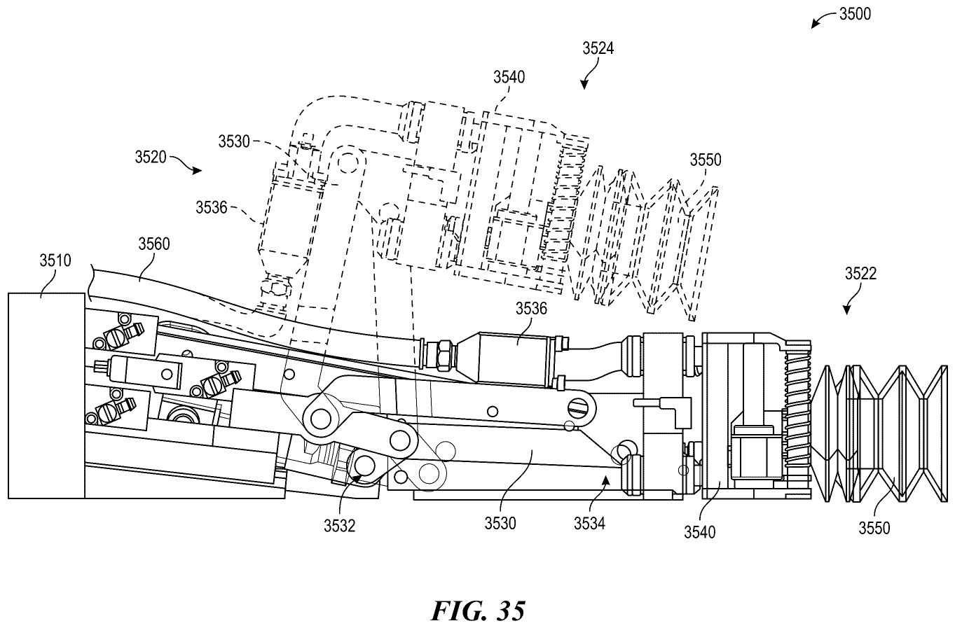

FIG. 35 is a partially schematic side view of a gripper component 3500 of the type illustrated in FIG. 34 in accordance with some embodiments of the present technology. That is, the gripper component 3500 illustrated in FIG. 35 can be generally similar to (or the same as) one of the gripper components 3440 of FIG. 34. In the illustrated embodiment, the gripper component 3500 (sometimes also referred to herein as a “gripping component”) includes a drive component 3510 and a gripping assembly 3520 operatively coupled to the drive component 3510. Although only a single gripping assembly 3520 is illustrated in FIG. 35, it will be understood that, in some embodiments, the drive component 3510 is operably coupled to a plurality of similar gripping assemblies to control a position of the gripping assemblies along an end effector in tandem (or generally in tandem). In the illustrated embodiment, the gripping assembly 3520 includes a pivotable link 3530, a connections housing 3540, and a gripping element 3550.

In the illustrated embodiment, the pivotable link 3530 (sometimes referred to herein as a “linkage mechanism”) includes a proximal end 3532 pivotably coupled to the drive component 3510 as well as a distal end 3534 pivotably coupled to the connections housing 3540. As a result, the pivotable link 3530 allows the gripping assembly 3520 to be actuated between a first position 3522 (shown in solid lines) and a second position 3524 (shown in broken lines). As discussed and illustrated in more detail below, the transition can allow the gripping assembly 3520 to engage and at least partially lift target objects onto an upper surface of an end effector (e.g., onto the upper surface 3331 of the plurality of frame conveyors 3330 of FIG. 33D, onto the upper surface 3431 of the frame conveyors 3430 of FIG. 34, and/or the like). For example, in the first position 3522, the gripping assembly 3520 can project beyond a distalmost end of a frame of an end effector to engage a target object. Once engaged, the gripping assembly 3520 can transition to the second position 3524 while at least partially lifting a target object (e.g., fully lifting, lifting one side of a target object, and/or the like). The drive component 3510 can then move proximally to pull the target object onto the upper surface. Said another way, the pivotable link 3530 has a carrying configuration and a standby configuration (e.g., the first position 3522). In the carrying configuration, the pivotable link 3530 positions the gripping element 3550 such that the gripping element 3550 can hold a target object spaced apart from one or more conveyors while the linkage assembly rotates relative to the frame of the end effector. The rotation allows the gripping element 3550 to move the target object above the plurality of conveyors (e.g., into the second position 3524, above the upper surface 3331 of the plurality of frame conveyors 3330 of FIG. 33D). In the standby configuration, the pivotable link 3530 positions the gripper element within the end effector (e.g., beneath the upper surface 3331 of the plurality of frame conveyors 3330 of FIG. 33D).

In some embodiments, movement between the first position 3522 and the second position 3524 is driven by a belt and pulley system operably coupled to the pivotable link 3530 and/or the connections housing 3540. For example, returning to the description of FIG. 34, the gripper component 3440 can include a plurality of belts 3446 that are coupled to a connections housing 3448. When the plurality of belts 3446 are pulled backward (e.g., by rotation of a drive shaft and/or one or more pulleys), they pull on the corresponding connections housing 3448, thereby causing the gripper component 3440 to actuate (e.g., rotate, pivot, and/or otherwise move) to a raised position, such as the second position illustrated in FIG. 35. Returning to FIG. 35, in some embodiments, movement between the first position 3522 and the second position 3524 is driven by a rotor and/or other electric drive mechanism operably coupled to the pivotable link 3530. In some embodiments, the pivotable link 3530 is operatively coupled to an actuating mechanism common between multiple gripping assemblies to control movement between the first position 3522 and the second position 3524 generally simultaneously.

As further illustrated in FIG. 35, the pivotable link can include an anchor 3536 positioned between the proximal end 3532 and the distal end 3534. The anchor 3536 can help manage various connections 3560 (e.g., electrical wires, vacuum tubes, vacuum lines, fluid lines, and/or the like) extending between the drive component 3510 and the connections housing 3540. That is, the anchor 3536 provides a fixed point for the connections 3560 as the gripping assembly 3520 transitions between the first position 3522 and the second position 3524. As a result, for example, the anchor 3536 can help reduce the chance that the connections 3560 are caught on another part of the gripper component 3500, the end effector, and/or a surrounding environment. In turn, the management can help improve a speed and accuracy of the gripper component 3500 (e.g., the gripping assembly 3520 can transition between the first position 3522 and the second position 3524 more quickly when the chance of a snag is reduced).

The connections housing 3540 can then route the connections 3560 to an appropriate end location. For example, in some embodiments, the gripping element 3550 (sometimes also referred to herein as a “gripper element,” an “engagement element,” and/or the like) includes a vacuum component. In such embodiments, the connections housing 3540 can route a vacuum tube to an input for the vacuum component to provide a vacuum pressure (and/or positive pressure) to engage (and disengage) a target object. In another example, the gripping element 3550 includes a magnetic component. In this example, the connections housing 3540 can route electrical connections to the magnetic component to generate (and stop generating) a magnetic force to engage (and disengage) a target object. In yet another example, the gripping element 3550 includes a mechanical gripper component (e.g., a clamp). In this example, the connections housing 3540 can route electrical connections to the clamping to actuate the mechanical gripper component to engage (and disengage) a target object.

FIGS. 36A-36E are partially schematic side views of an end effector 3600 at various stages of a process for picking up a target object in accordance with some embodiments of the present technology. The end effector 3600 can be generally similar to (or identical to) the end effector 3400 discussed above with reference to FIG. 34. For example, as illustrated in FIG. 36A, the end effector 3600 (sometimes also referred to herein as an end-of-arm tool) includes a frame 3610, a plurality of frame conveyors 3630, and a gripper component 3640. Further, the frame 3610 extends from a proximal end portion 3612 to a distal end portion 3614, and the plurality of frame conveyors 3630 are positioned to move an object thereon between the distal end portion 3614 and the proximal end portion 3612.

As further illustrated in FIG. 36A, the gripper component 3640 can be generally similar (or identical) to the gripper component 3500 discussed with reference to FIG. 35. For example, the gripper component 3640 can include a drive component 3642 and one or more gripping assemblies 3650 (six illustrated in FIG. 36A) operably coupled to the drive component 3642. The gripping assemblies 3650 each include a pivotable link 3652, a connections housing 3654, and a gripping element 3656. Similar to the components discussed above, the drive component 3642 can be actuated to move the gripping assemblies 3650 along a longitudinal axis of the end effector 3600. For example, as illustrated in FIG. 36A, the gripper component 3640 (or another suitable controller) can move the drive component 3642 to position the gripping assemblies 3650 to a position distal to a distalmost end of the frame 3610 (sometimes referred to herein as a “first position,” a “pick-up position,” and “engagement position,” and/or the like). In this position, one or more of the gripping assemblies 3650 can be operated to engage a target object 3602 (three in the illustrated embodiment).

In the illustrated embodiment, the engagement can be accomplished by delivering a drive force to the gripping elements 3656 via connections 3660 individually coupled between the drive component 3642 and each of the gripping elements 3656. In various embodiments, the drive force can be a vacuum force (sometimes also referred to herein as a suction force, e.g., delivered by a vacuum tube), an electrical drive force (e.g., supplied to a magnetic component, a mechanical gripper component, and/or the like), a pneumatic force (e.g., delivered to a mechanical gripper component), and/or any other suitable force. The drive force allows each of the gripping elements 3656 to releasably engage (e.g., grip, pick up, and/or otherwise couple to) the target object 3602.

As illustrated in FIG. 36B, after one or more of the gripping elements 3656 engages the target object 3602, the gripper component 3640 (or any other suitable controller) can actuate the pivotable links 3652 to raise the connections housings 3654 and the gripping elements 3656, thereby at least partially lifting the target object 3602. In the illustrated embodiment, the gripper component 3640 thereby tilts the target object 3602 onto a trailing edge, with the leading edge raised above an upper surface 3631 of the plurality of frame conveyors 3630.

Tilting the target object 3602 can have several benefits for the end effector 3600. For example, tilting the target object 3602 does not require that the gripping assemblies fully lift the target object 3602, which can be relatively difficult for heavier objects and/or objects that are otherwise difficult to engage with the gripping elements 3656. As a result, for example, the end effector 3600 can be used to unload a wider variety of objects from a shipping unit. Additionally, or alternatively, tilting the target object 3602 can reduce the surface area of the target object in contact with an underlying surface, thereby also reducing friction with the underlying surface. The reduction in friction, in turn, can lower the force required to pull the target object 3602 proximally onto the upper surface 3631 of them plurality of frame conveyors 3630 and/or reduce the chance pulling the target object 3602 will disrupt underlying objects (e.g., knock over a stack of underlying boxes that will be targeted next).

As illustrated in FIG. 36C, after the leading edge of the target object 3602 is raised above the upper surface 3631 of the plurality of frame conveyors 3630, the gripper component 3640 (or another suitable controller) can move the drive component 3642 to move the gripping assemblies 3650 proximally. As a result, the gripping assemblies 3650 can pull the target object 3602 onto the upper surface 3631 of the plurality of frame conveyors 3630 (sometimes referred to herein as a “second position,” an “object drop-off position,” a “disengagement position,” and/or the like).

As illustrated in FIG. 36D, as the drive component 3642 continues to move in a proximal direction, the gripper component 3640 (or another suitable controller) can actuate the gripping elements 3656 to disengage the target object. In some embodiments, the disengagement is accomplished by cutting off the drive force from the gripping elements 3656. In some embodiments, the disengagement includes delivering a disengagement force to the gripping elements 3656. For example, in embodiments using a vacuum force to engage the target object 3602, a vacuum pressure can continue to exist between the gripping elements 3656 and the target object 3602 after the vacuum force is cut off. In such embodiments, the gripper component 3640 can disengage the gripping elements 3656 by delivering a positive pressure (e.g., a burst of air, argon gas, and/or another suitable fluid) to the gripping elements via the connections 3660.

In some embodiments, the gripper component 3640 (or another suitable controller) causes the gripping elements 3656 to disengage the target object 3602 at a predetermined position between the distal end portion 3614 and the proximal end portion 3612 of the frame 3610. The predetermined distance can be configured such that the plurality of frame conveyors 3630 can move the target object 3602 proximally without the help of the gripper components 3640. In some embodiments, the end effector 3600 can include one or more sensors (see FIGS. 32A and 32B) that detect when the gripping elements 3656 and/or the target object 3602 reach the predetermined position. In some embodiments, the position of the gripper component 3640 and/or the gripping elements 3656 can be measured by monitoring a drive mechanism coupled to the drive component 3642 (e.g., by measuring rotations of a rotor coupled to the drive component 3642 to determine a position of the gripper component 3640).

Once the gripping elements 3656 disengage the target object 3602, the gripper component 3640 (or another suitable controller) can operate the drive component 3642 to move the gripping elements 3656 of the gripper component 3640 proximally more quickly than the plurality of frame conveyors 3630 move the target object 3602. As a result, the drive component 3642 can create some separation between the gripping elements 3656 and the target object 3602 to allow the gripping elements 3656 to be positioned beneath the plurality of frame conveyors 3630.

For example, as illustrated in FIG. 36E, after the gripping elements 3656 are separated from the target object 3602, the gripper component 3640 (or another suitable controller) can actuate the pivotable links 3652 to lower the connections housings 3654 and the gripping elements 3656 beneath the upper surface 3631 of the plurality of frame conveyors 3630. As a result, the gripper component 3640 is positioned fully outside of a proximal travel path for the target object 3602 along the plurality of frame conveyors 3630 (sometimes referred to herein as a “third position,” a “lowered position,” a “standby position,” and/or the like). The plurality of frame conveyors 3630 can then move the target object 3602 proximally (e.g., toward a movable base component) while (or before) the end effector 3600 is moved adjacent to the next target object.

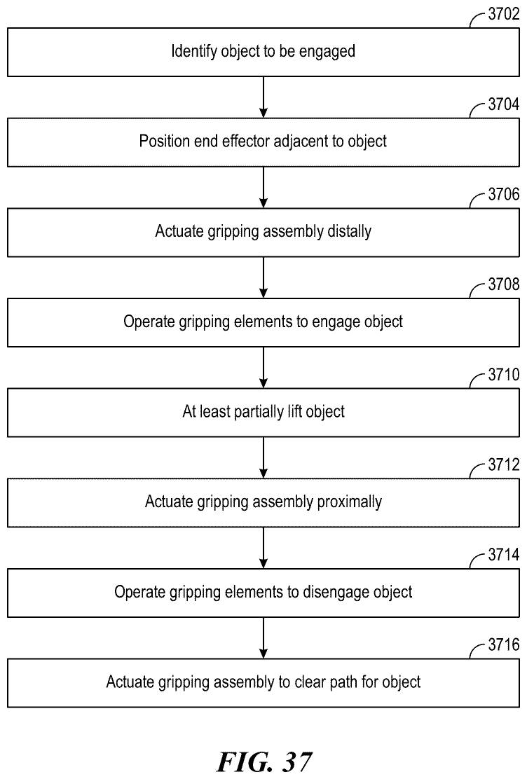

FIG. 37 is a flow diagram of a process for picking up a target object in accordance with some embodiments of the present technology. The process can be implemented by an end effector, components thereof, and/or various other components of a robotic system of the type discussed above with reference to FIGS. 3-31 to unload objects from a shipping unit (e.g., a shipping container, truck, and/or the like). Further, the process can be implemented, at least partially, using an end effector of the type discussed above with reference to FIGS. 32A-36E.

The process begins at block 3702 by identifying an object to be engaged. The identification process at block 3702 can be generally similar to (or identical to) one or more portions of the process discussed above with reference to FIG. 18. For example, the identification process can include detecting one or more target objects using sensors onboard the end effector and/or any other suitable sensors in the robotic system. Additionally, or alternatively, the identification process can include selecting one or more target objects previously detected using the sensors and/or otherwise known to the process (e.g., loaded from a map of target objects).

At block 3704, the process includes positioning the end effector adjacent to the identified object. In various embodiments, positioning the end effector can include moving and/or actuating chassis, a first segment, and/or distal joint of the robotic system. Once the end effector is positioned adjacent to the identified object (e.g., as illustrated in FIG. 33A), the identified object is distal to a distalmost end of the end effector.

At block 3706, the process includes actuating a gripping assembly in the end effector distally to position one or more gripping elements in the gripping assembly in contact with the identified object (e.g., as illustrated in FIG. 33B). As discussed above, actuating the gripping assembly can include actuating a drive component of the gripping assembly using a belt-and-pulley system, a gear-and-track system, driving one or more carts along a track, operating one or more expandable components (e.g., pistons, telescoping elements, and/or the like), and/or the like.

At block 3708, the process includes operating the one or more elements to engage the identified object (e.g., as illustrated in FIGS. 33C and 36A). In various embodiments, as discussed above, the gripping elements can include a vacuum component (sometimes also referred to herein as a suction component), a magnetic component, a mechanical gripper component, and/or the like that are operated by delivering a drive force and/or a drive signal (e.g., a vacuum force, electrical power, command signals, and/or the like) to the gripping elements through connections in the gripping assembly.

At block 3710, the process includes at least partially lifting the identified object (e.g., as illustrated in FIGS. 33D and 36C). The lifting can be accomplished, for example via the extendible component 3252 of FIG. 32A, the pivotable link 3530 of FIG. 35, and/or the like. Further, as discussed above, the lifting process can reduce friction between the identified object and an underlying object and/or pick up the identified object completely to avoid (or reduce) disturbance to the underlying object while retrieving the identified object. In some embodiments, the process does not need to lift the identified object (e.g., when pulling the object proximally off a shelf). In such embodiments, the process can omit block 3710 and instead actuate one or more components in the gripping assembly (e.g., the extendible component 3252 of FIG. 32A, the pivotable link 3530 of FIG. 35, and/or the like) at block 3706 to raise the gripping elements before engaging the identified object.

At block 3712, the process includes actuating the gripping assembly proximally to position the gripping elements above at least a first portion of a conveyor (e.g., frame conveyors) in the end effector (e.g., as illustrated in FIGS. 33E and 36D). In some embodiments, the process can implement block 3710 and block 3712 generally simultaneously to at least partially lift the identified object while also actuating the gripping assembly proximally. As the gripping assembly moves proximally, the gripping assembly pulls the identified object onto an upper surface of the end effector, where one or more conveyors can then move the identified object proximally toward the movable base of the robotic system.

At block 3714, the process includes operating the gripping elements to disengage the identified object. As discussed above, in various embodiments, disengaging the identified object can include cutting off a drive force (e.g., stop delivering a vacuum force, stop delivering power and/or another electric drive signal, and/or the like) and/or delivering various other control signals. In some embodiments, disengaging the identified object can include delivering a disengaging force (e.g., a burst of air, argon gas, and/or another suitable fluid to overcome a vacuum pressure between the gripping elements and the identified object). Once disengaged, the identified object is fully placed onto the conveyors of the end effector. Further, as discussed above, disengaging the identified object can include moving the gripping assembly proximally more quickly than the conveyors of the end effector move the identified object. The movement can help create separation between the gripping assembly and the identified object that, for example, can provide space for the gripping element to be actuated into a lowered position.

At block 3716, the process includes actuating the gripping assembly to position the gripping elements below at least a second portion of the conveyors (e.g., as illustrated in FIGS. 33F and 36E). Similar to the lifting discussed above, the actuation can be accomplished, for example, via the extendible component 3252 of FIG. 32A, the pivotable link 3530 of FIG. 35, and/or the like. Further, in some embodiments, the actuation includes creating some separation between the gripping assembly and the identified object by moving the gripping assembly proximally more quickly than the conveyors move the identified object (e.g., when separation was not created at block 3714 and/or to increase the separation). Once beneath the second portion of the conveyors, the gripping assembly is positioned out of a proximal travel path along the conveyors. Subsequently, the process can include operating the conveyors to move the identified target object proximally toward the movable base of the robotic system.

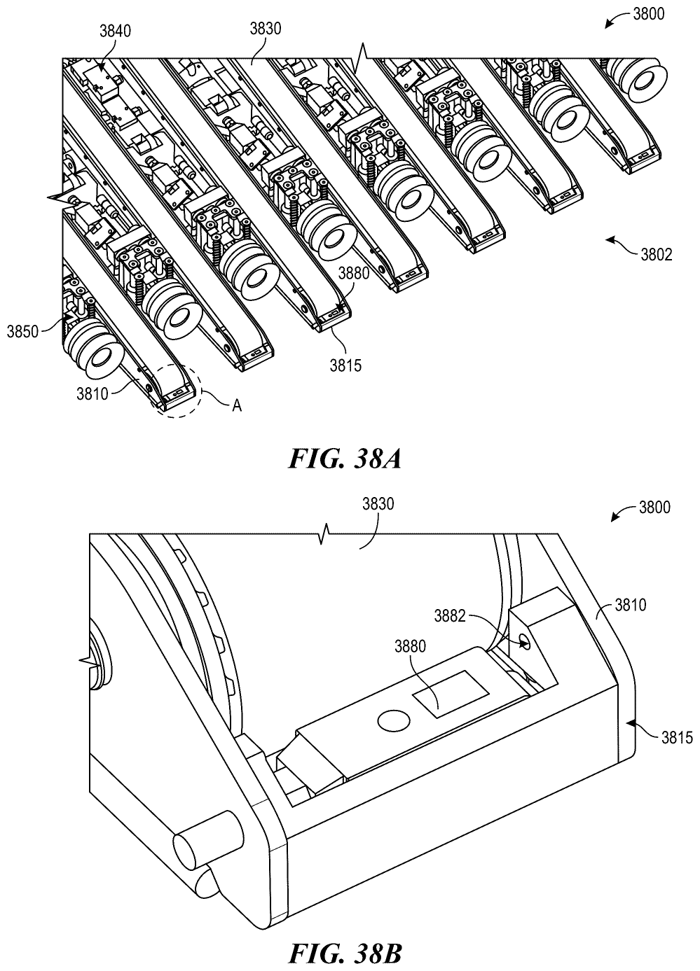

FIGS. 38A and 38B are partially schematic upper-side views illustrating additional features at a distal region 3802 of an end effector 3800 configured in accordance with some embodiments of the present technology. As best illustrated in FIG. 38A, the end effector 3800 can be generally similar to (or identical to) an end effector of the type discussed above with reference to any of FIGS. 32A-FIG. 36E. For example, in the illustrated embodiment, the end effector 3800 includes a frame 3810, a plurality of frame conveyors 3830, and a gripper component 3840 that includes a plurality of gripping assemblies 3850. Further, the end effector 3800 can include one or more sensors 3880 that are positioned to detect when the gripper component 3840 and/or an object engaged by the gripper component 3840 pass a predetermined position on the frame 3810 during a gripping operation. As discussed above, the predetermined position can be selected such that, beyond the predetermined position, the plurality of frame conveyors 3830 can carry and/or move the target object proximally. In some embodiments, the predetermined position accounts for a distance that the gripper component 3840 (and the target object engaged thereby) will travel before the gripper component 3840 can disengage the target object in response to signals from the sensors 3880. In the embodiment illustrated in FIG. 38A, the sensors 3880 are carried by a distalmost portion 3815 of the frame 3810. As a result, the end effector 3800 can rely on lag in the disengagement and/or momentum of the target object to ensure the target object is placed on the plurality of frame conveyors 3830.

FIG. 38B is a close-up view of a distalmost portion 3815 of the frame 3810 (e.g., a blown-up view of the circled region A). As illustrated in FIG. 38B, the sensors 3880 can include proximity sensors that detect when the target object crosses over the sensors 3880 and are thereby positioned above at least a portion of the plurality of frame conveyors 3830. However, the proximity sensors (and other sensors that can be used) can be sensitive to dust, dirt, and/or other contaminants. To help reduce interference with the sensors 3880, the end effector 3800 can include one or more outlet nozzles 3882 directed across the sensors 3880. The outlet nozzles 3882 can direct air (and/or any other suitable fluid) across the sensors 3880 periodically to help keep the proximity sensors clear of dust, dirt, and/or other contaminants. In some embodiments, the outlet nozzles 3882 can be fluidly couplable to the connections in the gripping assembly (e.g., the connections 3560 discussed above with reference to FIG. 35). In some such embodiments, the burst of air (and/or any other suitable fluid) used to disengage the gripping elements from the target object can be partially directed to the outlet nozzles 3882. As a result, the outlet nozzles 3882 can direct the portion of the burst across the sensors 3880 after each cycle through a gripping operation.

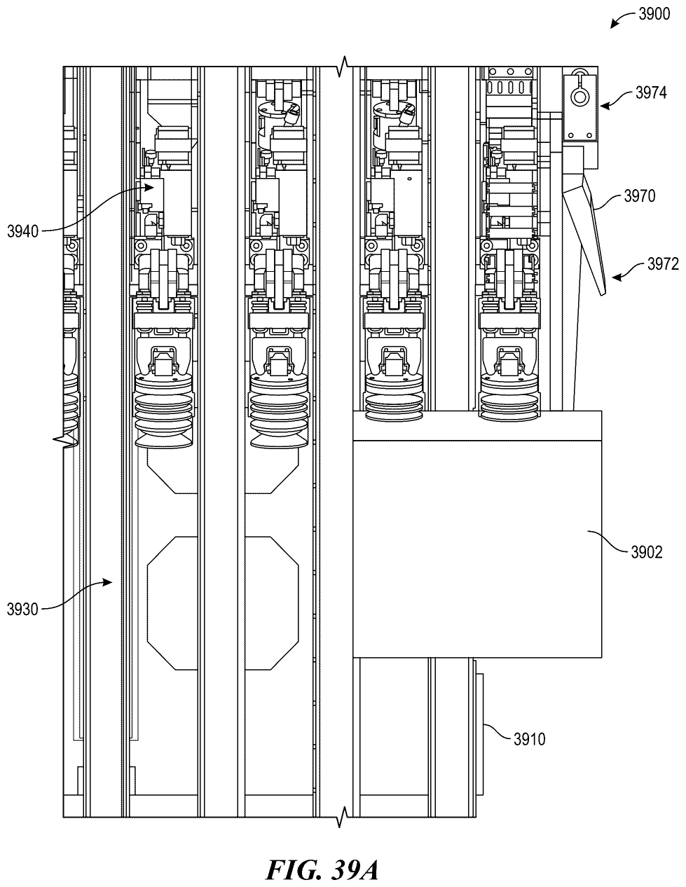

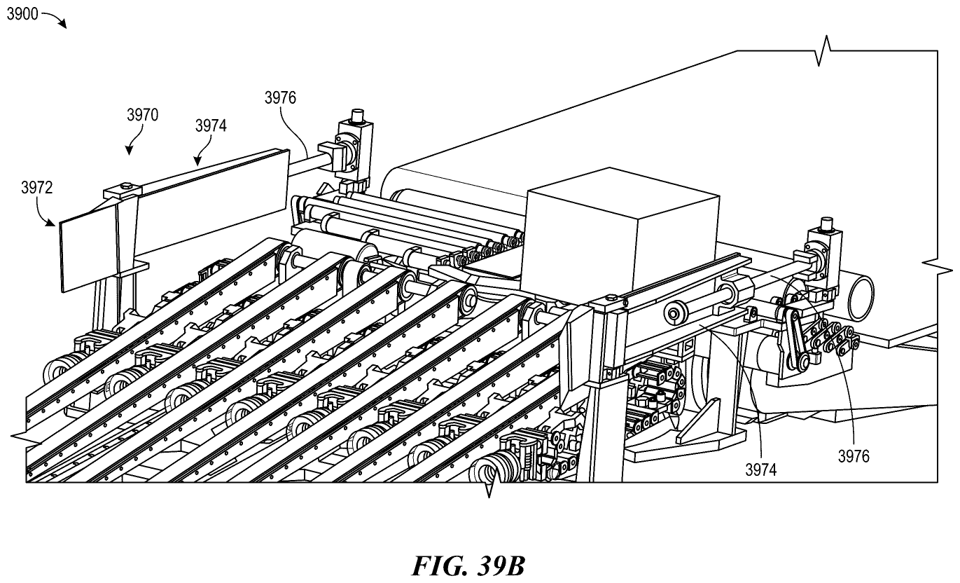

FIGS. 39A and 39B are partially schematic top and upper-side views, respectively, of an end effector 3900 configured in accordance with some embodiments of the present technology. In the illustrated embodiments, the end effector 3900 can be generally similar to (or identical to) any of the end effectors discussed above with reference to FIGS. 32A-36E, 38A, and 38B. For example, as illustrated in FIG. 39A, the end effector 3900 can include a frame 3910, a plurality of frame conveyors 3930, and a gripper component 3940. Further, similar to the end effector 3400 discussed above with reference to FIG. 34, the end effector 3900 can include one or more guide components 3970 positioned on lateral sides of the frame 3910.

As best illustrated in FIG. 39A, the guide components 3970 include an angled portion 3972 and a straight portion 3974. The angled portion 3972 slopes inward toward a central longitudinal axis of the end effector 3900. As a result, the angled portion 3972 can push (or otherwise force) a target object 3902 placed on a lateral side of the end effector 3900 toward the central longitudinal axis of the end effector 3900 as the plurality of frame conveyors 3930 move the target object 3902 proximally. The straight portion 3974 extends parallel to the longitudinal axis of the end effector 3900. As a result, the straight portion 3974 can act as a side rail along the remainder of the end effector 3900.

In some embodiments, as best illustrated in FIG. 39B, the straight portion 3974 can be movably coupled to a track 3976 (or another suitable component, such as a piston, telescoping component, and/or the like). The track 3976 allows the guide components 3970 to move distally and proximally along the longitudinal axis of the end effector 3900. As a result, for example, the guide components 3970 can adjust their position to maximize the object-guiding benefit of the guide components 3970 and/or to improve clearance around the end effector 3900. In a specific, non-limiting example, the guide components 3970 can be in a retracted (proximal) position while the end effector 3900 is positioned adjacent to one or more target objects to reduce the chance that the guide components 3970 catch on a surrounding environment during the motion. Once the end effector 3900 is in position, the guide components 3970 can be moved to an extended (distal) position to push target objects toward the central longitudinal axis of the end effector 3900 and/or help prevent them from falling off the lateral sides.

It will be understood that, although not explicitly discussed above with reference to FIGS. 31-39B, in some embodiments, the end effector can include a controller operably coupled to any of the components discussed herein. The controller can be communicably coupled to another controller (e.g., the processors 202 of FIG. 2 and/or any other suitable component) to help control the operation of any of the components of the end effector discussed above. Additionally, or alternatively, the controller can include a processor and a memory storing instructions that, when executed by the processor, cause the controller to implement any of the operations of the end effector discussed above.

### Example Distal Joints for the Robotic System

FIG. 40 is a partially schematic upper-side view of a distal joint 4010 for a robotic system 4000 configured in accordance with some embodiments of the present technology. As illustrated in FIG. 40, the robotic system 4000 includes between a first segment 4002 (e.g., sometimes also referred to herein as a “movable arm” and/or the like), the distal joint 4010 (sometimes also referred to herein as a “wrist joint,” a “second joint,” an “end effector joint,” and/or the like) operably coupled to the first segment 4002, and an end effector 4004 operably coupled to the distal joint 4010. It will be understood that the first segment 4002 can be generally similar to (or identical to) any of the first segments discussed above with reference to FIGS. 3-12F. Similarly, end effector 4004 can be generally similar to (or identical to) any of the end effectors discussed above with reference to FIGS. 32A-39.

As illustrated in FIG. 40, similar to the discussion above with reference to FIGS. 15 and 16, the distal joint 4010 allows the end effector 4004 to rotate with respect to the first segment 4002 along both the third axis A₃ and the fourth axis A₄. Said another way, the distal joint 4010 provides two degrees of freedom for the end effector 4004 relative to the first segment 4002. In turn, the degrees of freedom can allow the end effector 4004 (and the robotic system 4000 more broadly) to be positioned in a variety of suitable configurations. As a result, the robotic system 4000 can unload a variety of shipping units without external assistance (e.g., human or robotic assistance).

In the illustrated embodiment, the distal joint 4010 includes a first drive system 4020 that rotatably couples the distal joint 4010 to the first segment 4002. As discussed in more detail below, the first drive system 4020 can include various components that can rotate the distal joint 4010 (and the end effector 4004 coupled thereto) about the fourth axis A₄ with respect to the first segment 4002. For example, in the embodiment illustrated in FIG. 40, the first drive system 4020 (sometimes also referred to herein as a “first drive mechanism”) includes a pivotable link 4022 that helps support the weight of the distal joint 4010 and/or the end effector 4004 at a variety of angles with respect to the first segment 4002. In some embodiments, as discussed in more detail below, the first drive system 4020 can be operably coupled to the pivotable link 4022 to help drive the rotation of the distal joint 4010 about the fourth axis A₄. In the illustrated embodiment, the robotic system 4000 also includes a second drive system 4030 (shown schematically) that rotatably couples the distal joint 4010 to the end effector 4004. As discussed in more detail below, the second drive system 4030 can include a mechanism to rotate the end effector 4004 about the third axis A₃ with respect to the distal joint 4010. In a specific, non-limiting example discussed, the second drive system 4030 can include a rotary motion joint (sometimes also referred to herein as a rotary union) with a central passthrough for connections.

As further illustrated in FIG. 40, the distal joint 4010 can include a plurality of joint conveyors 4012 (e.g., rollers) that are positioned to receive a target object 4006 from the end effector 4004 and move the target object 4006 in a proximal direction (e.g., toward and/or onto the first segment 4002). The distal joint 4010 can also include one or more fixed support plates 4014 (one illustrated in FIG. 40) that help support the target object 4006 along the motion path, allow drive mechanisms (e.g., belts, servomotors, gears, and/or the like) to be coupled to the joint conveyors 4012, and/or help match the distal joint 4010 to one or more conveyors on the end effector 4004 (e.g., the plurality of joint conveyors 3220 of FIG. 32A, the plurality of joint conveyors 3420 of FIG. 34, and/or the like). Further, the distal joint 4010 can include one or more retractable elements 4044 (one illustrated in FIG. 40) that are operably coupled to a retraction system 4042. The retractable elements 4044 can include additional conveyors, passive rollers, support plates (and/or other low-friction elements), and/or the like. As discussed in more detail below with reference to FIGS. 42A-43C, the retraction system 4042 can raise (and lower) the retractable elements 4044 to fill gaps (and open space) between the distal joint 4010 and the end effector 4004 as the end effector 4004 rotates about the third axis A₃. For example, in various embodiments, the retraction system 4042 can include various telescoping components, pneumatic actuators, pistons, shape memory devices, scissor components, and/or the like. In the specific, non-limiting example illustrated in FIG. 40, the retraction system 4042 includes a stepped track that rotates along with the end effector 4004 to automatically raise (and lower) the retractable elements 4044 as the end effector 4004 rotates.

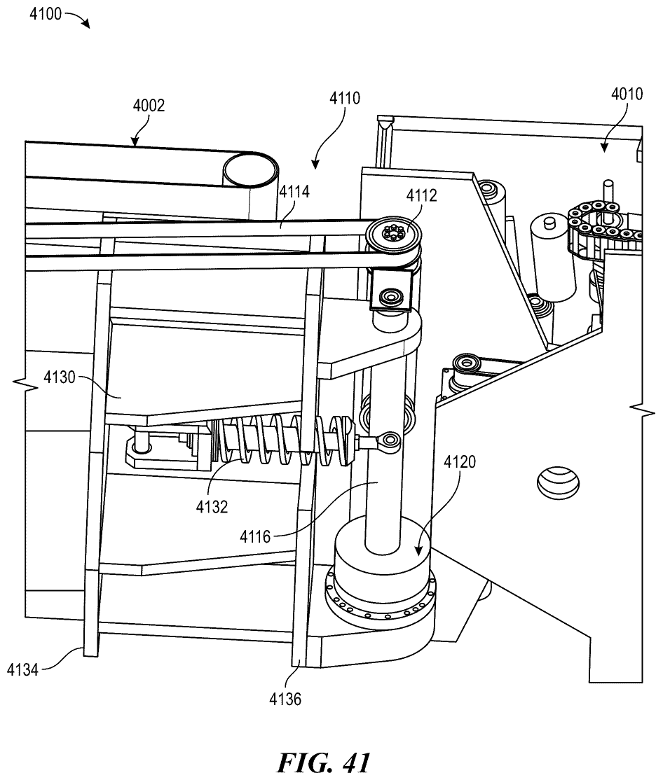

FIG. 41 is a partially schematic bottom view of a distal joint 4100 for a robotic system configured in accordance with some embodiments of the present technology. The distal joint 4100 can be generally similar (or identical) to the distal joint 4010 discussed above with reference to FIG. 40. For example, the distal joint 4100 can be operably coupled between a first segment 4002 and an end effector 4004. FIG. 41, however, illustrates additional details on a first drive mechanism 4110 in the distal joint 4100 to control rotation of the distal joint 4100 with respect to the first segment 4002 (e.g., along the fourth axis A₄ illustrated in FIG. 40). In the illustrated embodiment, the first drive mechanism 4110 includes a linking pulley 4112, a linking belt 4114 and a drive shaft 4116 each operably coupled to the linking pulley 4112, and a reducer system 4120 operably coupled to the drive shaft 4116. The linking belt 4114 extends from the linking pulley 4112 to a pulley at a proximal joint (e.g., to the actuators 336 discussed above with reference to FIG. 3) such that when the first segment 4002 rotates with respect to the proximal joint (e.g., rotates about the second axis A₂ of FIG. 3), the linking belt 4114 translates motion to the linking pulley 4112. In turn, the linking pulley 4112 can translate the motion into the drive shaft 4116, which translates the motion through the reducer system 4120.

The reducer system 4120 can include a pulley reducer and/or other breaking mechanism (e.g., resistive breaking mechanism) and/or an accelerating mechanism (e.g., a gear increase). As a result, the reducer system 4120 can help smooth and/or translate motion from the linking belt 4114 to the rotation of the distal joint 4100 such that rotation in the proximal joint (e.g., about the second axis A₂ of FIG. 3) is matched by rotation in the distal joint (e.g., about the fourth axis A₄ of FIGS. 3 and 40). The general match in the motion, in turn, helps maintain the end effector 4004 in a generally level configuration such that target objects engaged thereby can be moved by one or more conveyors in the end effector 4004 (e.g., to maintain a generally flat upper surface 3331 of the plurality of frame conveyors 3330 of FIG. 33D and/or to generally maintain a predetermined slope in the upper surface 3431 of the plurality of frame conveyors 3430 of FIG. 34).

In some embodiments, the reducer system 4120 includes one or more servomotors to help smooth the motion from the linking belt 4114 and/or to help translate the motion to various other components in the first drive mechanism 4110. In a specific, non-limiting example discussed in more detail below, the reducer system 4120 can translate the motion from the linking belt 4114 to a pivotable link of the type discussed above with reference to FIG. 40.

In the embodiment illustrated in FIG. 41, the distal joint 4100 also includes a floating joint 4130 operably coupled between the first drive mechanism 4110 and the first segment 4002. The floating joint 4130 includes a compression component 4132, a proximal reference 4134 coupled between the compression component 4132 and the first segment 4002, and a distal reference 4136 coupled between the compression component 4132 and the first drive mechanism 4110. The compression component 4132 can compress and/or expand in response to the rotation of the distal joint 4100 relative to the first segment 4002 (e.g., along the fourth axis A₄ of FIG. 40). As a result, the floating joint 4130 can help maintain a predetermined distance between the distal joint 4100 and the first segment 4002. As a result, the floating joint 4130 can help avoid interference between conveyors in the distal joint 4100 and the conveyors in the first segment 4002 and/or help avoid too large of a gap forming between the distal joint 4100 and the first segment 4002.

FIGS. 42A and 42B are partially schematic side views of a distal joint 4210 of a robotic system 4200 configured in accordance with further embodiments of the present technology. More specifically, FIGS. 42A and 42B illustrate additional details on a first drive system 4220 in the distal joint 4210 according to some embodiments of the present technology. In the illustrated embodiments, the distal joint 4210 is generally similar (or identical) to the distal joints 4010, 4100 discussed above with reference to FIGS. 40 and 41. For example, the distal joint 4210 can be operably coupled between a first segment 4202 and an end effector 4204.

Further, the first drive system 4220 is coupled between the distal joint 4210 and the first segment 4202. As illustrated in FIGS. 42A and 42B, the first drive system 4220 can include a reducer system 4222 carried by the distal joint 4210, as well as a pivotable link 4224 and an expandable component 4226 each coupled between the distal joint 4210 and the first segment 4202. As discussed above, the reducer system 4222 can help translate rotation in a proximal joint of the robotic system to an opposite rotation in the distal joint 4210. More specifically, the reducer system 4222 can drive rotation in the pivotable link 4224, thereby causing the distal joint 4210 to rotate about the fourth axis A₄ with respect to the first segment 4202. For example, FIG. 42A illustrates the robotic system 4200 in a lowered configuration while FIG. 42B illustrates the robotic system 4200 in a raised configuration. To move between the lowered configuration and the raised configuration, the reducer system 4222 can drive the pivotable link 4224 clockwise around the fourth axis A₄, thereby also rotating the distal joint 4210 with respect to the first segment 4202. As further illustrated in FIG. 42A, the fourth axis A₄ can be generally orthogonal to a longitudinal plane of the end effector 4204 (e.g., the third plane P₃). Additionally, or alternatively, the fourth axis A₄ can be generally orthogonal to a transverse plane of the end effector 4204 (e.g., the fourth plane P₄ illustrated in FIG. 42A).

In some embodiments, the expandable component 4226 can help drive the rotation of the pivotable link 4224 and/or the distal joint 4210. For example, the expandable component 4226 can be coupled to a controller to expand and/or contract in response to signals from the controller, thereby causing the distal joint 4210 (and the pivotable link 4224) to rotate about the fourth axis A₄. Additionally, or alternatively, the expandable component 4226 can help stabilize the rotation of the distal joint 4210 and/or help support the distal joint 4210 and/or the end effector 4204 during operation. For example, because the expandable component 4226 is coupled between the distal joint 4210 and the first segment 4202, the expandable component 4226 provides an additional anchor therebetween. The additional support can be useful, for example, to help reduce noise at the end effector 4204 while target objects of varying weights are engaged and loaded onto the end effector 4204. One result, for example, is that the end effector 4204 and/or the distal joint 4210 can drop fewer objects as a result of noise during operation and/or movement between configurations.

FIGS. 43A-43C are partially schematic top views of a distal joint 4310 for a robotic system 4300 configured in accordance with some embodiments of the present technology. As illustrated in FIG. 43A, the distal joint 4310 can be generally similar (or identical) to the distal joints discussed above with reference to FIGS. 40-42B. For example, the distal joint 4310 can be operably coupled between a first segment 4302 and an end effector 4304 of the robotic system 4300. Further, the distal joint 4310 includes a second drive system 4330 that helps control a rotation of the end effector 4304 about the third axis A₃ with respect to the distal joint 4310. As illustrated in FIG. 43A, the third axis A₃ can be generally orthogonal to the transverse plane of the end effector 4204 (e.g., the fourth plane P₄).

As further illustrated in FIG. 43A, the distal joint 4310 can include features that help bridge gaps between the distal joint 4310 and the end effector 4304 as the end effector 4304 rotates. For example, FIG. 43A illustrates the robotic system 4300 with the distal joint 4310 and the end effector 4304 in an aligned (e.g., non-rotated) configuration. In this state, there is not a significant gap between one or more first conveyors 4312 (e.g., rollers and/or the like) in the distal joint 4310 and one or more second conveyors 4305 in the end effector 4304 (e.g., the frame conveyors and/or joint conveyors discussed above with reference to FIGS. 32A and 34, such as conveyor belts, one or more rollers, and/or the like). As a result, the second conveyors 4305 can transfer target objects to the first conveyors 4312 without additional support. Accordingly, a first retractable system 4313 and a second retractable system 4316 can be in a retracted and/or lowered position beneath the one or more first conveyors 4312 (sometimes referred to herein as “lowered position,” a “standby position,” a “retracted position,” and/or the like).

As illustrated in FIG. 43B, as the end effector 4304 rotates counterclockwise along the third axis A₃ with respect to the distal joint 4310, the first conveyors 4312 move away from the second conveyors 4305, thereby forming a gap that may be too big for the target objects to traverse without additional support. Accordingly, as the end effector 4304 rotates counterclockwise, the first retractable system 4313 can transition (e.g., raise) into an extended and/or raised position to provide additional support (sometimes referred to herein as “raised position,” a “convey position,” an “active position,” and/or the like). In the illustrated embodiment, the first retractable system 4313 includes a first retractable conveyor 4314 and a first retractable support surface 4315. The first retractable conveyor 4314 can be a roller (passive or drive) and/or any other suitable conveyor. The first retractable support surface 4315 can be any surface that allows the target objects to continue to move (e.g., slide) in a proximal direction, such as a low-friction plastic and/or metal surface.

Similarly, as illustrated in FIG. 43C, as the end effector 4304 rotates clockwise along the third axis A₃ with respect to the distal joint 4310, the first conveyors 4312 move away from the second conveyors 4305, thereby forming a gap on the opposite transverse side of the of the distal joint 4310. Accordingly, as the end effector 4304 rotates clockwise, the second retractable system 4316 can transition (e.g., raise) into an extended and/or raised position to provide additional support. Similar to the first retractable system 4313, the second retractable system 4316 can include a second retractable conveyor 4317 and a second retractable support surface 4318. The second retractable conveyor 4317 can be a roller (passive or drive) and/or any other suitable conveyor. The second retractable support surface 4318 can be any surface that allows the target objects to continue to move (e.g., slide) in a proximal direction, such as a low-friction plastic and/or metal surface.

As further illustrated in FIGS. 43A-43C, the rotation of the end effector 4304 with about the third axis A₃ (respect to the distal joint 4310) changes an angle of the first and second conveyors 4312, 4305 with respect to each other. For example, in FIG. 43A, the first and second conveyors 4312, 4305 are positioned to convey (e.g., move) a target object in the same direction. However, in FIGS. 43B and 43C, the first conveyors 4312 are positioned to convey the target object in a first direction while the second conveyors 4305 are positioned to convey the target object in a second direction that is at an angle to the first direction. Said another way, the conveyors in the distal joint 4310 are configured to alter the direction of conveyance to account for the rotation of the end effector 4304 about the third axis A₃.

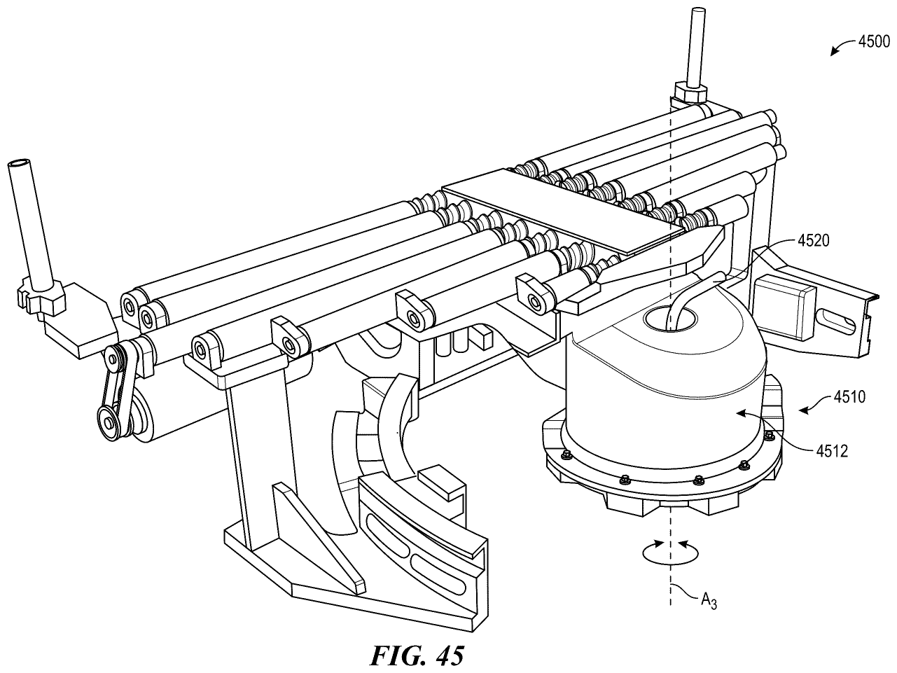

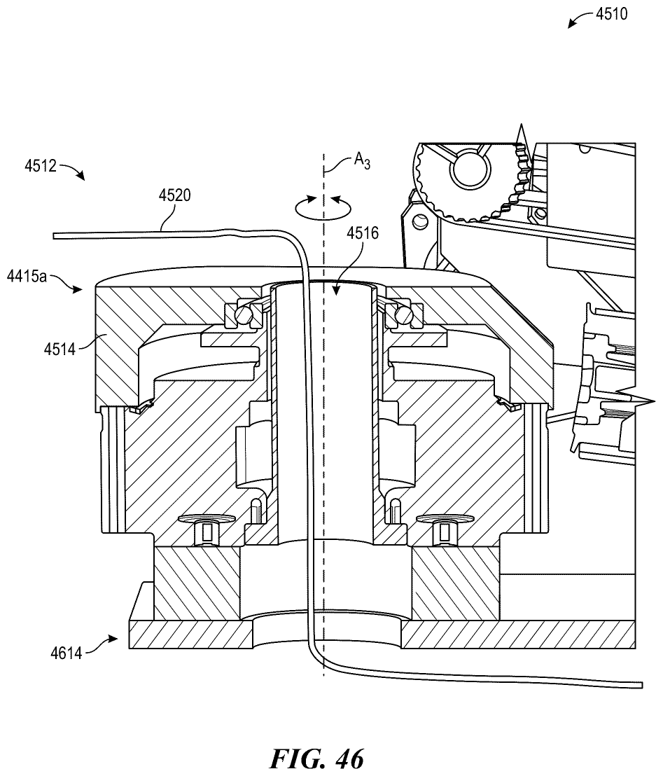

FIG. 43D is a partially schematic bottom view of the distal joint 4310 of FIGS. 43A-43C in accordance with some embodiments of the present technology. More specifically, FIG. 43D illustrates additional details on the second drive system 4330 in the distal joint 4310. For example, in the illustrated embodiment, the second drive system 4330 includes a rotary motion joint 4332 (sometimes also referred to herein as a rotary union) that includes shaft 4334, one or more bearings 4336 (shown schematically in FIG. 43D), a housing 4338, and a retaining component 4340. The shaft 4334 is coupled to a frame 4311 of the distal joint 4310 while the housing 4338 is coupled to the end effector 4304. The bearings 4336 are coupled between the shaft 4334 and the housing 4338, thereby allowing the housing 4338 (and the end effector 4304) to rotate with respect to the frame 4311 (and the distal joint 4310). The retaining component 4340 is coupled to a distal end of the frame 4311 to help keep the second drive system 4330 together. In the illustrated embodiment, the rotary motion joint 4332 also includes a central opening 4342. As discussed in more detail below with reference to FIGS. 45 and 46, the central opening 4342 can allow one or more connections to pass from the distal joint 4310 to the end effector 4304 without risking being pinched, snagged, and/or otherwise caught during the rotations.

In some embodiments, the bearings 4336 are electronic bearings that can control a rotation of the housing 4338 (and the end effector 4304) with respect to the frame 4311 (and the distal joint 4310). In some embodiments, the bearings 4336 are passive and the second drive system 4330 includes one or more expandable components (e.g., pistons, telescoping components, and/or the like) coupled to transverse sides of the end effector 4304 and the distal joint 4310 to control rotation about the bearings 4336. Additionally, or alternatively, the housing 4338 can be coupled to a belt (or other suitable component, such as a gear track) carried by the distal joint 4310 to drive rotation about the bearings 4336. Additionally, or alternatively, the housing 4338 can include a cart and/or other drive mechanism to drive rotation with respect to the shaft 4334.

As further illustrated in FIG. 43D, and as introduced above, the end effector 4304 can include a drive mechanism 4306 that is operably coupled to each of the second conveyors 4305 (FIG. 43A). For example, in the illustrated embodiment, the drive mechanism 4306 includes a servomotor 4307 that is coupled to each of the second conveyors 4305 (FIG. 43A) through a series of common shafts and belts. Because the drive mechanism 4306 drives each of the second conveyors 4305 (FIG. 43A) at the same time, the robotic system 4300 can create generally uniform motion in the second conveyors 4305 (FIG. 43A) without synchronizing multiple drive components (e.g., multiple servomotors). As a result of the generally uniform motion, as discussed above, the end effector 4304 can transport target objects without rotating them and/or driving the target objects toward transverse sides of the end effector 4304.

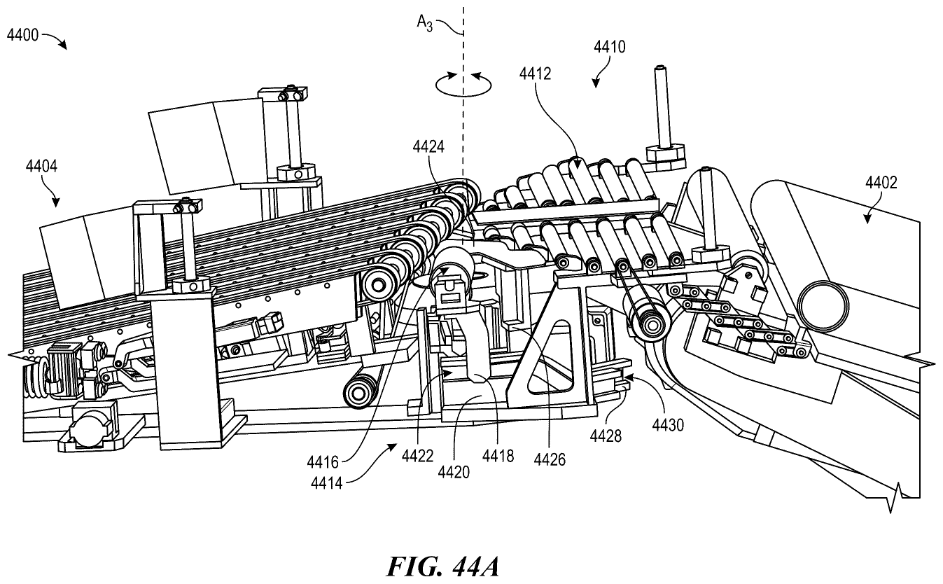

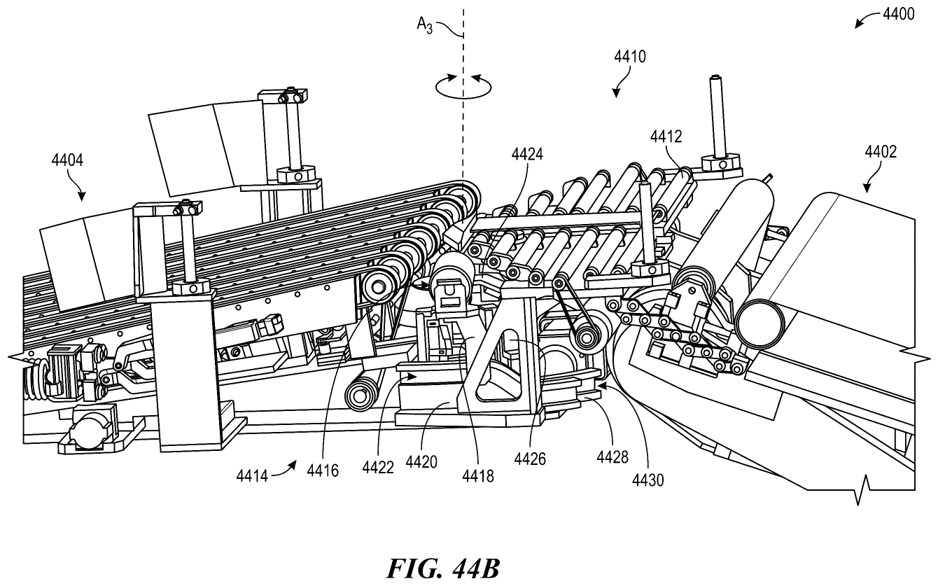

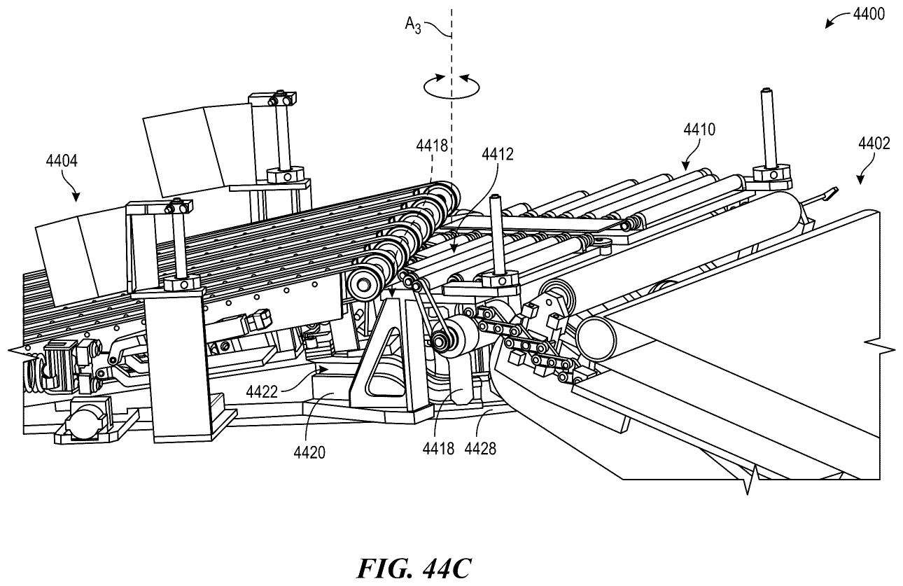

FIGS. 44A-44C are partially schematic side views of a distal joint 4410 of the type illustrated in FIGS. 43A-43D configured in accordance with some embodiments of the present technology. For example, as illustrated in FIG. 44A, the distal joint 4410 is operably coupled between a first segment 4402 and an end effector 4404 of a robotic system 4400. Further, the distal joint 4410 includes a plurality of first conveyors 4412 (e.g., rollers) and a retractable system 4414. As discussed above, the retractable system 4414 is movable between a raised position (e.g., as illustrated in FIG. 44A) and a lowered position (e.g., as illustrated in FIG. 44C). In the raised position, the retractable system 4414 can help fill a gap between the distal joint 4410 and the end effector 4404 to help support target objects moving in the proximal direction. In the lowered position, the retractable system 4414 is positioned beneath the first conveyors 4412, allowing the first conveyors 4412 to be positioned adjacent to the end effector 4404.

In the embodiments illustrated in FIGS. 44A-44C, the retractable system 4414 can automatically move between the raised position and the lowered position as the end effector 4404 rotates about the third axis A₃. For example, as illustrated in FIGS. 44A-44C, the retractable system 4414 can include a first retractable component 4416 that is carried by a first arm 4418, as well as a first guide component 4420 that is carried by the end effector 4404. The first guide component 4420 includes a first track 4422 that has a sloped step. The first arm 4418 is slidably coupled to the first track 4422. The first guide component 4420 is coupled to the end effector 4404 such that the first guide component 4420 rotates when the end effector 4404 rotates. In contrast, the first arm 4418 is coupled to the distal joint 4410 such that the first arm 4418 does not rotate. Instead, the first arm 4418 slides along the first track 4422. As a result, the first arm 4418 can slide down (or up) the step in the first track 4422 as the end effector 4404 rotates, thereby causing the first retractable component 4416 to move from the raised position (FIG. 44A) to the lowered position (FIG. 44C) and/or vice versa.

As further illustrated in FIGS. 44A-44C, the retractable system 4414 can also include a second retractable component 4424 that is carried by a second arm 4426, as well as a second guide component 4428 that is carried by the end effector 4404. Similar to the discussion above, the second arm 4426 is coupled to the distal joint 4410 while the second guide component 4428 is carried by the end effector 4404. Further, the second guide component 4428 includes a second track 4430 that has a sloped step and the second arm 4426 is slidably coupled to the second track 4430. As a result, similar to the discussion above, the second arm 4426 can slide down (or up) the step in the second track 4430 as the end effector 4404 rotates, thereby causing the second retractable component 4424 to move from the raised position (FIG. 44A) to the lowered position (FIG. 44C) and/or vice versa.

As best illustrated in FIG. 44B, the retractable system 4414 can raise and/or lower the first and second retractable components 4416, 4424 at separate times. For example, in the illustrated embodiments, the second guide component 4428 is rotated about the third axis A₃ with respect to the first guide component 4420 such that the step in the second track 4430 is offset around the third axis A₃ from the step in the first track 4422. As a result, as the end effector 4404 rotates, the second arm 4426 reaches the step in the second track 4430 before the first arm 4418 reaches the step in the first track 4422. Accordingly, as illustrated in FIG. 44B, the second retractable component 4424 is lowered before the first retractable component 4416.

In the embodiments illustrated in FIGS. 44A-44C, the first retractable component 4416 includes a roller (e.g., an active conveyor and/or a passive roller) and the second retractable component 4424 includes a low friction support surface. In various other embodiments, however, the retractable system 4414 can include various other elements. Purely by way of example, both of the first and second retractable components 4416, 4424 can include a roller. In another example, both of the first and second retractable components 4416, 4424 can include a low friction support surface. In yet another example, either of the first and second retractable components 4416, 4424 can include any other suitable component (e.g., another conveyor and/or the like). Further, in various other embodiments, the retractable system 4414 can include any other suitable number of retractable components (e.g., one, three, four, five, and/or any other suitable number of retractable components) to help fill the gap between the end effector 4404 and the distal joint 4410 as the end effector 4404 rotates.

Still further, it will be understood that the retractable system 4414 can include other suitable systems to raise and/or lower the retractable components. Purely by way of example, the retractable system 4414 can include one or more drivable pistons, telescoping elements, scissor elements, and/or the like that are actuatable to raise and/or lower the retractable components. In some such embodiments, the retractable system 4414 is controllable independent from the end effector 4404, thereby requiring the retractable system 4414 to be actuated in addition to rotating the end effector 4404 to help fill the gaps.

FIGS. 45 and 46 are a partially schematic upper-side view and a partially schematic cross-sectional view, respectively, of a distal joint 4500 of the type illustrated in FIGS. 40-43C in accordance with some embodiments of the present technology. As best illustrated in FIG. 45, the distal joint 4500 includes a drive system 4510 that can control rotation of an end effector about the third axis A₃. The drive system 4510 can be generally similar to the second drive system 4330 discussed above with reference to FIG. 43D. For example, in the illustrated embodiment, the drive system 4510 includes a rotary motion joint 4512 that allows one or more connections 4520 to pass through the distal joint 4500 to the end effector without needing to rotate and/or with minimal risk of catching as the end effector rotates.

For example, as best illustrated in FIG. 46, the rotary motion joint 4512 includes a shaft 4514 that has an opening 4516 extending from an upper end 4415a of the shaft 4514 to a lower end 4415b. The opening 4516 allows the connections 4520 to be routed through a central portion of the drive system 4510. Because the end effector rotates around the distal joint 4500 via the drive system 4510, the connections 4520 are routed through a center of the rotational motion. As a result, the connections do not require slack to accommodate the rotational motion that may otherwise be catchable during the end effector's motion and/or without a more complicated system to route the connections 4520 through the distal joint 4500.

### Additional Examples of the Drive Component in the End Effector

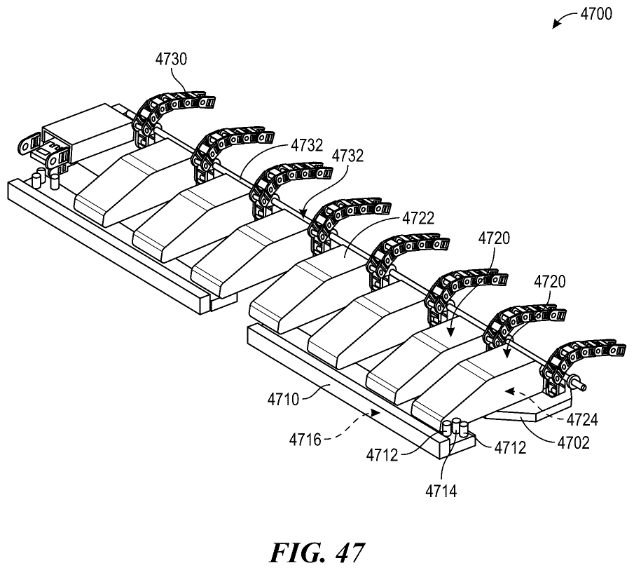

FIG. 47 is a partially schematic isometric view of a drive component 4700 configured in accordance with some embodiments of the present technology. The drive component 4700 illustrated in FIG. 47 can be integrated with any of the gripping components in the end effectors discussed above with reference to FIGS. 31-39B to help control the position of one or more gripping elements. In the illustrated embodiment, the drive component 4700 includes a frame 4702, an input and output (“I/O”) board 4710 coupled to the frame 4702, and one or more grip-generation units 4720 (eight illustrated in FIG. 47) coupled to the I/O board 4710. The I/O board 4710 includes a plurality of input nodes 4712 (one labeled in FIG. 47), a plurality of output nodes 4714 (one labeled in FIG. 47), and a redistribution network 4716 internal to the I/O board 4710. The I/O board 4710 (sometimes also referred to herein as a “branching component,” a “branching board,” and/or the like) can route inputs (e.g., electrical signals, pneumatic pressure, vacuum pressure, and/or the like) from another component in a robotic system (e.g., the robotic system 300 of FIG. 3) to the grip-generation units 4720. The grip-generation units 4720 can then use the inputs to provide a drive force (e.g., a vacuum force, magnetic force, actuation force, and/or the like) to each of the gripping elements in the gripping component.

In the embodiments illustrated in FIG. 47, for example, the redistribution network 4716 is an electronic redistribution network that can route input signals from the input nodes 4712 to one or more of the grip-generation units 4720 through the output nodes 4714. In turn, electronics 4724 within the grip-generation units 4720 that received the input signals can generate the drive force and provide the drive force to an individual and/or corresponding gripping elements in the gripping component. In this example, the drive force (e.g., vacuum pressure, magnetic force, actuation force, and/or the like) is generated locally in the drive component 4700, and therefore fully within the end effector. As a result, for example, the connections arriving at the input nodes 4712 can be only electrical connections, rather than, for example, vacuum tubes and/or the like. In turn, the connections can be relatively easy to manage because the electrical connections are not as sensitive to bends, kinks, reductions in slack, coiling, and/or the like.

Additionally, or alternatively, the local generation of the drive force in the electronics 4724 (e.g., at the scale of individual gripping elements) can reduce the magnitude of the drive force communicated via any communication line. For example, when a vacuum force is generated proximal to the end effector, the connections leading to the I/O board 4710 must communicate a vacuum force with sufficient magnitude to be divided among each of the gripping elements that will engage the target object. Further, that force must be routed through a distal joint with multiple degrees of freedom in rotation. In contrast, the local generation in the electronics 4724 allows the vacuum force to have a fraction of the magnitude and avoid a long route line.

As further illustrated in FIG. 47, the electronics 4724 in each of the grip-generation units 4720 can be at least partially contained within a housing 4722. The housing 4722 can help limit the amount of dust and other contaminants that reach the electronics 4724. Additionally, or alternatively, the housing 4722 can help protect the electronics 4724 from impacts (e.g., from target objects, an environment around the end effector during operation, other objects, and/or the like).

FIG. 47 also illustrates additional details on how the drive component 4700 helps actuate the gripping assemblies in the gripping component (see, e.g., FIGS. 32A and 34). For example, in the illustrated embodiment, the drive component 4700 includes a plurality of belts 4730 operably coupled to a single, shared drive shaft 4732. Each of the belts 4730 can be coupled to a suitable mechanism in the gripping assemblies to control actuation between a raised position and a lowered position (e.g., to rotate the pivotable link 3530 of FIG. 35). Because each of the belts 4730 is coupled to the drive shaft 4732, the drive component 4700 can control the actuation of each of the gripping assemblies at once, thereby keeping the gripping assemblies in sync as they lift a target object. Further, each of the gripping assemblies can be coupled to the frame 4702 of the drive component 4700 to simultaneously control a longitudinal position of each of the gripping assemblies.

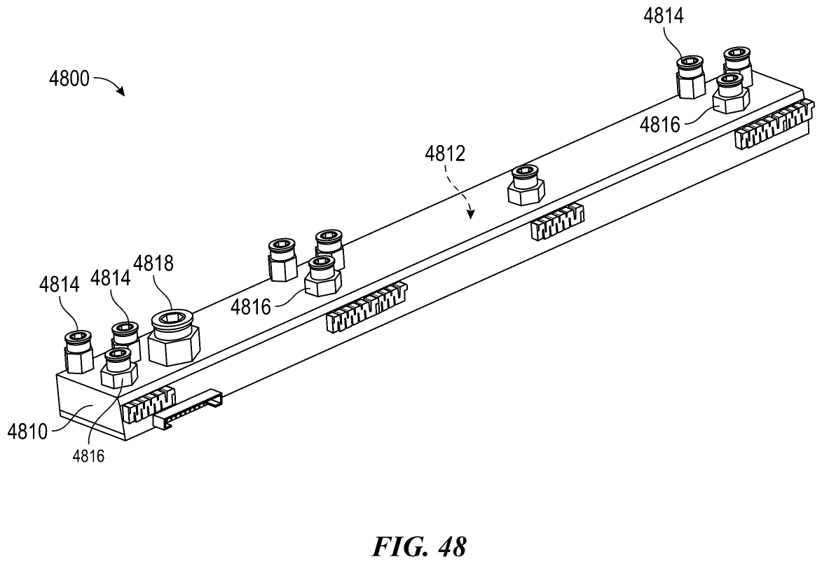

FIG. 48 is a partially schematic isometric view of a branching component 4800 of a drive component configured in accordance with some embodiments of the present technology. As illustrated in FIG. 48, the branching component 4800 can be generally similar to the I/O board 4710 discussed above with reference to FIG. 47. For example, in the illustrated embodiment, the branching component 4800 includes a housing 4810, a redistribution network 4812, a plurality of first input nodes 4814, and a plurality of output nodes 4816. Each of the plurality of first input nodes 4814 can receive and couple one or more connections to the redistribution network 4812. For example, each of the plurality of first input nodes 4814 can couple an electrical line (e.g., a power line, signal-routing line, and/or the like) to the redistribution network 4812. In turn, the redistribution network 4812 can route inputs (e.g., power, control signals, drive forces, and/or the like) to any (and/or all) of the plurality of output nodes 4816. In turn, the plurality of output nodes 4816 can be coupled to one or more connection lines in the drive component to, for example, couple the redistribution network 4812 to grip-generation units, gripping assemblies, and/or the like.

In some embodiments, the redistribution network 4812 can route inputs received at the plurality of first input nodes 4814 to a subset of the plurality of output nodes 4816. For example, first control signals received at the plurality of first input nodes 4814 can be routed to a first subset of the plurality of output nodes 4816 while second control signals received at the plurality of first input nodes 4814 can be routed to a second subset of the plurality of output nodes 4816. The first subset of the plurality of output nodes 4816 can then route the first control signals to a first subset of grip-generation units, gripping assemblies, and/or the like to grip a first target object. Similarly, the second subset of the plurality of output nodes 4816 can then route the second control signals to a second subset of grip-generation units, gripping assemblies, and/or the like to grip a second target object. As a result, for example, different subsets of grip-generation units and/or gripping assemblies can be operated to grip different target objects (e.g., to grip target objects of varying sizes and/or aligned with different subsets of an end effector).

As further illustrated in FIG. 48, the branching component 4800 can also include one or more second input nodes 4818 (one illustrated in FIG. 48). Similar to the plurality of first input nodes 4814, the second input node(s) 4818 can route couple one or more connections to the redistribution network 4812. However, as further illustrated in FIG. 48, the second input node(s) 4818 can have a different size and/or shape from the plurality of first input nodes 4814. As a result, the connections received at the second input node(s) 4818 can be different from the connections received at the plurality of first input nodes 4814. In a specific, non-limiting example, the plurality of first input nodes 4814 can receive connections related to the control and/or operation of various components in the gripping component while the second input node(s) 4818 receive connections that provide power for the components in the gripping component. In another specific, non-liming example, the plurality of first input nodes 4814 can receive connections related to the control and/or the plurality of gripping assemblies coupled to the drive component while the second input node(s) 4818 receive connections that are related to the control and/or operation of the drive component.

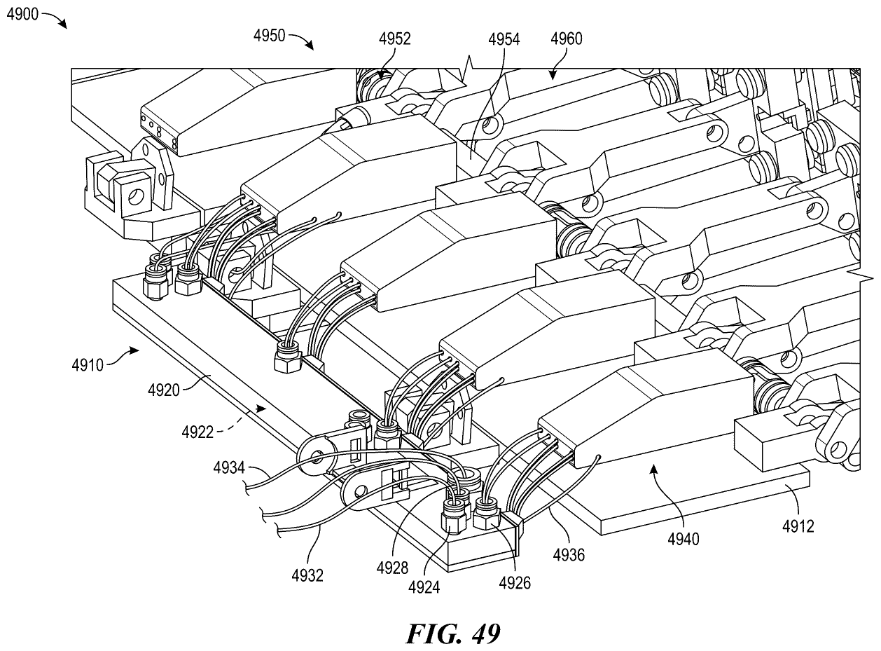

FIG. 49 is a partially schematic isometric view illustrating additional details on various components of a gripping component 4900 in accordance with some embodiments of the present technology. In the illustrated embodiment, the gripping component 4900 includes a drive component 4910, an assembly actuation component 4950 coupled to the drive component 4910, and a plurality of gripping assemblies 4960 coupled to the assembly actuation component 4950.

The drive component 4910 can be generally similar (or identical) to the drive component 4700 discussed above with reference to FIG. 47. For example, as illustrated in FIG. 49, the drive component 4910 can include a frame 4912, a branching component 4920 coupled to the frame 4912, and one or more grip-generation units 4940 (five illustrated in FIG. 49) coupled to the branching component 4920. As further illustrated in FIG. 49, the branching component 4920 can be generally similar (or identical) to the branching component 4800 discussed above with reference to FIG. 48. For example, the branching component 4920 can include a redistribution component 4922, a plurality of first input nodes 4924, a plurality of output nodes 4926 (one labeled in FIG. 47), and one or more second input nodes 4928.

Similar to the discussion above, the plurality of first input nodes 4924 can couple a plurality of first connections 4932 to the redistribution component 4922. In turn, the redistribution component 4922 can route inputs (e.g., power inputs, control inputs, force inputs, and/or the like) from the first connections 4932 to one or more of the plurality of output nodes 4926. The plurality of output nodes 4926 couple the redistribution component 4922 to a plurality of third connections 4936 that extend from the branching component 4920 to the grip-generation units 4940. More specifically, each of the plurality of third connections 4936 extend from a corresponding one of the plurality of output nodes 4926 to the grip-generation units 4940. As a result, the redistribution component 4922 can route the inputs (e.g., power inputs, control inputs, force inputs, and/or the like) to an appropriate destination during a gripping operation using the gripping component 4900. Each of the grip-generation units 4940 can then generate (or route) a drive force (e.g., a suction force, magnetic force, and/or any other suitable force) to a corresponding one of the plurality of gripping assemblies 4960.

Further, the second input nodes 4928 on the branching component 4920 can couple one or more second connections 4934 to the redistribution component 4922. As discussed above, inputs received via the second connections 4934 can be different from the inputs received from the plurality of first connections 4932. For example, the inputs received via the plurality of first connections 4932 can be related to controlling and/or powering the grip-generation units 4940 while inputs received via the second connections 4934 can be related to controlling and/or powering other components of the gripping component 4900 (e.g., the assembly actuation component 4950 and/or the plurality of gripping assemblies 4960).

As further illustrated in FIG. 49, the assembly actuation component 4950 can include one or more rotational drive mechanisms 4952 (e.g., a servo motor, a pulley and drive belt, a gear and track, and/or any other suitable mechanism) and a drive shaft 4954 coupled to the rotational drive mechanisms 4952. Further, each of the plurality of gripping assemblies 4960 can be operably coupled to the drive shaft 4954 (sometimes also referred to herein as a “common drive shaft,” a “shared drive shaft,” and/or the like). As a result, the drive shaft 4954 can help actuate each of the plurality of gripping assemblies 4960 simultaneously (or generally simultaneously) to help sync the motion of the gripping component 4900 during a gripping operation. In a specific, non-limiting example, the proximal end of a pivotable link of the type discussed above with reference to FIG. 35 can be coupled to the drive shaft 4954 to rotate between a first, lowered position and a second, raised position during the gripping operation. In another specific, non-limiting example, an expandable component of the type discussed above with reference to FIG. 32A can be operably coupled to drive shaft 4954 to raise and lower in response to the rotation of the drive shaft 4954.

### EXAMPLES

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples can be combined in any suitable manner, and placed into a respective independent example. The other examples can be presented in a similar manner.

A0. A robotic system, comprising:
a chassis;
a segment extending away from the chassis;
a first conveyor over the segment;
a gripper including:
   a second conveyor extending between the first conveyor and a distalmost portion of the gripper, and
   an interfacing element configured to move between (1) a retracted position located before the distalmost portion and at least partially below the second conveyor and (2) an extended position located beyond the distalmost portion and the second conveyor;
the first and second conveyors along with the interfacing element are configured to move an object between a proximal end of the robotic system and an object location beyond the distalmost portion of the robotic system.

A1. A robotic system, comprising:
a chassis;
a first leg and a second leg operatively coupled to the chassis to support the chassis,
   wherein:
   the first leg including a first wheel,
   the second leg including a second wheel,
   the first wheel and the second wheel are rotatable to move the chassis in a first translational degree of freedom, and
   the first leg and the second leg are configured to move in a vertical direction to move the chassis in a second translational degree of freedom perpendicular to the first translational degree of freedom;
a proximal conveyor;
a first segment including a first segment conveyor extending along a length of the first segment;
a first joint between the proximal conveyor and the first segment, wherein the first joint is configured to provide a first rotational degree of freedom between the first segment and the proximal conveyor;
a gripper including a distal conveyor extending along a length of the gripper; and
a second joint between the gripper and the first segment, wherein the second joint is configured to provide a second rotational degree of freedom between the first segment and the gripper, wherein:
   the distal conveyor, first segment conveyor, and proximal conveyor are configured to move an object from a distal end of the robotic system to a proximal end of the robotic system.

A2. The robotic system of A1 or a combination of portions thereof, wherein:
the first joint is configured to provide a third rotational degree of freedom between the first segment and the proximal conveyor, and
the second joint is configured to provide a fourth rotational degree of freedom between the first segment and the proximal conveyor.

A3. The robotic system of one or more examples above (e.g., A2) or a combination of portions thereof, wherein:
the first rotational degree of freedom and the second rotational degree of freedom are pitch degrees of freedom, and
the third rotational degree of freedom and the fourth rotational degree of freedom are yaw degrees of freedom.

A4. The robotic system of one or more examples above (e.g., A1) or a combination of portions thereof, wherein:
the first joint includes a first plurality of rollers configured to move the object from the first segment conveyor to the proximal conveyor, and
the second joint includes a second plurality of rollers configured to move the object from the distal conveyor to the first segment conveyor.

A5. The robotic system of one or more examples above (e.g., A1) or a combination of portions thereof, further comprising:
a third leg including a third wheel; and
a fourth leg including a fourth wheel, wherein the third leg and the fourth leg are configured to move in the vertical direction to move the chassis in the second translational degree of freedom.

A6. The robotic system of one or more examples above (e.g., A5) or a combination of portions thereof, wherein:
the first leg and the second leg are distal legs coupled to a distal portion of the chassis,
the third leg and the fourth leg are proximal legs coupled to a proximal portion of the chassis,
the first wheel and the second wheel are formed of a first material, and
the third wheel and the fourth wheel are formed of a second material different than the first material.

A7. The robotic system of one or more examples above (e.g., A5) or a combination of portions thereof, wherein the first leg, second leg, third leg, and fourth leg are configured to move in the vertical direction independently from one another, such that independent movement of the first leg, second leg, third leg, and fourth leg provides a pitch chassis rotational degree of freedom and a roll chassis rotational degree of freedom.

A8. The robotic system of one or more examples above (e.g., A1) or a combination of portions thereof, wherein the first leg and the second leg are rotatable relative to the chassis to move in the vertical direction.

A9. The robotic system of one or more examples above (e.g., A1) or a combination of portions thereof, wherein:

the first leg includes one or more first motors configured to drive the first wheel, and the second leg includes one or more second motors configured to drive the second wheel.

A10. The robotic system of one or more examples above (e.g., A1) or a combination of portions thereof, further comprising:
at least one vision sensor connected to the chassis and configured to obtain image information in a distal direction relative to the chassis; and
a local controller including a processor and memory, wherein the local controller is programmed to receive the image information from the at least one vision sensor.

A11. The robotic system of one or more examples above (e.g., A10) or a combination of portions thereof, wherein the local controller is configured to:
detect objects depicted in the image information received from the at least one vision sensor,
operate one or more first joint actuators to move the first segment in the first rotational degree of freedom,
operate one or more second joint actuators to move the gripper in the second rotational degree of freedom, and
control the distal conveyor, first segment conveyor, and proximal conveyor for accessing the detected objects and moving the detected objects in a proximal direction across the distal conveyor, first segment conveyor, and proximal conveyor.

A12. The robotic system of one or more examples above (e.g., A11) or a combination of portions thereof, wherein the local controller is programmed to:
operate a first leg actuator to move the first leg in the vertical direction to move the chassis in the second translational degree of freedom,
operate a second leg actuator to move the second leg in the vertical direction to move the chassis in the second translational degree of freedom,
operate a first wheel motor to rotate the first wheel to move the chassis in the first translational degree of freedom, and
operate a second wheel motor to rotate the second wheel to move the chassis in the first translational degree of freedom.

A13. The robotic system of one or more examples above (e.g., A10) or a combination of portions thereof, wherein the at least one vision sensor is positioned below the first segment.

A14. The robotic system of one or more examples above (e.g., A1) or a combination of portions thereof, wherein the chassis is configured to overlap and fit over at least a portion an existing warehouse conveyor while the existing warehouse conveyor extends and retracts in a third translational degree of freedom parallel to the first translational degree of freedom, and wherein proximal conveyor is configured to move an object in a proximal direction to the existing warehouse conveyor.

A15. The robotic system of one or more examples above (e.g., A14) or a combination of portions thereof, wherein the proximal conveyor is configured to be positioned above the existing warehouse conveyor such that the proximal conveyor moves the object onto the existing warehouse conveyor.

A16. The robotic system of one or more examples above (e.g., A14) or a combination of portions thereof, further comprising a chassis joint coupling a distal end portion of the existing warehouse conveyor to the chassis, wherein the chassis joint includes:
a warehouse conveyor mount configured to attach to the existing warehouse conveyor, and
a chassis mount configured to attach to the chassis, wherein the chassis mount is configured to slide relative to the warehouse conveyor mount in a direction parallel to the first translational degree of freedom.

A17. The robotic system of one or more examples above (e.g., A16) or a combination of portions thereof, wherein the chassis mount is further configured to slide relative to the warehouse conveyor mount in a vertical direction perpendicular to the first translational degree of freedom.

A18. The robotic system of one or more examples above (e.g., A17) or a combination of portions thereof, wherein the chassis mount further includes:
a first vertical shaft fixed to the chassis;
a first vertical coupler configured to slide on the first vertical shaft;
a second vertical shaft fixed to the chassis, wherein the second vertical shaft is apart spaced from the first vertical shaft; and
a second vertical coupler configured to slide on the second vertical shaft independently of the first vertical coupler sliding on the first vertical shaft.

A19. The robotic system of one or more examples above (e.g., A18) or a combination of portions thereof, wherein:
the first vertical coupler is configured to rotate about a first vertical coupler axis perpendicular to the first vertical shaft, and
the second vertical coupler is configured to rotate about a second vertical coupler axis perpendicular to the second vertical shaft.

A20. The robotic system of one or more examples above (e.g., A16) or a combination of portions thereof, wherein the chassis joint further includes a distance sensor configured to obtain distance information indicative of a relative position of the chassis mount and the warehouse conveyor mount.

A21. The robotic system of one or more examples above (e.g., A20) or a combination of portions thereof, further comprising:
a local controller including a processor and memory, wherein the local controller is configured to receive the distance information from the distance sensor;
a first wheel motor coupled to the first wheel and configured to drive the first wheel; and
a second wheel motor coupled to the second wheel and configured to drive the second wheel,
wherein the local controller is programmed to command the first wheel motor and the second wheel motor based on the distance information.

A22. The robotic system of one or more examples above (e.g., A1) or a combination of portions thereof, further comprising a power supply configured to connect to an external power source for providing electrical power that directly powers the robotic system.

B1. A method of operating a robotic system, the method comprising:
rotating a first wheel along a support surface and/or a second wheel along a support surface to adjust a position of a chassis of the robotic system in a first translational degree of freedom;
moving a first leg and/or a second leg in a vertical direction relative to a chassis to adjust the position of the chassis in a second translational degree of freedom different from the first translational degree of freedom, wherein the first wheel is coupled to the first leg, and wherein the second wheel is coupled to the second leg;
rotating a first segment in a first rotational degree of freedom about a first joint with respect to a proximal conveyor;
rotating a gripper in a second rotational degree of freedom about a second joint with respect to the first segment;
moving an object in a proximal direction along a distal conveyor disposed on the gripper to the first segment;
moving the object in the proximal direction along a first segment conveyor disposed on the first segment to the proximal conveyor; and
moving the object in the proximal direction along the proximal conveyor.

B2. The method of one or more examples above (e.g., B1 or a combination of
rotating the first segment in a third rotational degree of freedom about the first joint with respect to the proximal conveyor, and
rotating the gripper in a fourth rotational degree of freedom about the second joint with respect to the first segment.

B3. The method of one or more examples above (e.g., B2) or a combination of portions thereof, wherein:
the first rotational degree of freedom and the second rotational degree of freedom are pitch degrees of freedom, and
the third rotational degree of freedom and the fourth rotational degree of freedom are yaw degrees of freedom.

B4. The method of one or more examples above (e.g., B1) or a combination of portions thereof, further including:
rotating a first plurality of rollers of the first joint to move the object from the first segment conveyor to the proximal conveyor,
rotating a second plurality of rollers of the second joint to move the object from the distal conveyor to the first segment conveyor.

B5. The method of one or more examples above (e.g., B1) or a combination of portions thereof, further comprising:
moving a third leg and/or a fourth leg in a vertical direction relative to a chassis to adjust the position of the chassis in a second translational degree of freedom perpendicular to the first translational degree of freedom, wherein the third leg includes a third wheel and the fourth leg includes a fourth wheel.

B6. The method of one or more examples above (e.g., B5) or a combination of portions thereof, wherein:
the first leg and the second leg are distal legs coupled to a distal portion of the chassis,
the third leg and the fourth leg are proximal legs coupled to a proximal portion of the chassis,
the first wheel and the second wheel are formed of a first material, and
the third wheel and the fourth wheel are formed of a second material different than the first material.

B7. The method of one or more examples above (e.g., B5) or a combination of portions thereof, wherein moving the first leg, second leg, third leg, and/or fourth leg includes moving the first leg, second leg, third leg, and/or fourth leg in the vertical direction independently from one another, such that independent movement of the first leg, second leg, third leg, and/or fourth leg rotates the chassis in a pitch chassis rotational degree of freedom and/or a roll chassis rotational degree of freedom.

B8. The method of one or more examples above (e.g., B1) or a combination of portions thereof, wherein moving the first leg and/or the second leg includes rotating the first leg and/or the second leg relative to the chassis to move in the vertical direction.

B9. The method of one or more examples above (e.g., B1) or a combination of portions thereof, wherein:
rotating the first wheel includes driving the first wheel with a first motor coupled to the first wheel, and
rotating the second wheel includes driving the second wheel with a second motor coupled to the second wheel.

B10. The method of one or more examples above (e.g., B1) or a combination of portions thereof, further comprising obtaining, with at least one vision sensor connected to the chassis, image information in a distal direction relative to the chassis.

B11. The method of one or more examples above (e.g., B10) or a combination of portions thereof, further comprising:
detecting objects depicted in the image information received from the at least one vision sensor,
operating one or more first joint actuators to move the first segment in the first rotational degree of freedom,
operating one or more second joint actuators to move the gripper in the second rotational degree of freedom, and
controlling the distal conveyor, first segment conveyor, and proximal conveyor for accessing the detected objects and moving the detected objects in a proximal direction across the distal conveyor, first segment conveyor, and proximal conveyor.

B12. The method of one or more examples above (e.g., B10) or a combination of portions thereof, wherein the at least one vision sensor is positioned below the first segment.

B13. The method of one or more examples above (e.g., B1) or a combination of portions thereof, wherein the chassis is configured to overlap and fit over at least a portion of an existing warehouse conveyor, and wherein the method further comprises:
extending the existing warehouse conveyor in a third translational degree of freedom parallel to the first translational degree of freedom; and
moving the object in the proximal direction from the proximal conveyor to the existing warehouse conveyor.

B14. The method of one or more examples above (e.g., B13) or a combination of portions thereof, wherein a proximal portion of the proximal conveyor is positioned above the existing warehouse conveyor.

B15. The method of one or more examples above (e.g., B13) or a combination of portions thereof, wherein
the robotic system includes a chassis joint coupling a distal end portion of the existing warehouse conveyor to the chassis, wherein the chassis joint includes:
   a warehouse conveyor mount configured to attach to the existing warehouse conveyor, and
   a chassis mount configured to attach to the chassis; and
the method further includes sliding the chassis mount relative to the warehouse conveyor mount in a direction parallel to the first translational degree of freedom.

B16. The method of one or more examples above (e.g., B15) or a combination of portions thereof, further comprising sliding the chassis mount relative to the warehouse conveyor mount in a vertical direction perpendicular to the first translational degree of freedom.

B17. The method of one or more examples above (e.g., B16) or a combination of portions thereof, wherein the chassis mount further includes:
a first vertical shaft fixed to the chassis;
a first vertical coupler configured to slide on the first vertical shaft;
a second vertical shaft fixed to the chassis, wherein the second vertical shaft is spaced from the first vertical shaft; and
a second vertical coupler configured to slide on the second vertical shaft, wherein sliding the chassis mount relative to the warehouse conveyor mount in a vertical direction includes sliding the second vertical coupler on the second vertical shaft independently of the first vertical coupler on the first vertical shaft.

B18. The method of one or more examples above (e.g., B17) or a combination of portions thereof, further comprising:
rotating the first vertical coupler about a first vertical coupler axis perpendicular to the first vertical shaft, and
rotating the second vertical coupler about a second vertical coupler axis perpendicular to the second vertical shaft.

B19. The method of one or more examples above (e.g., B15) or a combination of portions thereof, further comprising obtaining distance information indicative of a relative position of the chassis mount and the warehouse conveyor mount with a distance sensor disposed on the chassis mount.

B20. The method of one or more examples above (e.g., B19) or a combination of portions thereof, further comprising:
commanding a first wheel motor coupled to the first wheel and configured to drive the first wheel along the support surface based on the distance information; and
commanding a second wheel motor coupled to the second wheel and configured to drive the second wheel along the support surface based on the distance information.

C1. A method of operating a robotic system, the method comprising:
rotating a first segment in a first rotational degree of freedom about a first joint with respect to a proximal conveyor to adjust a pitch angle of the first segment, wherein rotating the first segment in the first rotational degree of freedom moves a gripper disposed on a distal end of the first segment along a first arc;
rotating the first segment in a second rotational degree of freedom about the first joint with respect to the proximal conveyor to adjust a yaw angle of the first segment, wherein rotating the first segment in the second rotational degree of freedom moves the gripper in a second arc different from the first arc;
rotating a first wheel of a first leg and/or a second wheel of a second leg to adjust a position of the first segment in a first translational degree of freedom;
gripping an object with the gripper;
moving the object along a first segment conveyor disposed on the first segment to the proximal conveyor in a proximal direction; and
moving the object along the proximal conveyor in the proximal direction.

C2. The method of one or more examples above (e.g., C1) or a combination of portions thereof, further comprising
moving the gripper both linearly and arcuately to position the gripper to a target gripping position for griping the object.

C3. The method of one or more examples above (e.g., C1) or a combination of portions thereof, further comprising:
selecting the object; and
translating the first segment relative to the object while the gripper moves along the first arc and/or the second arc to move the gripper toward a target gripping position for gripping the object.

C4. The method of one or more examples above (e.g., C1) or a combination of portions thereof, further comprising:
determining a pick-up path for moving the gripper toward a target gripping position for gripping the object; and
reconfiguring the robotic system to move the gripper along the pick-up path while the gripper moves along the first arc and/or the second arc.

C5. The method of one or more examples above (e.g., C4) or a combination of portions thereof, wherein the pick-up path is determined based, at least in part, on one or more joint parameters of the first joint and/or the second joint.

C6. The method of one or more examples above (e.g., C5) or a combination of portions thereof, wherein the one or more joint parameters includes at least one of a range of motion, a joint speed, joint strength, or a joint accuracy.

C7. The method of one or more examples above (e.g., C1) or a combination of portions thereof, further comprising robotic system to move the gripper along a pick-up path toward a target gripping position for the gripper to grip the object, and wherein the pick-up path is a linear path or a non-linear path.

C8. The method of one or more examples above (e.g., C1) or a combination of portions thereof, further comprising moving the robotic system along a support surface while the first joint and/or second joint move the gripper.

C9. The method of one or more examples above (e.g., C1) or a combination of portions thereof, further comprising controlling the robotic system to move the gripper toward the object to compensate for movement along at least one of the first arc or the second arc to position the gripper at a gripping position for gripping the object.

C11. The method of one or more examples above (e.g., C1) or a combination of portions thereof, wherein the first segment is an articulatable cantilever conveyor arm, the first arc is a vertical arc, and the second arc is a horizontal arc.

C13 The method of one or more examples above (e.g., C1) or a combination of portions thereof, wherein the object is one of a plurality of objects stacked along a vertical plane.

C13. The method of one or more examples above (e.g., C1) or a combination of portions thereof, further comprising:
rotating the gripper in a third rotational degree of freedom about a second joint with respect to the first segment to adjust a pitch angle of the gripper, and
rotating the gripper in a fourth rotational degree of freedom about the second joint with respect to the first segment to adjust a yaw angle of the gripper.

C14. The method of one or more examples above (e.g., C1) or a combination of portions thereof, wherein the first joint includes a first joint conveyor, wherein the method further comprises moving the object from the first segment to the proximal conveyor with the first joint conveyor.

C15. The method of one or more examples above (e.g., C12) or a combination of portions thereof, wherein:
the first joint conveyor includes a first plurality of rollers, and
moving the object from the first segment conveyor to the proximal conveyor comprises rotating the first plurality of rollers.

C16. The method of one or more examples above (e.g., C1) or a combination of portions thereof, wherein the gripper includes a distal conveyor and at least one suction cup, wherein the method further comprises moving, using the distal conveyor, the object away from the at least one suction cup and toward the first segment conveyor.

C17. The method of one or more examples above (e.g., C1) or a combination of portions thereof, wherein:
the first segment conveyor includes a first segment conveyor belt,
the proximal conveyor includes a proximal conveyor belt; and
a proximal end of the first segment conveyor belt is positioned above a distal end of the proximal conveyor belt.

C18. The method of one or more examples above (e.g., C1) or a combination of portions thereof, further comprising moving the first leg and/or the second leg relative to a chassis to adjust the position of the chassis in a second translational degree of freedom perpendicular to the first translational degree of freedom.

C19. The method of one or more examples above (e.g., C8) or a combination of portions thereof, wherein moving the first leg and/or the second leg in the vertical direction comprises rotating the first leg and/or the second leg relative to the chassis.

D1. A robotic system comprising:
a proximal conveyor configured to extend and retract in a first translational degree of freedom;
a chassis;
a first leg and a second leg operatively coupled to the chassis to support the chassis, wherein:
   the first leg includes a first wheel,
   the second leg includes a second wheel,
   rotation of the first wheel and the second wheel moves the chassis in a second translational degree of freedom parallel to the first translational degree of freedom; and
a chassis joint coupling a distal end portion of the proximal conveyor to the chassis, wherein the chassis joint includes:
   a proximal conveyor mount configured to attach to the proximal conveyor, and
   a chassis mount configured to attach to the chassis, wherein the chassis mount is configured to slide relative to the proximal conveyor mount in a direction parallel to the first translational degree of freedom.

D2. The robotic system of one or more examples above (e.g., D1 or a combination of portions thereof, wherein the chassis mount is further configured to slide relative to the proximal conveyor mount in a vertical direction perpendicular to the first translational degree of freedom.

D3. The robotic system of one or more examples above (e.g., D2) or a combination of portions thereof, wherein:
the first leg and the second leg are configured to move in a vertical direction to move the chassis in a third translational degree of freedom perpendicular to the first translational degree of freedom, and
the chassis mount is configured to slide in the vertical direction to accommodate movement of the chassis relative to the proximal conveyor in the third translational degree of freedom.

D4. The robotic system of one or more examples above (e.g., D2) or a combination of portions thereof, wherein the chassis mount further includes:
a first vertical shaft fixed to the chassis;
a first vertical coupler configured to slide on the first vertical shaft;
a second vertical shaft fixed to the chassis, wherein the second vertical shaft is spaced from the first vertical shaft; and
a second vertical coupler configured to slide on the second vertical shaft.

D5. The robotic system of one or more examples above (e.g., D4) or a combination of portions thereof, wherein:
the first vertical coupler is configured to rotate about a first vertical coupler axis perpendicular to the first vertical shaft, and
the second vertical coupler is configured to rotate about a second vertical coupler axis perpendicular to the second vertical shaft.

D6. The robotic system of one or more examples above (e.g., D5) or a combination of portions thereof, wherein:
the first leg and the second leg are configured to move in a vertical direction independently from one another to rotate the chassis in a pitch rotational degree of freedom, and
the first vertical coupler and the second vertical coupler are configured to rotate about the first vertical coupler axis and the second vertical coupler axis, respectively, to accommodate rotation of the chassis relative to the proximal conveyor in the pitch rotational degree of freedom.

D7. The robotic system of one or more examples above (e.g., D4) or a combination of portions thereof, wherein:
the chassis mount further includes an axle coupled to the first vertical coupler and the second vertical coupler; and
the axle is configured to rotate in an axle roll rotational degree of freedom, such that the first vertical coupler slides on the first vertical shaft in an equal and opposite direction to the second vertical coupler on the second vertical shaft when the axle rotates in the axle roll rotational degree of freedom.

D8. The robotic system of one or more examples above (e.g., D7) or a combination of portions thereof, wherein:
the first leg and the second leg are configured to move in a vertical direction independently from one another to rotate the chassis in a chassis roll rotational degree of freedom, and
the axle is configured to rotate about the axle roll rotational degree of freedom to adjust relative positions of the first vertical coupler and the second vertical coupler on the first vertical shaft and the second vertical shaft, respectively, to accommodate rotation of the chassis relative to the proximal conveyor in the chassis roll rotational degree of freedom.

D9. The robotic system of one or more examples above (e.g., D1) or a combination of portions thereof, wherein the chassis joint further includes a distance sensor configured to obtain distance information indicative of a relative position of the chassis mount and the proximal conveyor mount.

D10. The robotic system of one or more examples above (e.g., D9) or a combination of portions thereof, further comprising:
a local controller including a processor and memory, wherein the local controller is configured to receive the distance information from the distance sensor;
a first wheel motor coupled to the first wheel and configured to drive the first wheel; and
a second wheel motor coupled to the second wheel and configured to drive the second wheel,
wherein the local controller is configured to command the first wheel motor and the second wheel motor based on the distance information.

D11. The robotic system of one or more examples above (e.g., D10) or a combination of portions thereof, wherein the distance information is indicative of a relative position of the chassis mount and the proximal conveyor mount in the first translational degree of freedom.

D12. The robotic system of one or more examples above (e.g., D1) or a combination of portions thereof, wherein the chassis mount further includes a spring configured to bias the proximal conveyor mount and the chassis mount to a neutral position relative to one another with respect to the first translational degree of freedom.

D13. The robotic system of one or more examples above (e.g., D1) or a combination of portions thereof, further comprising:
a first segment operatively coupled to the chassis via a first joint, wherein the first joint is configured to provide a first rotational degree of freedom between the first segment and the chassis;
a gripper operatively coupled to the first segment via a second joint, wherein the second joint is configured to provide a second rotational degree of freedom between the first segment and the gripper.

D14. The robotic system of one or more examples above (e.g., D13) or a combination of portions thereof, wherein:
the gripper includes a distal conveyor extending along a length of the gripper,
the first segment includes a first segment conveyor extending along a length of the first segment,
the distal conveyor is configured to move an object from a distal end of the gripper to a distal end of the first segment, and
the first segment conveyor is configured to move the object from the distal end of the first segment to a distal end of the proximal conveyor.

E1. A method of operating a robotic system, the method comprising:
obtaining, from one or more vision sensors, an image of a plurality of objects arrayed in a vertical plane;
identify, based on the image, a minimum viable region corresponding to a first object of the plurality of objects;
commanding a gripper to grasp the first object within the minimum viable region;
commanding the gripper to lift the first object;
obtaining, with one or more distance sensors, a plurality of distance measurements in a vertical direction;
detecting, based on the plurality of distance measurements in the vertical direction, a bottom boundary of the first object;
updating a vertical dimension of the minimum viable region based on the detected bottom boundary of the first object;
obtaining, with the one or more distance sensors, a plurality of distance measurements in a horizontal direction below the detected bottom boundary;
detecting, based on the plurality of distance measurements in the horizontal direction, a side boundary of the first object; and
updating a horizontal dimension of the minimum viable region based on the detected side boundary of the first object.

E2. The method of one or more examples above (e.g., E1) or a combination of portions thereof, wherein:
grasping the first object in the minimum viable region includes grasping the first object in an upper left quadrant of the minimum viable region with respect to the vertical plane,
the bottom boundary is below a location where the first object is grasped with respect to the vertical plane, and
the side boundary is to the right of the location wherein the first object is grasped with respect to the vertical plane.

E3. The method of one or more examples above (e.g., E1) or a combination of portions thereof, further comprising:
updating the image by subtracting the minimum viable region including the updated vertical dimension and the updated horizontal dimension from the image, and
identify, based on the updated image, a second minimum viable region corresponding to a second object of the plurality of objects.

E4. The method of one or more examples above (e.g., E3) or a combination of portions thereof, further comprising:
grasping, with the gripper, the second object within the second minimum viable region;
lifting the second object with the gripper;
obtaining, with the one or more distance sensors, a second plurality of distance measurements in the vertical direction;
detecting, based on the second plurality of distance measurements in the vertical direction, a bottom boundary of the second object;
updating a vertical dimension of the second minimum viable region based on the detected bottom boundary of the second object;
obtaining, with the one or more distance sensors, a plurality of distance measurements in the horizontal direction below the detected bottom boundary;
detecting, based on the plurality of distance measurements in the horizontal direction, a side boundary of the second object; and
updating a horizontal dimension of the second minimum viable region based on the detected side boundary of the second object.

E5. The method of one or more examples above (e.g., E4) or a combination of portions thereof, wherein the minimum viable region and the second minimum viable region have a different horizontal dimension and/or a vertical dimension.

E6. The method of one or more examples above (e.g., E4) or a combination of portions thereof, wherein the first object is rectangular within the vertical plane, and wherein the second object is rectangular within the vertical plane.

E7. The method of one or more examples above (e.g., E3) or a combination of portions thereof, wherein identifying the second minimum viable region is not based on obtaining an additional image from the one or more vision sensors.

E8. The method of one or more examples above (e.g., E1) or a combination of portions thereof, wherein the one or more distance sensors include one or more laser rangefinders.

E9. The method of one or more examples above (e.g., E1) or a combination of portions thereof, wherein the gripper includes at least one suction cup, wherein grasping the first object includes:
contacting the first object with the at least one suction cup; and
applying vacuum to the at least one suction cup

E10. The method of one or more examples above (e.g., E9) or a combination of portions thereof, wherein the at least one suction cup is a plurality of suction cups arranged in a horizontal line.

E11. The method of one or more examples above (e.g., E9) or a combination of portions thereof, wherein the gripper includes a gripper frame, wherein lifting the first object includes moving the at least one suction cup in a vertical direction with respect to the gripper frame.

E12. The method of one or more examples above (e.g., E11) or a combination of portions thereof, wherein the gripper includes a gripper conveyor disposed on the gripper frame, wherein the method further comprises:
moving, using the at least one suction cup, the first object onto the gripper conveyor; and
moving the first object on the gripper conveyor in a proximal direction with respect to the gripper toward a proximal conveyor of the robotic system.

E13. The method of one or more examples above (e.g., E1) or a combination of portions thereof, wherein the one or more distance sensors include a vertical distance sensor and a horizontal distance sensor.

E14. The method of one or more examples above (e.g., E1) or a combination of portions thereof, wherein detecting the bottom boundary of the first object includes detecting a stepwise change in distance measurements greater than a non-zero threshold in the vertical direction.

E15. The method of one or more examples above (e.g., E15) or a combination of portions thereof, wherein detecting the side boundary of the first object includes detecting a stepwise change in distance measurements greater than the non-zero threshold in the horizontal direction.

F1. A robotic system comprising:
a gripper including:
   a suction cup configured to hold an object when vacuum is applied to the suction cup, and
   a conveyor configured to move the object in a proximal direction after being held by the suction cup;
a vision sensor configured to obtain image information including a plurality of objects arrayed in a vertical plane within a cargo carrier; and
one or more distance sensors configured to measure a distance to the plurality of objects arrayed in the vertical plane, wherein:
   the one or more distance sensors are configured to obtain a plurality of distance measurements in a vertical direction, and
   the one or more distance sensors are configured to obtain a plurality of distance measurements in a horizontal direction.

F2. The robotic system of one or more examples above (e.g., F1) or a combination of portions thereof, wherein the one or more distance sensors include:
a vertical distance sensor configured to obtain one or more of the plurality of distance measurements in the vertical direction, and
a horizontal distance sensor configured to obtain one or more of the plurality of distance measurements in the horizontal direction.

F3. The robotic system of one or more examples above (e.g., F1) or a combination of portions thereof, wherein the one or more distance sensors is a single distance sensor configured to measure the distance, wherein the distance is from the single distance sensor to the plurality of objects arrayed.

F4. The robotic system of one or more examples above (e.g., F3) or a combination of portions thereof, wherein the single distance sensor is a LIDAR sensor.

F5. The robotic system of one or more examples above (e.g., F1) or a combination of portions thereof, wherein the gripper is configured to move the object held by the suction cut vertically with respect to the conveyor.

F6. The robotic system of one or more examples above (e.g., F5) or a combination of portions thereof, wherein the gripper is configured to move the object held by the suction cut horizontally with respect to the conveyor.

F7. The robotic system of one or more examples above (e.g., F1) or a combination of portions thereof, wherein the gripper further comprises a vacuum generator fluidically coupled to the suction cup.

F8. The robotic system of one or more examples above (e.g., F1) or a combination of portions thereof, wherein the suction cup is a first suction cup, wherein the gripper further includes a second suction cup and a third suction cup, wherein the first suction cup, the second suction cup, and the third suction cup are arranged in a line.

F9. The robotic system of one or more examples above (e.g., F1) or a combination of portions thereof, further comprising:
a chassis;
a first segment;
a first joint operatively coupling the first segment to the chassis, wherein the first joint is configured to provide a first rotational degree of freedom between the first segment and the chassis; and
a second joint operatively coupling the gripper to the first segment, wherein the second joint is configured to provide a second rotational degree of freedom between the first segment and the gripper.

F10. The robotic system of one or more examples above (e.g., F9) or a combination of portions thereof, wherein:
the first segment includes a first segment conveyor extending along a length of the first segment,
the conveyor of the gripper is configured to move the object from a distal end of the gripper to a distal end of the first segment, and
the first segment conveyor is configured to move the object from the distal end of the first segment to a proximal end of the first segment conveyor.

F11. The robotic system of one or more examples above (e.g., F9) or a combination of portions thereof, wherein the vision sensor is positioned below the first segment.

F12. The robotic system of one or more examples above (e.g., F1) or a combination of portions thereof, further comprising a local controller including a processor and memory, wherein the local controller is configured to receive the image information from the vision sensor, wherein the local controller is programmed to:
obtain, from the vision sensor, an image of the plurality of objects arrayed in a vertical plane;
identify, based on the image, a minimum viable region corresponding to a first object of the plurality of objects;
command the gripper to grasp, with the suction cup, the first object within the minimum viable region;
command the gripper to lift the first object with the suction cup;
obtain, with the one or more distance sensors, a first plurality of distance measurements in a vertical direction;
detect, based on the first plurality of distance measurements in the vertical direction, a bottom boundary of the first object;
update a vertical dimension of the minimum viable region based on the detected bottom boundary of the first object;
obtain, with the one or more distance sensors, a second plurality of distance measurements in a horizontal direction below the detected bottom boundary;
detect, based on the second plurality of distance measurements in the horizontal direction, a side boundary of the first object; and
update a horizontal dimension of the minimum viable region based on the detected side boundary of the first object.

F13. The robotic system of one or more examples above (e.g., F12) or a combination of portions thereof, wherein detecting the bottom boundary of the first object includes detecting a stepwise change in the first plurality of distance measurements greater than a non-zero threshold.

F14. The robotic system of one or more examples above (e.g., F13) or a combination of portions thereof, wherein detecting the side boundary of the first object includes detecting a stepwise change in the second plurality of distance measurements greater than the non-zero threshold.

G1. A method of operating a robotic system, the method comprising:
obtaining, from one or more sensors, an image of at least one object to be engaged by a gripper of the robotic system and be conveyed along a chassis conveyor belt of a chassis and an arm conveyor belt of an arm of the robotic system, wherein the arm is coupled distal to the chassis, wherein the gripper is coupled distal to the arm;
determining, based on the image, at least one of a first position for the chassis or a first angular position for the chassis;
determining, based on the image, a second position for the gripper;
determining, based on the image, a second angular position for the arm;
actuating one or more supporting legs coupled to the chassis such that the chassis is at least at one of the first position or the first angular position; and
actuating one or more joints of the robotic system such that the gripper is at the second position and the arm is at the second angular position.

G2. The method of one or more examples above (e.g., G1) or a combination of portions thereof, wherein a combination of the first and second angular positions is configured to prevent slippage of the object along the chassis conveyor belt and the arm conveyor belt.

G3. The method of one or more examples above (e.g., G1) or a combination of portions thereof, further comprising:
detecting, via the one or more sensors, slippage of the object along the arm conveyor belt; and
actuating the one or more supporting legs to raise or lower the first position of the chassis while maintaining the gripper at the second position, thereby lowering the second angular position of the arm.

G4. The method of one or more examples above (e.g., G1) or a combination of portions thereof, further comprising:
detecting, via the one or more sensors, slippage of the object along the arm conveyor belt; and
actuating the one or more joints to raise or lower the second position of the gripper while maintaining the chassis at the first position, thereby lowering the second angular position of the arm.

G5. The method of one or more examples above (e.g., G1) or a combination of portions thereof, further comprising:
detecting, via the one or more sensors, slippage of the object along the arm conveyor belt;
actuating the one or more supporting legs to raise or lower the first position of the chassis; and
actuating the one or more joints to raise or lower the second position of the gripper, thereby lowering the second angular position of the arm.

G6. The method of one or more examples above (e.g., G1) or a combination of portions thereof, further comprising:
detecting, via the one or more sensors, slippage of the object along the chassis conveyor belt; and
actuating the one or more supporting legs to decrease the first angular position of the chassis.

G7. The method of one or more examples above (e.g., G1) or a combination of portions thereof, further comprising driving one or more wheels attached to corresponding ones of the one or more supporting legs to move the chassis in a forward or backward direction relative to the at least one object such that the gripper maintains the second position relative to the at least one object.

G8. The method of one or more examples above (e.g., G1) or a combination of portions thereof, further comprising:
detecting, via the one or more sensors, a tilt of the robotic system caused by an uneven surface on which the robotic system is positioned, wherein the tilt is in a direction away from a longitudinal axis extending along the chassis conveyor belt; and
actuating at least a subset of the one or more supporting legs to compensate for the tilt of the robotic system caused by the uneven surface.

G9. The method of one or more examples above (e.g., G1) or a combination of portions thereof, wherein the robotic system is positioned over a warehouse conveyor belt such that the chassis conveyor belt and the warehouse conveyor belt form a continuous travel path for the at least one object, and wherein the one or more supporting legs are actuated such that the continuous travel path is maintained while the chassis is actuated to at least at one of the first position or the first angular position.

G10. The method of one or more examples above (e.g., G1) or a combination of portions thereof, wherein determining the at least one of the first position or the first angular position comprises determining a first range of acceptable positions or a first range of acceptable angular positions.

G11. The method of one or more examples above (e.g., G1) or a combination of portions thereof, wherein determining the second position comprises determining a second range of acceptable positions.

G12. The method of one or more examples above (e.g., G1) or a combination of portions thereof, wherein determining the second angular position comprises determining a second range of acceptable angular positions.

G13. The method of one or more examples above (e.g., G1) or a combination of portions thereof, wherein the first and second positions are determined relative to a support surface on which the robotic system is positioned.

G14. The method of one or more examples above (e.g., G1) or a combination of portions thereof, wherein the first and second positions are determined relative to the at least one object.

H1. An end effector for a robotic unit, the end effector comprising:
a frame having a proximal end region configured to be couplable to the robotic unit and a distal end region opposite the proximal end region;
a plurality of conveyors carried by the frame and positioned to move an object toward the proximal end region of the frame; and
a gripper assembly including a gripper element, wherein the gripper assembly is configured to move the gripper element to a first position at which the gripper element protrudes beyond the distal end region of the frame to pick up an object, a second position to place the object on an upper surface of one or more of the plurality of conveyors, and a third position below the upper surface such that the one or more of the plurality of conveyors move the object toward the proximal end region of the frame over the gripper element.

H2. The end effector of one or more examples above (e.g., H1) or a combination of portions thereof, further comprising one or more sensors for detecting target objects, and wherein the gripper assembly is configured to move the gripper element along motion paths to transport each of the target objects above one or more of the plurality of conveyors and onto the upper surface based on signals from the one or more sensors.

H3. The end effector of one or more examples above (e.g., H1) or a combination of portions thereof wherein the gripper element is configured to grip a side of the object for carrying the object from the first position to the second position, wherein the gripper assembly is configured to release the object after the object is placed on the upper surface.

H4. The end effector of one or more examples above (e.g., H1) or a combination of portions thereof wherein the gripper assembly includes a linkage assembly that is rotatable relative to the frame, wherein the linkage assembly has
a carrying configuration to position the gripper element such that the gripper element holds the object spaced apart from the plurality of conveyors while the linkage assembly rotates relative to the frame to move the object held by the gripper element above the plurality of conveyors; and
a standby configuration for holding the gripper element within the end effector.

H5. The end effector of one or more examples above (e.g., H1) or a combination of portions thereof wherein the gripper assembly includes a scissor mechanism movable between
an extended configuration for holding the gripper element higher than the plurality of conveyors, and
a collapsed configuration for holding the gripper element lower than portions of the conveyor belts of the plurality of conveyors to allow the object carried by the conveyor belts over and past the gripper element.

H6. The end effector of one or more examples above (e.g., H1) or a combination of portions thereof, wherein the plurality of conveyors is in communication with a controller programmed to cause the plurality of conveyors to begin moving the upper surface of the one or more of the plurality of conveyors after the gripper element has placed the object on the upper surface.

H7. The end effector of one or more examples above (e.g., H1) or a combination of portions thereof wherein the gripper assembly further comprises a vertical actuation component operably coupled to the gripper element, wherein the vertical actuation component is movable between a lowered state and a raised state to move the gripper element between the second position and the third position.

H8. The end effector of one or more examples above (e.g., H7) or a combination of portions thereof wherein the vertical actuation component comprises a link having a first end at a fixed height relative to the upper surface of the plurality of conveyors and a second end operably coupled to the gripper element, wherein the link pivots about the first end between the lowered state and the raised state.

H9. The end effector of one or more examples above (e.g., H7) or a combination of portions thereof wherein the vertical actuation component comprises an expandable component having a first end region at a fixed height relative to the upper surface of the plurality of conveyors and a second end region operably coupled to the gripper element, wherein the expandable component expands to move the second end region in an upward direction between the lowered state and the raised state.

H10. The end effector of one or more examples above (e.g., H1) or a combination of portions thereof wherein the gripper assembly further comprises an actuation base movable in a lateral direction relative to the plurality of conveyors.

H11. The end effector of one or more examples above (e.g., H10) or a combination of portions thereof wherein the gripper assembly further comprises a vacuum generation component carried by the actuation base and operably coupled to the gripper element to provide a vacuum force to grip the object.

H12. The end effector of one or more examples above (e.g., H11) or a combination of portions thereof wherein the vacuum generation component is further operably coupled to the gripper element to provide a positive pressure to disengage the gripper element from the object.

H13. The end effector of one or more examples above (e.g., H1) or a combination of portions thereof wherein the frame has a sloped top surface, and wherein the upper surface of the plurality of conveyors is coplanar with an sloped top surface of the frame.

H14. The end effector of one or more examples above (e.g., H1) or a combination of portions thereof further comprising a drive component operably coupled to each of the plurality of conveyors to drive the plurality of conveyors at a uniform speed.

H15. The end effector of one or more examples above (e.g., H1) or a combination of portions thereof, further comprising a plurality of sensors carried by the frame and positioned to detect one or more target objects and/or an environment around the end effector.

H16. The end effector of one or more examples above (e.g., H1) or a combination of portions thereof, further comprising an engagement sensor positioned to detect when a target object is over a portion of the upper surface of the one or more of the plurality of conveyors.

H17. The end effector of one or more examples above (e.g., H16) or a combination of portions thereof wherein the gripper assembly is configured to disengage with the target object in response to a detection signal from the engagement sensor.

H18. The end effector of one or more examples above (e.g., H16) or a combination of portions thereof wherein the gripper assembly is configured to direct fluid over the engagement sensor while disengaging with the target object.

H19. The end effector of one or more examples above (e.g., H1) or a combination of portions thereof, further comprising an engagement sensor positioned to detect when the object is at a target drop-off position above the upper surface of the one or more of the plurality of conveyors.

H20. The end effector of one or more examples above (e.g., H1) or a combination of portions thereof wherein, after the gripper element engages a target object, a motion path between the first position and the second position causes the gripper element to at least partially lift the target object.

H21. The end effector of one or more examples above (e.g., H1) or a combination of portions thereof wherein, after the gripper element engages a target object, a motion path between the first position and the second position causes the gripper element to tilt the target object onto an edge to reduce friction between the target object and an underlying surface as the gripper assembly moves the target object onto the upper surface of the one or more of the plurality of conveyors.

H22. The end effector of one or more examples above (e.g., H1) or a combination of portions thereof wherein the gripper assembly comprises a plurality of gripper elements.

H23. The end effector of one or more examples above (e.g., H22) or a combination of portions thereof wherein the gripper assembly further comprises a shared actuation base movable in a lateral direction relative to the plurality of conveyors.

H24. The end effector of one or more examples above (e.g., H22) or a combination of portions thereof wherein the gripper assembly further comprises a plurality of vacuum generation components individually corresponding to each of the plurality of gripper elements.

H25. The end effector of one or more examples above (e.g., H24) or a combination of portions thereof wherein each of the plurality of vacuum generation components is movable in a lateral direction.

H26. The end effector of one or more examples above (e.g., H22) or a combination of portions thereof wherein each individual vacuum component is positioned between a corresponding pair of the plurality of conveyors.

J1. A method for operating a robotic unit to unpack a shipping unit, the method comprising:
identifying one or more target objects in the shipping unit;
positioning an end effector of the robotic unit adjacent to an individual target object from the one or more target objects;
moving a gripper assembly in the end effector distally to position one or more gripping elements of the gripper assembly distal to a distalmost end of a frame of the end effector;
providing a drive force to the one or more gripping elements to engage the individual target object;
moving the gripper assembly proximally to position the one or more gripping elements above at least a first portion of a conveyor component in the end effector;
disengaging the one or more gripping elements from the individual target object;
moving the gripper assembly to position the one or more gripping elements below at least a second portion of the conveyor component; and
operating the conveyor component to move the individual target object proximally toward a base conveyor of the robotic unit.

J2. The method of one or more examples above (e.g., J1) or a combination of portions thereof wherein the conveyor component comprises a plurality of conveyor belts extending from a distal region of the end effector to a proximal region, and wherein operating the conveyor component comprises driving each of the plurality of conveyor belts with a common drive shaft.

J3. The method of one or more examples above (e.g., J1) or a combination of portions thereof wherein the one or more gripping elements is two or more gripping elements, wherein the gripper assembly comprises a shared actuation base component operatively coupled to each of the two or more gripping elements, and wherein moving the gripper assembly distally to position the two or more gripping elements distal to the distalmost end of the frame comprises moving the shared actuation base component distally.

J4. The method of one or more examples above (e.g., J3) or a combination of portions thereof wherein the gripper assembly further comprises two or more links pivotably coupled between the shared actuation base component and an individual one of the two or more gripping elements, wherein moving the gripper assembly to position the two or more gripping elements above the first portion of the conveyor component comprises pivoting the two or more links from a first state to a second state to raise a height of the two or more gripping elements.

J5. The method of one or more examples above (e.g., J1) or a combination of portions thereof wherein providing a drive force to the one or more gripping elements to engage the individual target object comprises supplying a vacuum pressure to the one or more gripping elements.

J6. The method of one or more examples above (e.g., J1) or a combination of portions thereof disengaging the individual target object comprises supplying positive pressure to the one or more gripping elements to overcome a suction force therebetween.

J7. The method of one or more examples above (e.g., J1) or a combination of portions thereof, further comprising, before operating the one or more gripping elements to disengage the individual target object, detecting a presence of the individual target object over a predetermined portion of the conveyor component.

J8. The method of one or more examples above (e.g., J7) or a combination of portions thereof wherein detecting the presence of the individual target object is based on one or more signals from a presence sensor at a predetermined position, and wherein the method further comprises, while operating the one or more gripping elements to disengage the individual target object, blowing fluid over the presence sensor.

J9. The method of one or more examples above (e.g., J1) or a combination of portions thereof wherein moving the gripper assembly proximally to position the one or more gripping elements above the first portion of the conveyor component comprises:
raising the one or more gripping elements to tilt the individual target object onto a rear edge; and
moving the one or more gripping elements toward a proximal region of the end effector.

J10. The method of one or more examples above (e.g., J1) or a combination of portions thereof wherein moving the gripper assembly proximally to position the one or more gripping elements above the first portion of the conveyor component comprises:
raising the one or more gripping elements to a predetermined height; and
moving the one or more gripping elements toward a proximal region of the end effector.

K1. A robotic unit, comprising:
a movable base;
a movable arm having a proximal end coupled to the movable base at a first joint and a distal end opposite the proximal end, the movable arm comprising one or more conveyor elements operable to move a target object from the distal end to the proximal end, wherein the first joint is configured to allow the movable arm to pivot about a first axis and a second axis with respect to the movable base;
a second joint coupled to the distal end of the movable arm, wherein the second joint is configured to rotate about a fourth axis with respect to the movable arm; and
an end effector coupled to the second joint, wherein the second joint is configured to allow the end effector to rotate about a third axis with respect to the second joint.

K2. The robotic unit of one or more examples above (e.g., K1) or a combination of portions thereof wherein the end effector comprises:
a frame having a first end region coupled to the second joint and a second end region opposite the first end region;
a plurality of side-by-side conveyors carried by the frame and operable to move the target object toward the first end region of the frame and onto the second joint; and
a gripper assembly, comprising a vacuum component movable along a motion path that includes (1) a first position protruding beyond the second end region of the frame, (2) a second position above a first portion of an upper surface of the plurality of side-by-side conveyors, and (3) a third position beneath a second portion of the upper surface of the plurality of side-by-side conveyors.

K3. The robotic unit of one or more examples above (e.g., K1) or a combination of portions thereof wherein the second joint comprises a plurality of rollers operable to move the target object from a second connection point with the end effector to a first connection point with the movable arm.

K4. The robotic unit of one or more examples above (e.g., K1) or a combination of portions thereof wherein the second joint comprises:
a first retractable component positioned on a first side of the second joint, wherein the second joint is configured to raise and lower the first retractable component in response to a rotation of the end effector about the third axis to provide and retract additional support for the target object; and
a second retractable component positioned on a second side of the second joint, wherein the second joint is configured to raise and lower the second retractable component opposite the first retractable component in response to the rotation of the end effector about the third axis to provide and retract additional support for the target object.

K5. The robotic unit of one or more examples above (e.g., K4) or a combination of portions thereof wherein the second joint further comprises a track operably coupling the first retractable component to a central component of the second joint, wherein the rotation of the end effector about the third axis moves the first retractable component to automatically raise and lower the first retractable component as the end effector rotates about the third axis.

K6. The robotic unit of one or more examples above (e.g., K1) or a combination of portions thereof wherein the second joint comprises:
a first drive system configured to rotate the second joint and the end effector about the fourth axis; and
a second drive system configured to rotate the end effector about the third axis.

K7. The robotic unit of one or more examples above (e.g., K1) or a combination of portions thereof wherein the third axis is positioned in a plane, and wherein the fourth axis is generally orthogonal to the plane.

K8. The robotic unit of one or more examples above (e.g., K1) or a combination of portions thereof wherein the second joint comprises a drive system configured to rotate the second joint and the end effector with respect to the movable arm.

K9. The robotic unit of one or more examples above (e.g., K8) or a combination of portions thereof wherein the drive system comprises:
a linking pulley; and
a linking belt coupled between the linking pulley and the first joint, wherein the linking belt is positioned to translate rotation about the second axis of the movable arm with respect to the movable base into motion in the linking pulley.

K10. The robotic unit of one or more examples above (e.g., K9) or a combination of portions thereof wherein the drive system further comprises a reduction system coupled to the linking pulley, wherein the reduction system is positioned to translate motion in the linking pulley into a second rotation amount of the second joint and the end effector with respect to the movable arm generally opposite a first rotation amount of the movable arm with respect to the movable base.

K11. The robotic unit of one or more examples above (e.g., K8) or a combination of portions thereof wherein the drive system comprises a pivotable link between coupled between the second joint and the movable arm, wherein rotation of the pivotable link causes the second joint and the end effector to rotate with respect to the movable arm.

K12. The robotic unit of one or more examples above (e.g., K12) or a combination of portions thereof wherein the drive system comprises further comprises reduction system coupled to the pivotable link to control the rotation of the pivotable link.

K13. The robotic unit of one or more examples above (e.g., K1) or a combination of portions thereof wherein the second joint comprises a drive system configured to rotate and the end effector with respect to the second joint.

K14. The robotic unit of one or more examples above (e.g., K13) or a combination of portions thereof wherein the drive system comprises a rotary motion joint, and wherein the rotary motion joint comprises:
a shaft coupled to the second joint;
one or more bearings coupled to the shaft; and
a housing coupled between at least one of the one or more bearings and the end effector.

K15. The robotic unit of one or more examples above (e.g., K14) or a combination of portions thereof wherein at least one of the one or more bearings is drivable to control rotation of the end effector with respect to the second joint.

K16. The robotic unit of one or more examples above (e.g., K14) or a combination of portions thereof wherein the drive system further comprises an expandable component coupled between the end effector and the second joint, wherein expansion and contraction of the expandable component drives rotation about the rotary motion joint.

K16. The robotic unit of one or more examples above (e.g., K14) or a combination of portions thereof wherein the drive system further comprises a drive belt coupled to the rotary motion joint to control rotation of the end effector with respect to the second joint.

L1. A method for operating a robotic unit to unpack a shipping unit, the method comprising:
selecting an individual target object from a stack of target objects;
positioning a gripper assembly of an end effector adjacent to the individual target object, wherein the end effector includes a conveyor mechanism and the gripper assembly;
gripping the individual target object using the gripper assembly extending distally from of the conveyor mechanism;
transporting the individual target object away from the stack of target objects and above one or more movable upper surfaces of the conveyor mechanism;
moving the gripper assembly to a retracted position below the one or more movable upper surfaces; and
carrying the individual target object proximally over the gripper assembly and toward a base conveyor of a robotic unit.

L2. The method of one or more examples above (e.g., L1) or a combination of portions thereof wherein the conveyor mechanism comprises a plurality of conveyor belts extending from a distal region of the end effector to a proximal region, and wherein operating the conveyor mechanism comprises driving each of the plurality of conveyor belts with a common drive shaft.

L3. The method of one or more examples above (e.g., L1) or a combination of portions thereof wherein the gripper assembly includes two or more gripping elements, wherein the gripper assembly comprises a shared actuation base component operatively coupled to each of the two or more gripping elements, and wherein moving the gripper assembly distally comprises moving the shared actuation base component distally.

L4. The method of one or more examples above (e.g., L3) or a combination of portions thereof wherein the gripper assembly further comprises two or more links pivotably coupled between the shared actuation base component and an individual one of the two or more gripping elements, wherein transporting the individual target object above the one or more movable upper surfaces of the conveyor mechanism comprises pivoting the two or more links from a first state to a second state to raise a height of the two or more gripping elements.

L5. The method of one or more examples above (e.g., L1) or a combination of portions thereof wherein gripping the individual target object comprises supplying a vacuum pressure to one or more gripping elements in the gripper assembly.

L6. The method of one or more examples above (e.g., L1) or a combination of portions thereof, further comprising releasing the individual target object before moving the gripper assembly to the retracted position.

L7. The method of one or more examples above (e.g., L6) or a combination of portions thereof wherein releasing the individual target object comprises supplying positive pressure to one or more gripping elements in the gripper assembly.

L8. The method of one or more examples above (e.g., L6) or a combination of portions thereof, further comprising, before releasing the individual target object, detecting a presence of the individual target object over a portion of the conveyor mechanism.

L9. The method of one or more examples above (e.g., L8) or a combination of portions thereof wherein detecting the presence of the individual target object is based on one or more signals from a presence sensor, and wherein the method further comprises, while releasing the individual target object, blowing fluid over the presence sensor.

L10. The method of one or more examples above (e.g., L1) or a combination of portions thereof wherein transporting the individual target object above the one or more movable upper surfaces of the conveyor mechanism comprises:
raising one or more gripping elements in the gripper assembly to tilt the individual target object onto a rear edge; and
moving the one or more gripping elements toward a proximal region of the end effector.

M1. A robotic unit, comprising:
a movable base;
a conveyor arm having a proximal end coupled to the movable base and a distal end opposite the proximal end;
an end effector coupled to the distal end of the conveyor arm;
a first conveyor joint movably coupling the conveyor arm to the movable base; and
a second conveyor joint movably coupling the end effector to the conveyor arm, wherein the second conveyor joint includes a plurality of roller sections that move relative to one another to direct objects from the end effector to the conveyor arm, wherein one or more rollers of the plurality of roller sections move from a convey position for carrying the objects to a standby position to allow other rollers of the plurality of roller sections to move toward each other to compensate for a relative position between the end effector to the conveyor arm.

M2. The robotic unit of one or more examples above (e.g., M1) or a combination of portions thereof wherein the plurality of roller sections includes a swiveling roll section with a set of rollers that rotate together to adjust a path of travel of objects along the second conveyor joint.

M3. The robotic unit of one or more examples above (e.g., M1) or a combination of portions thereof wherein the plurality of roller sections are movable relative to one another to adjust an object-transport path extending from the end effector to the conveyor arm.

### Remarks

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms can be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms can on occasion be used interchangeably.

Consequently, alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the disclosed technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

These and other changes can be made to the disclosed technology in light of the above Detailed Description. While the Detailed Description describes certain examples of the disclosed technology as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

We claim:

1. A robotic system, comprising:
a chassis;
a first leg and a second leg operatively coupled to the chassis to support the chassis, wherein:
the first leg including a first wheel,
the second leg including a second wheel,
the first wheel and the second wheel are rotatable to move the chassis in a first translational degree of freedom, and
the first leg and the second leg are configured to move in a vertical direction to move the chassis in a second translational degree of freedom perpendicular to the first translational degree of freedom;
a proximal conveyor;
a first segment including a first segment conveyor extending along a length of the first segment;
a first joint between the proximal conveyor and the first segment, wherein the first joint is configured to provide a first rotational degree of freedom between the first segment and the proximal conveyor;
a gripper including a distal conveyor extending along a length of the gripper; and
a second joint between the gripper and the first segment, wherein the second joint is configured to provide a second rotational degree of freedom between the first segment and the gripper, wherein:
the distal conveyor, first segment conveyor, and proximal conveyor are configured to move an object from a distal end of the robotic system to a proximal end of the robotic system.

2. The robotic system of claim 1, wherein:
the first joint is configured to provide a third rotational degree of freedom between the first segment and the proximal conveyor, and
the second joint is configured to provide a fourth rotational degree of freedom between the first segment and the proximal conveyor.

3. The robotic system of claim 2, wherein:
the first rotational degree of freedom and the second rotational degree of freedom are pitch degrees of freedom, and
the third rotational degree of freedom and the fourth rotational degree of freedom are yaw degrees of freedom.

4. The robotic system of claim 1, wherein:
the first joint includes a first plurality of rollers configured to move the object from the first segment conveyor to the proximal conveyor, and
the second joint includes a second plurality of rollers configured to move the object from the distal conveyor to the first segment conveyor.

5. The robotic system of claim 1 wherein the first leg and the second leg are distal legs coupled to a distal portion of the chassis, and wherein the robotic system further comprises:
a third leg including a third wheel; and
a fourth leg including a fourth wheel, wherein the third leg and the fourth leg are configured to move in the vertical direction to move the chassis in the second translational degree of freedom, and wherein the third leg and the fourth leg are proximal legs coupled to a proximal portion of the chassis.

6. A method of operating a robotic system, the method comprising:
rotating a first wheel along a support surface and/or a second wheel along a support surface to adjust a position of a chassis of the robotic system in a first translational degree of freedom;
moving a first leg and/or a second leg in a vertical direction relative to a chassis to adjust the position of the chassis in a second translational degree of freedom different from the first translational degree of freedom, wherein the first wheel is coupled to the first leg, and wherein the second wheel is coupled to the second leg;
rotating a first segment in a first rotational degree of freedom about a first joint with respect to a proximal conveyor;
rotating a gripper in a second rotational degree of freedom about a second joint with respect to the first segment;
moving an object in a proximal direction along a distal conveyor disposed on the gripper to the first segment;
moving the object in the proximal direction along a first segment conveyor disposed on the first segment to the proximal conveyor; and
moving the object in the proximal direction along the proximal conveyor.

7. The method of claim 6, wherein:
rotating the first segment in a third rotational degree of freedom about the first joint with respect to the proximal conveyor; and
rotating the gripper in a fourth rotational degree of freedom about the second joint with respect to the first segment.

8. The method of claim 7, wherein:
the first rotational degree of freedom and the second rotational degree of freedom are pitch degrees of freedom; and
the third rotational degree of freedom and the fourth rotational degree of freedom are yaw degrees of freedom.

9. The method of claim 6, further comprising:
rotating a first plurality of rollers of the first joint to move the object from the first segment conveyor to the proximal conveyor; and
rotating a second plurality of rollers of the second joint to move the object from the distal conveyor to the first segment conveyor.

10. The method of claim 6, further comprising:
moving a third leg and/or a fourth leg in a vertical direction relative to a chassis to adjust the position of the chassis in a second translational degree of freedom perpendicular to the first translational degree of freedom, wherein the third leg includes a third wheel and the fourth leg includes a fourth wheel.

11. A robotic unit, comprising:
a chassis;
a movable arm having a proximal end coupled to the chassis and a distal end opposite the proximal end; and
an end effector, comprising:
a frame having a proximal end region coupled to the distal end of the movable arm and a distal end region opposite the proximal end region;
a plurality of conveyors carried by the frame and positioned to move an object toward the proximal end region of the frame; and
a gripper assembly including a gripper element, wherein the gripper assembly is configured to move the gripper element to a first position at which the gripper element protrudes beyond the distal end region of the frame to pick up an object, a second position to place the object on an upper surface of one or more of the plurality of conveyors, and a third position below the upper surface such that the one or more of the plurality of conveyors move the object toward the proximal end region of the frame over the gripper element.

12. The robotic unit of claim 11 wherein the gripper assembly further comprises a vertical actuation component operably coupled to the gripper element, wherein the vertical actuation component is movable between a lowered state and a raised state to move the gripper element between the second position and the third position.

13. The robotic unit of claim 12 wherein the vertical actuation component comprises a link having a first end at a fixed height relative to the upper surface of the plurality of conveyors and a second end operably coupled to the gripper element, wherein the link pivots about the first end between the lowered state and the raised state.

14. The robotic unit of claim 12 wherein the vertical actuation component comprises an expandable component having a first end region at a fixed height relative to the upper surface of the plurality of conveyors and a second end region operably coupled to the gripper element, wherein the expandable component expands to move the second end region in an upward direction between the lowered state and the raised state.

15. The robotic unit of claim 11 wherein the gripper assembly further comprises a vacuum generation component operably coupled to the gripper element to provide a vacuum force to grip the object.

16. The robotic unit of claim 11 wherein the gripper assembly further comprises a plurality of gripper elements and a shared actuation base movable in a lateral direction relative to the plurality of conveyors.

17. A robotic unit, comprising:
a movable base;
a movable arm having a proximal end coupled to the movable base at a first joint and a distal end opposite the proximal end, the movable arm comprising one or more conveyor elements operable to move a target object from the distal end to the proximal end, wherein the first joint is configured to allow the movable arm to pivot about a first axis and a second axis with respect to the movable base;
an end effector coupled to a distal end of the movable arm; and
a second joint coupled between the distal end of the movable arm and the end effector, wherein:
the second joint is configured to allow the end effector to rotate about a third axis with respect to the second joint;
the second joint is configured to rotate about a fourth axis with respect to the movable arm; and
the second joint comprises a retractable component positioned on a first side of the second joint, wherein the second joint is configured to raise and lower the retractable component in response to a rotation of the end effector about the third axis.

18. The robotic unit of claim 17 wherein:
the retractable component is a first retractable component, wherein the first retractable component comprises a roller positioned to provide additional support for the target object when the retractable component is in a raised position; and
the second joint further comprises a second retractable component positioned on the first side of the second joint, wherein the second joint is configured to raise and lower the second retractable component in response to the rotation of the end effector about the third axis, and wherein.

19. The robotic unit of claim 17 wherein the retractable component is a first retractable component, and wherein the second joint further comprises:
a second retractable component positioned on a second side of the second joint, wherein the second joint is configured to raise and lower the second retractable component opposite the first retractable component in response to the rotation of the end effector about the third axis to provide and retract additional support for the target object.

20. The robotic unit of claim 17 wherein the second joint further comprises a track operably coupling the retractable component to a central component of the second joint, wherein the rotation of the end effector about the third axis moves the retractable component to automatically raise and lower the retractable component as the end effector rotates about the third axis.
